(19) United States
(12) Patent Application Publication
(10) Pub. No.: US 2016/0088132 A1
(43) Pub. Date: Mar. 24, 2016

(54) Mobile Phone With Enhanced Functions

(71) Applicant: Vladimir KRANZ, Prague (CZ)

(72) Inventor: Vladimir KRANZ, Prague (CZ)

(21) Appl. No.: 14/891,480

(22) PCT Filed: May 15, 2014
(86) PCT No.: PCT/CZ2014/000056

§ 371 Date: Nov. 16, 2015

(30) Foreign Application Priority Data
May 15, 2013 (CZ) PV 2013 - 329
May 17, 2013 (CZ) PV 2013 - 362
Jun. 29, 2013 (CZ) PV 2013 - 513
Aug. 20, 2013 (CZ) PV 2013 - 640
May 15, 2014 (CZ) PV 2014 - 338

(51) Int. Cl. H04M 1/02; H04B 1/3883; H02J 7/00; G06F 19/00

(52) U.S. Cl. CPC H04M 1/0262; G06F 19/3418; H04B 1/3883; H02J 7/0044

(57) ABSTRACT

Completion of functions of multimedial devices for auxiliary functions which are not featured in original device. Such functions can be functions for processing of physiologic data, extended and/or uninterrupted operation with regard on monitored and processed data.

Auxiliary function are realized by auxiliary devices and peripheral solutions which are physically placed in original device or outside it, but connected electrically and mechanically with it, whereas preferably able to form one compact mechanical unit with it. These parts which are to be modified in order to achieve uninterrupted functions within operation, are replaceable from the point of view of operation, in maximum simple way for user.

### TECHNICAL FIELD

Subject of the invention is a measure concerning increase of utilizability of electronic devices. It enables uninterrupted function of device within collection and generation of important data, theoretically during unlimited period, independent on replacement of accumulator, which replaces preferably electronic device.

### BACKGROUND ART

Mobile phones in large scale are characterized by unsufficient capacity of supplying accumulators which prevents longterm uninterrupted operation by using applications, especially handy ones which require display and therefore relatively high input of energy. Par example, when are utilized capacities of their software for the most various applications, namely especially for utilization of communication by bluetooth, relatively quick discharging of accumulator occurs and it is necessary to charge the accumulator, either by using network charger or USB port of notebook. Especially if the application of monitoring of health conditions is used, when is necessary to realize continuous monitoring on display, current equipment, due to time of operation without charging, especially in case of mobile phones, will not be convenient. It can obstruct in case of whole number of applications, as par example by monitoring of heart arrhythmia or registration of statistic data in case of sport performance. It is disadvantage that current status is enforcing, in case of discharging of accumulator, par example of mobile phone, to charge it, but due to it, par example mobile phone leaves off being mobile, or to replace accumulator, but due to it the mobile phone is reset, and it is necessary to wait for its restart and also it is lengthy because it is necessary to remove cover of phone. In case of auxiliary accumulators, fastened on mobile phone by different way, par example by means of auxiliary devices, the auxiliary accumulator approximately of the same or higher capacity is used, and thus weight and thickness of device is increased and this is multiplied by the fact that auxiliary accumulator does not charge only mobile phone but basic accumulator as well. Even if, in spite of all disadvantages of current level of technology, user came to the decision to replace accumulators instead of their charging, current level of technology will not offer multiple portable charger for accumulators of mobile phones. Existing chargers do not enable to use them for charging of mobile phones from accumulators placed in them or to use them as bridging source at the moment of replacement of accumulator for uninterrupted operation. Current technology does not enable to replace accumulator of mobile phone during operation and auxiliary devices are increasing thickness of mobile phone approximately by a factor of two mobile phones of current technology and in case of use of application on base of SW for mobile phone, par example in case of system android, the mobile phones are unreliable, because their microprocessor is processing more programs parallel, especially for telephoning.

### DISCLOSURE OF INVENTION

The indicated imperfections of current status of technology eliminates and considerable contribution contrary to known status of technology represents mobile phone with auxiliary functions, which contrary to existing technology is enabling, without increase of thickness of mobile phone, auxiliary functions as it is easy replacement of basic accumulator of mobile phone and thus necessity to charge mobile phone is removed, preferably by means of mechanism for replacement of accumulator which is preferably possible to realize during operation of mobile phone and thereby to ensure its uninterrupted operation preferably by means of source of bridging energy preferably formed by bridging battery or condenser or accumulator with bridging electronics. Further important auxiliary function is, preferably independent processing of data on unit of electronics of mobile phone and application in block of auxiliary modules. Preferably the results are identified on display, auxiliary and independent, on display of mobile phone and/or on part of split screen of module of units and results from electronics of mobile phone on part of split screen of electronics of mobile phone and/or alternatively are displayed gradually, by one of electronics of mobile phone and afterwards of module of auxiliary units of mobile phone on display of mobile phone. Interface divides both parts of split screen.

Bridging accumulator is preferably of substantively smaller dimensions and lower capacity than basic one, but sufficient for to keep mobile phone operation during replacing of basic accumulator when relatively small source of bridging energy supplies operation of mobile phone only for the time of replacement of basic accumulator and thus many times smaller dimensions of mobile phone are reached, contrary to execution with auxiliary accumulator securing not only bridging but also operation of mobile phone and/or charging of basic accumulator and thickness of mobile phone is not increased because to the basic accumulator is not added auxiliary accumulator but basic accumulator is to be replaced. Basic accumulator preferably with substantively higher capacity than bridging one, corresponding with the current accumulator par example in mobile phone, is charging bridging accumulator provided it has enough of energy whereas is easily and quickly replaceable for another one, preferably from the set of accumulators charged in advance in group charger and thanks to the store mechanism of accumulator preferably enabling to place the same basic accumulator in mobile phone and also in charger. Replacement of accumulators in mobile phone with auxiliary functions takes only some seconds preferably during the operation and without removal of cover of mobile phone, contrary to existing technology, when lengthy replacement in the conditions of interruption of operation and necessity to reactivate mobile functions with renewal of respective application is further burdened because of to removal of cover of accumulator at first and then again of installation of it.

Alternatively mobile phone is preferably fastened by strap of mobile phone forming band for fastening of mobile phone on wrist. Contrary to mobile phone which is not fastened on wrist, the mobile phone which is fastened on wrist, is preferably of smaller dimensions and is mainly destinated for operative observation of display on wrist.

Bridging accumulator is preferably of smaller dimensions contrary to basic accumulator because ensures operation of mobile phone only for a short time when replacing of basic accumulator occurs. Operation is ensured by basic accumulator of bigger dimensions than bridging one, usual for current mobile phones which is preferably replaceable for charged one, instead of its charging, preferably during operation, thanks to source of bridging energy, which supplies energy to electronics of mobile phone and module of auxiliary units of supplying module of central electronics of mobile phone during the time of replacing of basic accumulator. For to save place for source of bridging energy, preferably formed by bridging accumulator, is preferably for supply of bridging energy in time of replacement of basic accumulator connected charger, modular or external, or source of bridging energy or casing which substitutes preferably source of bridging energy. Then is preferably, instead of internal source of bridging energy, used external source of bridging energy and in this case internal bridging accumulator is preferably out of use.

Connection of module of auxiliary units and electronics with external devices is preferably done as wireless, by means of wireless links preferably formed by bluetooth or by wire through connector for such a connection of module and/or through connector for data connection of electronics of mobile phone.

Independent processing of data of block of auxiliary modules on unit of electronics of mobile phone is done preferably by placing of minimum one microprocessor, operating independently on electronics of mobile phone, on control unit in module of auxiliary units in block of auxiliary modules which communicates with data connected by wireless connection or independent connector on connector for electronics of mobile phone, operating independently as well. By such an adjustment the reliable operation is achieved and processing of application and incoming data in independently operating module of auxiliary units and is removed less reliable processing of applications and data in electronics of mobile phone which is given by the fact that simultaneously more programs are processed, especially with preference those programs which are ensuring operation of mobile phone. In case that reliable processing of data and applications does not matter, preferably is not applicable module of auxiliary units and described processing of applications and data is realized in electronics of mobile phone where are these applications and data directly brought.

As mechanism for replacement of basic accumulator is preferably used swivel casing forming part of side of mobile phone or auxiliary device and other mechanisms described as examples of execution.

In case of mobile phone, to the receiving of bridging energy for electronics of mobile phone with auxiliary functions and then for its operation, by replacement of basic accumulator without interruption of operation, serves source of bridging energy which in time of replacement supplies mobile phone. This is formed preferably by bridging battery or bridging accumulator, which is regularly charged, or bridging condenser which is continuously charged from basic accumulator through convertor of voltage. Charging electronics adjusts voltage of network charger on the voltage suitable for charging of basic accumulator which is alternative to its replacement for the charged one.

Instead of internal source of bridging energy is possible to use preferably external source of bridging energy which is adapted for charging of basic accumulator and supply of electronics of mobile phone with auxiliary functions at the moment of its replacement.

Module of auxiliary units with independent control unit operating preferably independently on control unit of mobile phone contains internal monitoring units in block of internal monitoring units and is enabling to connect external monitoring units in module of external monitoring units through interface, connector and/or electronic one. Internal units include preferably unit of wireless communication, watchdog unit, checking continuously trouble-free operation, unit of position detection containing preferably acceleration meter or gyroscope, further units forming block internal of monitoring units, including unit of testing of health functions, pulsation receiver 5.5 kHz, ECG unit preferably processing heart signals in ECG curve and/or pulsation curve and/or curve of arrhythmia and/or worked out degree of arrhythmia, variability, monitor of heart signals, unit of alcohol testing and/or drugs and other units.

Over interface, connector and/or electronic one, are connected modules of external monitoring units which preferably include probe of health functions, unit of testing of heath functions external, further unit of alcohol detection and/or drugs, external with probe, units of detectors external and external unit of alcohol or drugs detection. Further advantage is connection of electrodes and sensors placed on wheel of car through ECG connector enabling continuous monitoring of health conditions of driver, preferably of driver of public transport, buses and lorries.

Reliable storing of data or applications in module of auxiliary unit is given by use of minimum one microprocessor independently operating on electronics of mobile phone, in control unit placed in module of auxiliary units having data and signals delivered directly from monitoring units, external or internal, independently on delivery of data into electronics of mobile phone. Electronics of mobile phone does not guarantee reliable processing of data because more programs and applications are processed simultaneously, especially programs and applications for operation of mobile phones, having priority.

Module of auxiliary units contains watchdog producing independent warning signal in case of disfunction of mobile phone.

Module of auxiliary units is preferably processing data from individual monitoring units, sensors and detectors which is economic because in current conditions of technology these data are processed in individual monitoring units independently, where in each of units there is display and microprocessor while in module of auxiliary unit display, preferably of mobile phone, is, used and independently operating microprocessor, together for all monitoring units.

In case that control unit of mobile phone is preferably adapted for direct communication with module of monitoring units internal or external, this communication and processing in electronics of mobile phone is preferably realized. In such a case module of auxiliary units is not preferably applicable which is economic, but less reliable.

To the module of auxiliary unit is preferably connected also unit of alcohol detection and/or drugs, external or internal, which is the advantage especially in case that there are contacts and sensors on wheel of vehicle simultaneously used, therefore the health conditions of driver are continuously tested. In case that are produced the results which are not backing good conditions of driver, preferably driver will use chest strap or electrodes, preferably glued, by means of them is sensed ECG, curve of pulses, arrhythmia, variability more exactly than of the contact with wheel, by hand touch. Device enables to check not only arrhythmia, ECG and variability but it is possible to do the drugs and alcohol test. This is the advantage especially in case of drivers of public transport or lorries. Auxiliary device with block of auxiliary modules and module of auxiliary units with standard mobile phone or in case that unit of wireless communication is contained and/or communication module even without standard phone is preferably built in transport means in which takes place monitoring of person driving the transport means and which communicates with near cooperating units and/or remote ones. Then falls off wearing of auxiliary device with standard phone or phone with auxiliary functions even by monitored person. In such a case monitored person wears only chest strap or electrodes for case of necessity of exact sensing of ECG and other physiologic signals. Preferably is strap and/or electrodes and/or sensors especially of alcohol and/or drugs detection also built in transport means and preferably by sufficiently long cable with auxiliary device in such a way that they are accessible for testing or only free preferably with wireless connection.

Module of auxiliary units of auxiliary device to standard mobile phone with auxiliary functions is provided with same units and functions as module of auxiliary units of mobile phone, above described, with the difference, that connector of module with auxiliary units enables connection to mobile phone, the second connector of module of auxiliary units ensures connection of external devices and the third connector of module of auxiliary units connection to other external devices.

Alternatively bridging energy is obtained from module of charging by stand by condenser.

For easier replacement is preferably the store mechanism of accumulator adapted for lifting of basic accumulator preferably in such a way that there is a spring fastened on door which one lifts up also basic accumulator by opening of door by using a notch which is usual on standard accumulators and it is not necessary to use adapted accumulator, only in case that the notch on accumulator is not giving the guarantee for reliable lifting up of accumulator, then it is possible preferably adjust basic accumulator by sufficient deepening of notch.

Indicated principle of mobile phone with auxiliary function is preferably applicable on existing standard mobile phone which has no indicated auxiliary functions, by means of auxiliary device connected to it, when there is used for operation basic accumulator of mobile phone which by means of mechanism for replacing of basic accumulator is easily replaceable for charged one without removal of cover or auxiliary device in such a way that in auxiliary device which preferably replaces original cover of mobile phone is the side of auxiliary device equipped by mechanism for replacement of accumulator preferable with door enabling such replacement. After its opening the basic accumulator is preferably removed by hand and replaced by charged one which is possible in frame of existing technology.

Source of bridging energy is preferably used also in auxiliary device which is adapted for its fixing on mobile phone by means of holding mechanism of auxiliary device. Source of bridging energy and for block of electronics of auxiliary device is possible to get preferably either from charging and communication connector preferably USB of mobile phone which is enabling the same or from contacts of basic accumulator which is preferable in case that mobile phone does not enable replacement of basic accumulator even when respective voltage is brought to its charging connector. In such a case, during the time of replacement of basic accumulator without interruption of operation source of bridging energy supplies energy directly to mobile phone on contacts for connection of basic accumulator. Manual or automatic switch preferably enables switching of source of bridging energy, for time period when is not realized replacement of basic accumulator, from supplying of energy to mobile phone on supply of auxiliary device and charging of source of bridging energy from mobile phone, with the exception when it is a battery. In case of drawing of energy from contacts of basic accumulator are preferably placed, between its contacts and contacts of mobile phone, contacts springs which are pressed by basic accumulator on contacts of mobile phone and are connected with auxiliary device which supplies together with charging of source of bridging energy, which is preferably of dimensions as small as possible and has capacity which is still able to ensure replacing of basic accumulator without operation interruption. Auxiliary device with such diminished source of bridging energy is preferably of reduced dimensions than auxiliary device with auxiliary accumulator from which is drawn energy not only within the time of replacement of basic accumulator but also for operation of mobile phone and charging of basic accumulator and preferably keeps original thickness of mobile phone by realization of auxiliary device where its block of auxiliary modules is placed at the place of auxiliary device and thus corpus of mobile phone is extended or enlarged, instead of placing above it. Source of bridging energy is part of block of auxiliary modules placed in auxiliary device which is enabling further functions and preferably contains module of auxiliary units with control unit with microprocessor which enables to process applications independently on mobile phone. Energy for auxiliary device and mobile phone within the replacement of accumulator is preferably supplied by replaceable battery or bridging accumulator, which is placed in store mechanism of bridging accumulator and then is easily replaceable, which is replaced for charged one instead of its charging from par example springs on contacts of basic accumulator. Easy removal of basic accumulator is realizable by mechanism for replacement of accumulator formed preferably by door placed in side of auxiliary device and further described designs.

Fixing of auxiliary device in mobile phone is done by fixation mechanism of auxiliary device preferably formed by side of auxiliary device, formed in such a way that for fitting on mobile phone partly surrounded it with overhang for securing of connection. Auxiliary device preferably enlarges mobile phone only in length and/or width and not in height and therefore does not increase thickness of mobile phone.

As other example of execution of auxiliary device which does not increase thickness of mobile phone is preferably into original space for basic accumulator of mobile phone placed internal auxiliary device with smaller basic accumulator which enables to place inside preferably also block of auxiliary modules with bridging source in casing of auxiliary device which by insertion into space of basic accumulator of mobile phone preferably fits closely to original contacts of mobile phone set for connection of basic accumulator and due to it connection between auxiliary device and mobile phone is achieved.

In next variant of connection of auxiliary device to mobile phone is preferably original cover of mobile phone replaced by auxiliary device where fixing mechanism of auxiliary device is preferably formed by holds which fit closely into bulges of cover of mobile phone and therefore both devices are mechanically joined. Easy replacement of basic accumulator ensures mechanism for replacing of basic accumulator preferably formed by door, hinges with axis and latch where preferably switch, by opening of door, is switching charging of bridging accumulator in bridging function of supply of mobile phone. Block of auxiliary modules stored in auxiliary device preferably forms source of bridging energy preferably with bridging accumulator and bipolar switch which is to be switched automatically, preferably by switch on mechanism for replacement of basic accumulator or manually, from charging of bridging accumulator to supply, par example of mobile phone in time of replacing of basic accumulator, further acoustic convertor preferably speaker or piezoelectric convertor, charging electronics par example of mobile phone and block of electronics of auxiliary device further block of electronics of auxiliary device which preferably includes unit of bluetooth, unit of watchdog, unit of detection of position preferably with acceleration meter or gyroscope, control unit with microprocessor, receiver of pulses 5.5 kHz and eventually other electronic units.

Unit of watchdog activates signalization of alarm preferably acoustic and/or visual and/or vibrator preferably by acoustic convertor or LED or vibrator in case when par example mobile phone for certain time does not show correct operation. In case of watchdog placed in mobile phone with auxiliary functions, this is preferably programmed in such a way that its microprocessor unit is realizing in set time intervals suitable time-non-consuming activity, preferably par example product of several figures and if the result is equal to correct result stored in memory then is sent refresh signal to timer of watchdog which resets timer measuring permanently time passed since the last reset. If reset does not come sooner than preset time is over, timer activates acoustic convertor preferably loudspeaker or piezoelectric convertor.

In case of watchdog placed in auxiliary device mobile phone sends result of calculation into the auxiliary device which evaluates it and in case of correct result sends refresh signal to timer of watchdog.

Described mechanical adjustment of auxiliary device as further example of fixing mechanism is preferably adapted in such a way that auxiliary device is connected with original cover of mobile phone by overplating of bendable connecting piece in form adapted to shape of mobile phone to which it is attached and which is possible preferably to glue. Original cover is preferably adjusted for removal of basic accumulator by incising or pressing out of opening on its edges are glued the railings in which is shifted door with pressure surface enabling sliding of door which is after shut preferably arrested by fitting of hollows in protrusions or glued latch. Alternatively it is possible preferably to use swivel door with glued hinges and latch on original cover.

Other variant of execution of fixing mechanism of auxiliary device is universally usable auxiliary device, width of which does not preferably exceed straight part of shorter side of standard mobile phones on which universal auxiliary device is fastened, which is using basic accumulator, containing only block of auxiliary modules therefore does not increase thickness of mobile phone but only the length. Auxiliary device is preferably mechanically connected with mobile phone by insertion into its charging connector preferably supported by gluing of one or two bendable connections connecting auxiliary device with mobile phone. Original cover is, in this case, adapted for removal of basic accumulator by means of mechanism for replacement of basic accumulator preferably formed by incising or pressure of opening in cover of mobile phone in spot of placing of accumulator, in which are installed door preferably shiftable in glued on railings. It is preferably used alternative solution of door in incised or pressed opening in place of placing of accumulator which are as pivoting connected by glued hinges with external cover of mobile phone, par example and secured by glued latch. Instead of door is to be alternatively removed cover of mobile phone.

Other universally usable auxiliary device is preferably mechanically fixed on original cover of mobile phone preferably by connecting layer of glue or velcro fastening. Preferably minimum thickness of auxiliary device is used, given only by block of electronics with very low parts and then preferably lower than auxiliary device using auxiliary accumulator. Discharged basic accumulator in mobile phone, used for operation of mobile phone, is for replacement for charged one, preferable accessible by standard procedure, it means removal of cover whereas auxiliary device procures energy for mobile phone for the time of replacement of basic accumulator without interruption of operation.

Arrangement with removal of cover of mobile phone is possible for removal of basic accumulator preferably modify in such a way that auxiliary device is glued or otherwise affixed on door placed above opening made in cover of mobile phone, preferably original one, for removal of basic accumulator and connected with cover over axis and hinges preferably glued to cover at the same way as is glued latch, therefore by door opening also auxiliary device is uncovered and basic accumulator accessible for to be replaced.

Alternative of fixing of auxiliary device on mobile phone is its placing in protrusions fit to cover of mobile phone, preferably by glue. Preferable is connected auxiliary device which contains only block of auxiliary modules without accumulator, it means that thickness of mobile phone will be increased only slightly and only at the moment when auxiliary device is used. Auxiliary device supplies the bridging energy for mobile phone which is preferably replaced by lifting up of cover of mobile phone which is alternatively in one piece or only as door with auxiliary device. In case of alternative execution when preferably auxiliary device contains auxiliary accumulator, basic accumulator is charged by it. For to be possible to connect independently part of auxiliary accumulator which is more increasing thickness of mobile phone, both parts are provided with protrusions for clicking on and connection.

Advantageous is the solution of simple or multiple casing for accumulators which is also charger for accumulators used for mobile phone and/or auxiliary device and also can be used as powerbank which thanks to used electronics also serves as external source of energy for supply/charging of mobile phone and/or auxiliary device by using cartridge of just set accumulators until to technically possible maximum, because charging electronics gradually declining voltage of accumulators from which energy is taken, is increasing on voltage necessary for external supply. In case of modular charger where the above indicated principle is used, it is possible to put out whichever module of cooperation on external supply, in case for to have respective accumulator fully charged and user wishes that it remains fully charged, for eventual further use.

Thanks to easy fixing of auxiliary device the auxiliary accumulator is preferably applicable only for charging of basic accumulator, therefore it is increasing thickness of mobile phone only for relatively short time. Also part of auxiliary device with block of auxiliary unit is applicable preferably only in case of need and further it is increasing thickness of mobile phone less than charged accumulator. Basic accumulators of mobile phone and auxiliary device, replaced for charged ones without necessity of restart, is possible to charge by universal group charger adapted for flat accumulators of mobile phone on their mounting board the charged accumulators are fixed on side of their contacts of accumulator by group of springly contacts of charger with possibility of shift of whole group of contacts and adjustability of their mutual pitch, on the second hand by shiftable stop and sliding fixing mechanism from sides. Sliding fixing mechanism can preferably form shiftable notch with two fixing elements adapted for shift in grooves made in mounting board. After pressing of notch on side of side of accumulator is position of notch fixed by fastening elements preferably by tightening of nuts. In variant adjustment notch of shiftable fixing mechanism preferably forms part of upper fixation element shiftable along lower fixation element firmly connected with mounting board. Mutual shift of both fixation element along sides with notches of saw shape tooth enables guiding element with spring pressing to it both fixation elements and firmly connected with lower fixation element. By pressing of upper fixation element shiftable in range of length of groove formed in upper guiding element on side of accumulator is the position of upper fixation element and by it also by notch fixed automatically. Imperfections of different placements of accumulator and different store mechanisms and adjustments for such purchase outlined, are eliminating further indicated alternatives and variants of store mechanism accordingly invention, the core of them is based on the fact that they are reducing substantively the thickness of mobile phone and are ensuring possibility of quick replacement of accumulator, namely also without necessity of removal of back cover. Substance is that in auxiliary device or mobile phone is placed mechanism for replacement of basic accumulator, which is adapted for basic accumulator, the side of which is also side of mobile phone or auxiliary device, through which is reduced thickness of mobile phone or auxiliary device for thickness of door or cover and mechanism for replacement it is more simple and due to it failure rate is reduced. One of variants of possible executions is to provide basic accumulator by mounting frame the perimeter panelling of which is closed from upper outside part by thin cover side of accumulator and from lower outside part is preferably open or covered by thin covering foil and in one side of mounting frame are preferably adapted contacts for connection of accumulator with auxiliary device or mobile phone whereas opposite these contacts for connection of accumulator are in auxiliary device or mobile phone preferably adapted springly contacts preferably telescopic and internal side of upper thin covering side is provided preferably with gluing layer for fixing of accumulator and at least on two sides of this mounting frame are preferably adapted arresting elements for fitting of mounting frame in structure of auxiliary device and on outside surface of cover of auxiliary device or mobile phone is at least on one edge of opening for storing of mounting frame is preferably formed shaped slot for fingernail able to be taken out, when opening in cover is adjustable preferably above space for insertion of operation accumulator of mobile phone or another auxiliary mobile device. It is also acceptable when in surface of cover of auxiliary device or mobile phone is in perimeter of opening for insertable mounting frame of mechanism, able to be taken out, for taking out of accumulator, formed seating adapted for insertion of mounting frame with overhangs whereas opposite surface of overhangs and seating are round perimeter preferably provided with antidust profile formed by depression and protrusion. Arrestings are preferably formed by formed protrusions or by shaped protrusions with opposite slots, or magnets with metallic opposite elements. It is suitable if on mounting frame are adapted arrestings, overhang of upper edge of mounting frame with overhang as well as also on mounting frame adapted contact elements are in shape and position adapted not only to construction of mobile phone or auxiliary device but also charger of source modules when store mechanism of accumulator of auxiliary device is preferably the same. Further, it is suitable to adjust charger for charging of basic accumulators or preferably by means of same mechanism for replacement of accumulator or in auxiliary device or mobile phone outlined preferably for charging of more chargers. In this execution is preferably source module adapted for insertion of accumulator with firm packing or without firm packing or without firm packing with contact outlets in form of cables. It is also suitable if source module is formed by accumulator fastened preferably by glue on side of accumulator provided by notch against taking out for fingernail, whereas side of accumulator is secured by sliding closing. Stable charger of source module is able to be realized, segments of which are provided by block of charging electronics connected by connector, LED indication of status of charging where each segment is formed and constructed in shape for insertion of two or four source modules complementary when shafts of these blocks are provided by arresting elements, contacts of interconnection with contacts of source modules and from both flat sides of charging module is formed connected connector of modules of charger and lock of connection of mechanic and electric assembly of chain of charging modules. Principle of further store mechanism of basic accumulator, the part of which is source module, consists in the fact that accumulator is preferably placed in source module which is formed by accumulator connected with mounting frame of different execution preferably provided by contacts and in such a way enables quick manipulation with accumulator during its replacement without taking out of cover of mobile phone preferably formed by mobile phone. Variants of execution of source module are existing. Source module with mounting frame with overhang after insertion of source module into mobile phone preferably in mobile phone is source module fixable by arresting elements of mounting elements and arresting elements of mobile phone which can be preferably made as mechanic holds, magnets. Electric connection of mounting frame with electronics of mobile phone is secured by flexible contacts placed on mobile phone and contacts of mounting frame. Store mechanism of accumulator placed in auxiliary device is enlarging possibilities of use of mobile phone with which auxiliary device is connected. Source module with mounting frame without overhang is in mobile phone mechanically fixed by sliding closing and then without use of arresting elements. Auxiliary device is after removal of original cover of mobile phone connected with mobile phone by fixing mechanism preferably formed by snapping holds of auxiliary device which are manufactured in such a way that they snap in bulges of mobile phone, originally set for fastening of cover of mobile phone. Auxiliary device preferably fits closely to surface of mobile phone along whole its length, therefore by insertion source module is going through opening formed in thin cover of auxiliary device thereby is extended only the whole length of formation of mobile phone with auxiliary device while total height is not almost changed. Electric interconnection of mobile phone with auxiliary device comes by mutual connection of connector USB female with connector USB male. Bridging accumulator securing operation of mobile phone without interruption within the time of replacing of its discharged basic accumulator for charged one, is preferably placed in auxiliary device. By placement of store mechanism in auxiliary device connected with mobile phone is used the space between surface of mobile phone and cover of auxiliary accumulator for insertion of source module with flat mounting frame containing auxiliary accumulator. Source module with mounting framework with overhang in which the accumulator is fixed preferably by glue, preferably by glue layer and thus on side of frame which is preferably thinner because is fortified by frame itself and contrary to another kinds of store devices par example with swivel doors, is preferable. In fact it is self-supporting which enables decrease of thickness of mobile phone. Accumulator is preferably in execution without firm cover through which is decreased installation height of accumulator with contacts of cable execution. Overhang of upper part of frame preferably completed for protrusions formed for such a purpose in side of auxiliary device prevents infiltration of dust. Notch on edge of mounting frame with overhang and fingernail slot on auxiliary device are enabling taking out of frame of auxiliary device. After insertion of source module in auxiliary device or mobile phone upper part of its mounting frame is siding with surface of mobile phone therefore source module is simultaneously replacing its cover. Bottom part of mounting frame can be preferably covered by thin foil therefore it comes to minimalization of height dimension of source module. Mounting frame with accumulator is fixed by arresting elements of mounting frame and arresting elements of mobile phone. Electric interconnection of accumulator with auxiliary device is secured by contacts of mounting frame and flexible contacts, preferably telescopic, forming part of auxiliary device or mobile phone. Variantly with use of mounting frame without overhang, accumulator is also fastened preferably by glue. In case of source module with flat mounting frame with overhang to which accumulator is also fastened by glue, after insertion in mobile phone contacts of accumulator are electrically connected with flexible contacts preferably telescopic which form part of mobile phone or auxiliary device. Arresting elements are in this case fastened by glue preferably to casing of accumulator. In case of use of flat mounting frame without overhang is accumulator fastened to it preferably by glue as well. It is to realize also using of specific accumulator with overhang and arresting elements fitting into counterpart preferably on mobile phone whereas arresting elements are fastened preferably by glue to the cover of accumulator. For this kind of store device is solved modular charger for charging of source modules with accumulators. Base is formed by modules of charger, in each of them it is possible to insert two or four source modules by identical procedure as in case of insertion/taking out in/out of mobile phone. Some modules of charger is possible mechanically in easy way and quickly connect or disconnect with using of locks for insertion and taking out of source modules and electrically interconnect couple of connectors. There is connector adjusted, set for connection of external source and is part of module master and is connected with electronics of module of charger and couple of connectors. Signalization LED informs about state of charging of inserted source modules.

Preferably is chest strap completed by electronics for evaluation of pulsation and/or ECG and/or measurer of variability and two couples of contact areas for continuous sensing of electrical activity of heart muscle. Sensed physiologic and bioelectric signals are delivered preferably in two independent control units which currently are comparing results and in case of revelation of difference they are activating source of sound signal, preferably loudspeaker or vibrator or piezochanger, for sending of warning signal. Signals are further transmitted, wireless, to further processing and graphic displaying preferably to mobile phone with auxiliary functions and/or to auxiliary device by wireless connection preferably in band 2.4 GHz and/or transmitter 5.5 kHz and/or bluetooth with wireless connection 2.4 GHz. Preferably it is possible to dispatch the results to watch with receiver 5.5 kHz.

With further preference are results obtained in one control unit transmitted in block of electronics of auxiliary device and results obtained in the second control unit are transmitted to mobile phone and subsequently both results are compared preferably in block of electronics of auxiliary device and/or in electronic of mobile phone with auxiliary functions. Control unit of chest strap preferably fastened on wrist band is provided with buttons and display and is set for control of electronics of chest strap and displaying. If the values of evaluated parameters exceed the set limit the warning is activated by switching on of vibrator and/or source of sound signal. Advantage of two independent complete systems evaluating heart pulsation and/or ECG is that system is not only backed up which is important for monitoring of vital functions but by comparison of them to verify values and curves processed from physiologic and bioelectric signals.

Invention provides also several possibilities of option of display of data, after their processing sent to cooperating units among others from chest strap on display of mobile phone, preferably numeric projection of values of arrhythmia, variability, breathing, pulsation and also cause of alarm unless comes to warning and/or graphic display of time course of ECG curves with possibility to control sensibility and speed of shift of displayed curves, setting of movement filter and control of multiple line projection. Also individual or multifunctional projection is preferably realized, preferably of ECG curve, curve of pulsation, curve of arrhythmia and curve of variability whereas it is possible to change the details of projection. Preferably it is control of sensibility, speed of shift and degree of filtration of interference suppression during moving of measured subject, made by buttons or touch display, therefore it is possible, if change of setting is done, to observe preferably ECG curves and thus to choose the most suitable setting and it is not necessary.

Communication between near cooperating units is secured by means of wireless connection preferably formed by bluetooth or ANT. Further it is illustrated the connection of mobile phone with auxiliary functions and/or auxiliary device with standard mobile phone on monitor of heart signals sensing and evaluating physiologic and bioelectric signals which are processed in numeric value and curve of pulsation and/or arrhythmia and/or variability and/or ECG curve and/or other data about human body with couples of contact areas and or contact areas on chest strap where is preferably placed and/or electrodes glued and/or other adapted accordingly need for continual sensing of bioelectric signals.

Monitor of heart signals among others preferably contains reset button, panic button, unit of wireless communication, comparing unit and communicates by means of wireless connection 5.5 kHz or wireless connection 2.4 GHz for communication with watch equipped with control unit of watch, band. Monitor cooperates with chest strap and preferably contains unit of sensors of strap which preferably contains among others sensor of breathing, sensor of body temperature.

Monitor communicates preferably with mobile phone by means of wireless connection in band of 5.5 kHz for receiving signal of heart pulsation or bluetooth or ANT. Sensed physiologic or bioelectric signals from contact areas are led to control unit which evaluates the signals and in case of deviation from set limit is sending warning signal preferably through source of sound signal or through some of near cooperating units, Alternatively are physiologic and bioelectric signals preferable recorded from both independent control units which secure their independent processing and preferably currently compare results and in case of revelation of difference and/or deviation from settable standard are activating warning signal preferably by means of source of sound signal preferably loudspeaker or piezochanger or vibrator or wireless connection through cooperating units preferably formed by mobile phone with auxiliary functions, auxiliary device with standard mobile phone, control unit and in case that warning signal is not reset is settable time by reset button, chest strap of optional cooperating unit preferably is sending alarm to optional remote unit formed by server and/or suitable device at other participants preferably PC or standard mobile phone.

Results of minimum one control unit are preferably transmitted by wireless connection for graphic and numeric processing and projection in near cooperating units of standard mobile phone and/or module of auxiliary units in auxiliary device connected with mobile phone standard and/or watch and/or PC and/or projection and control units preferably on wrist band and/or other, whereas wireless connection is preferably formed by bluetooth and/or bluetooth low energy and/or wireless connection of 2.4 GHz and/or wireless connection 5.5 Hz and/or ANT and/or WIFI, whereas projection on indicated units preferably includes values of arrhythmia and/or variability and/or pulsation and/or other medicinal data with respective curves and numeric values with preferably ECG, preferably in control units evaluated and processed from heart signals and respective in indicated units further processed for projection. Other alternative means that results obtained in one control unit, par example control unit are transmitted by one communication channel, by means of wireless connection, into module of auxiliary units preferably to unit of wireless communication preferably formed by unit of bluetooth and results obtained in the second control unit to transmit, par example by second channel to standard mobile phone preferably and afterwards to compare both results preferably in module of auxiliary units of auxiliary device and/or in standard mobile phone and preferably to display the results independently and in case of disharmony to initiate warning signal. Alternatively are, used signals from both channels in indicated units individually without comparison as backup when one of them dropped out of them or in simple form is, used preferably only one channel and only this one is processed and projected. Also alternatively is, used preferably only one couple of contact areas led to both control units thus backup runs just from them. Preferably is monitor together with described connectable units especially mobile phone and/or auxiliary device adapted for full backup, processing and projection of physiologic and bioelectric signals, preferably heart ones as, par example, curve and value of pulsation, ECG arrhythmia and other from contact areas, electrodes up to display with projection of both channels independently and whole system is doubled whereas standard mobile phone with display is doubled by auxiliary device with display or mobile phone with auxiliary functions is doubled by module of auxiliary units and electronics of mobile phone working independently or is doubled in module of auxiliary units with two or more independently working microprocessors or alternatively system is backed up only partially when is only its part doubled or it is not backed up and monitor of heart signals is equipped only by one couple of contact areas and one control unit.

Control unit is preferably fastened to wrist band and contains buttons, display for processing and displaying of data preferably respective curves including ECG and which except processing and projection is preferably set for control of monitor of heart signals and forms with it independent complex working without other units. Control unit is preferably of small dimensions and has only emergency functions necessary for control of monitor of heart signals and simple projection contrary to mobile phone with auxiliary functions which has more functions and detailed projection.

Unless values of valuated parameters exceed some of option limits, there is preferably activated warning by starting of vibrator and/or source of sound signal preferably loudspeaker or piezochanger in monitor of heart signals and/or accordingly option preferably in one of near cooperating units. Preferably in case that warning signal is not reset by button of reset on monitor of heart signals or on other near cooperating units until settable time, alarm is on and is preferably transmitted to remote cooperating units preferably to surveillance centre or other participants, by data or phone.

Monitor of heart signals operates preferably individually without mobile phone with auxiliary functions or auxiliary device with standard mobile phone whereas is preferably handled by control buttons and/or other ones and in its control unit are processed indicated signals which in case of deciation from set limits start warning signal generated by source of sound signal or vibration by means of vibrator. In case that warning signal is not reset by reset button in set time, monitor of heart signals is sending alarm through network of mobile operator to remote cooperating units. Warning signal is able to be set and preferably coded thereby is informing about the kind of alarm and what is its cause. Setting of functions of monitor of heart signals is made preferably by control buttons on monitor of heart signals without necessity of connection of further device or control unit or, par example, of mobile phone. In this case monitor of heart signals informs user about values of measured quantities by sound signals by means of loudspeaker or acoustic changer as indicated above.

In case of connection of auxiliary device control is realized by buttons or touch display of auxiliary device which preferably displays curves and values on display preferably independently on displaying on standard mobile phone for parallel projection on display or backup. Monitor of heart signals preferably contains numeric display and/or of curves for projection of the most important data preferably arrhythmia, heart pulsation, ECG, variability and other data and/or touch display for control and projection preferably of curves of pulsation, arrhythmia, ECO and others. Preferably monitor of heart signals contains watchdog watching its correct activity and activating control unit fails and does not send “refresh signal”. Monitor of heart signals preferably supervises correct activity of mobile phone with auxiliary functions and/or auxiliary device and/or control unit and/or watch for sport and other units in such a way that indicated units are sending through wireless connection optional code or result of respective task preferably of mathematics into monitor of heart signals. In case that code or result is correct, control unit will send “refresh signal” to “watchdog”. When this signal does not come within set time or is not correct, monitor of heart signals will not send refresh signal and alarm is started, initiated in watchdog. Alternatively monitor of heart signals will start alarm independently on watchdog in case that is not receiving correct code. Signals and/or kinds of acoustic and/or vibration alarm are indicating cause of alarm. Except of it they signal preferably discharging of battery, heart pulses and other information.

Memory card preferably removable, preferably is recording data of monitor of heart signals which are to be loaded to PC or another suitable electronic device with display preferably by its move or by means of wireless connection or USB connection by means of connection. Due to it monitor of heart signals is adapted to be used as “Holter” preferably with uninterrupted monitoring simultaneously for live evaluation on display and other data of pulsation and/or arrhythmia and/or variability, in numeric version or indicated by curve and/or ECG, preferably it is possible instead of memory card in monitor of heart signals to use memory card in auxiliary device and/or in standard mobile phone and/or mobile phone with auxiliary functions.

Monitor of heart signals is preferably placed on chest strap or outside it, preferably as wrist band or in module of auxiliary units of mobile phone with auxiliary functions or in module of auxiliary units and ECG electrodes preferably glued as connected cables in sufficient number on monitor of heart signals for ECG screened in it preferably to be optionally adapted for 1 to 12 leads and be backed up. Connection to remote units as par example server, is preferably made by means of network of mobile operator. On server has preferably access surveillance centre and participants. Connection through network of mobile operator has auxiliary device and standard mobile phone preferably independently for backup.

Alternatively, instead of system of standard mobile phone with auxiliary device or simultaneously with it, is used mobile phone with auxiliary functions which has the same functions as system and fully substitutes it. Advantage of system is in fact that auxiliary device is removable and applicable in case of need and only with such kind of auxiliary device where its function complies with momentary need and in equipment preferably with option sensors from set of auxiliary device therefore standard mobile phone is expanded for option functions only in case of need, it means that mobile phone of smaller dimensions and less costly. Auxiliary device contains module of auxiliary units which are removable with it of standard mobile phone while in mobile phone with auxiliary functions is module of auxiliary units firmly built in. Electronics of mobile phone with auxiliary functions is contained also in standard mobile phone as electronics of standard mobile phone with the same functions. Auxiliary device with standard mobile phone are preferably containing unit of wireless communication placed in module of auxiliary devices, preferably formed by unit of bluetooth or ANT for communication of near cooperating units.

Communication through network of mobile operator secures connection of near cooperating units, which are monitor of heart signals, mobile phone with auxiliary functions, standard mobile phone with auxiliary device and control unit, with remote cooperating units preferably with server on which are stored pieces of information, connected preferably on PC of operator whereas pieces of information are accessible to remote cooperating units and authorized participants as par example medical staff, relatives and other and preferably surveillance centre. Indicated communication is enabled by communication unit with parts for data and/or voice communication by means of network of mobile operator.

Mobile phone with auxiliary functions preferably on wrist band, of smaller dimensions than mobile phone with auxiliary functions without band, communicating with monitor of heart signals, preferably simplified without backup. For backup mobile phone with auxiliary functions preferably communicates with monitor of heart signals on two channels by means of communication wireless connection on module of auxiliary units and wireless connection on electronics of mobile phone. It is possible the backed up communication alternatively instead of communication with module of auxiliary device and also electronics of mobile phone to realize only with module of auxiliary devices, where the second channel of wireless connection is preferably processed by second microprocessor in control unit of module of auxiliary devices. Mobile phone with auxiliary devices on band, of smaller dimensions will process data in control unit of module of auxiliary devices separated from control unit of mobile phone and therefore working reliable and preferably passes processed data to mobile phone standard, of bigger dimensions which secures detailed projection on larger display than mobile phone with auxiliary device on band. Preferably there is on mobile phone with auxiliary functions on wrist operative instant view on smaller display and in standard mobile phone detailed view on larger display which is not instant in case that is kept in pocket. Mobile phone with auxiliary functions on band secures reliability of processing of data and instant view on emergency smaller display of smaller mobile phone with auxiliary functions on band, projection with detailed view secures bigger mobile phone for detailed displaying. Mobile phone with auxiliary functions is working independently on mobile phone for detailed projection even when is not connected. In case of non-backed up communication only on one channel of wireless connection is alternatively instead of monitor of heart signals in classic execution used monitor of heart signals of economic execution which is not adapted for backup and therefore is simpler and smaller, of smaller dimension and consumption of power.

Mobile phone with auxiliary functions preferably displays option data of mobile phone for detailed projection, par example data about incoming calls or SMS which preferably takes over. Similarly, for described communication with mobile phone for detailed projection on monitors of heart signals there is used standard mobile phone with auxiliary device or projection and control unit. In case of use of mobile phone with auxiliary functions, due to economic and dimensions reasons, mobile phone with auxiliary functions and mobile phone standard as well, is not preferably equipped by parts for communication with mobile operator, it is then smaller and less costly and for communication in network of mobile operator is preferably used mobile phone for detailed projection.

Connection between mobile phone with auxiliary functions or standard mobile phone with auxiliary device is not backup connection and connection by means of wireless connection is only module of auxiliary units, processing data and sending them to electronics of mobile phone and from there they are sent to mobile phone for detailed projection or connection is realized by means of wireless connection to control unit and from it directly to mobile phone.

Data produced by monitor of heart signals on display of monitor of heart signals and/or on display of mobile phone with auxiliary functions and/or auxiliary device with mobile phone and/or watch and/or control unit and/or other units. Projecting part preferably formed by display, by numeric projection preferably displays value of arrhythmia, value of variability, value of breath, value of pulsation and cause of alarm unless alarm situation occurs. Projecting part is preferably universal and displays course of curves, par example curve of ECG, is touch handled, par example by control of sensibility, control of speed of shift of displayed curves, further, control of movement filter preferably for calm, walking, running and control of multilead projection settable preferably on display with displaying of ECG curve which is correcting in order to recognize immediately results of setting. It displays preferably curve of pulsation, curve of arrhythmia and curve of variability whereas it is possible to observe change instantly within realization and to set suitable value. These quantities and/or curves are preferably displayed individually or in groups, on one displaying unit. Value of arrhythmia is preferably put in % of irregular pulses from total ones for optional time period, or in degrees of arrhythmia preferably in values from 1 to 10 taken as 1/10 of above stated % of irregular pulses or in another adequate scale preferably expressed orally as arrhythmia: none, low, middle, high, very high. Irregular pulses are to be understood these ones which are exceeding value 1.15 or average pulsation measured of set number of pulses, preferably of 3 pulses for filtration of disturbance mostly to the detriment of accuracy of projection.

Further advantage in execution of invention is sensing of physiologic and bioelectric signals from external sensors glued and/or placed on T-shirt and/or internal sensors on chest strap and/or directly on mobile phone and/or wrist band and enables their wireless or wire transmission to processing and projection on mobile phone and/or auxiliary device. Probes for internal sensors are either part of surface of mobile phone and/or auxiliary device or they are connectable to them by wire or wireless.

With preference there is execution when the probes are placed on internal side of wear, fit closely to body with secured contacts with body and at the same time is their wearing comfortable for monitored person.

With preference there is the execution, if in case of glued probes on surface of human body, their connection with mobile phone and/or auxiliary device placed on wrist band by thin conductors in such a way that it is not disturbing the monitored person and is not noticeable for person's environs, whereas monitored person has permanent overview thanks to pieces of information displayed on displaying unit and/or display of mobile phone placed on wrist band. With preference there is execution when external sensors placed on control device of means with human operation, preferably on wheel of car. On wheel of car, on handlebars of motorcycle, bike, joystick of aircraft, control levers of transport building and other machines.

Auxiliary device is designed variantly, accordingly wish of user concerning shape and size, with regard on required functions extended.

### BRIEF DESCRIPTION OF DRAWINGS

FIG. 1 Mobile telephone with auxiliary functions with a mechanism for exchange basic accumulator

Det. 1 to FIG. 1 Example of assembly of adapted mobile phone with auxiliary functions

FIG. 2 Detail of the mechanism for exchange of basic accumulator

Det. 1 to FIG. 2 Released rotatable case by shifting of closure

Det. 1 to FIG. 2 Basic accumulator replaceable without necessity to remove cover

FIG. 3 An example of block diagram of module supplying the electronics of mobile telephone

FIG. 4 The external source bridging energy usage instead of internal bridging energy source

FIG. 5 Module of auxiliary monitoring units with control unit

FIG. 6 A block diagram of power supply electronics for example of mobile telephone FIG. 7 An example of completion of standard mobile telephone with a mechanism for quick basic accumulator exchange

Det. 1 to FIG. 7 Closed door of mechanism for exchange of basic accumulator

Det. 2 to FIG. 7 Detail of releasing of basic accumulator by drawing accumulator apart from spring

Det. 3 to FIG. 7 partial slide of basic accumulator while door are opening

FIG. 8 Mobile telephone with detachable auxiliary device adapted for simple exchange of basic accumulator by charged one

Det. 1 to FIG. 8 Contact spring inserted between contacts of basic accumulator and flexible contacts

Det. 2 to FIG. 8 Detailed picture of contact spring with connected cable

Det. 3 to FIG. 8 Power supply module in auxiliary device

Det. 4 to FIG. 8 Module of auxiliary units of auxiliary device

FIG. 9 An example of fixing auxiliary device with mechanism for exchange of basic accumulator fixed on mobile telephone on formed side

FIG. 10 Auxiliary device which is inserted into space of basic accumulator

FIG. 11 Another embodiment of an auxiliary device with simple accumulators exchange

Det. 1 to FIG. 11 Original cover of mobile telephone is replaced by auxiliary device

Det. 2 to FIG. 11 Detail of latch which by sliding in the way according arrow release door

FIG. 12 Block diagram of detection activity of watchdog

FIG. 13 Adapted auxiliary device joined with mobile phone by plating and gluing

FIG. 14 A universal usable auxiliary device Det. 1 to FIG. 14 An alternative solution with door located above cutting out or press out opening in the accumulator placement

FIG. 15 All-purpose usable auxiliary device which is mechanically connected with original by screws or contact layer

FIG. 16 All purpose usable auxiliary device with block of electronics and contact layer

FIG. 16a All-purpose usable auxiliary device snaped to original mobile phone cover protrusions in

Det. 1 to FIG. 16a Alternative embodiment of protrusion with connector, into which a connector of auxiliary device is inserted

Det. 2 to FIG. 16a Embodiment of auxiliary equipment with individually removable parts of block of auxiliary modules

FIG. 17 Accumulator storing mechanism located in mobile phone and auxiliary device with power supply module

FIG. 18 Common mobile telephone with auxiliary device with power supply module with carrying frame with side wall without overlap

FIG. 19 Source module comprised by additional accumulator with attached wall

FIG. 20 Source module with supporting frame with overlap

FIG. 20a An example of source module using the supporting frame without overlapping

FIG. 21 Source module with side with overlapping to which the basic accumulator is fastened

FIG. 21a A source module with wall formed by side of accumulator, which is rounded

FIG. 21b Mechanic connection of arresting elements a modular charger for charging source modules with auxiliary accumulator and/or basic accumulator

FIG. 22 Utilization of formed accumulator in formed frame with overlaps

FIG. 23 A modular charger for charging source modules with accumulators

FIG. 23a Module of charger of accumulators for placement of four cases for accumulators at the same time

FIG. 24 An example of group charger

Det. 1 to FIG. 24 An example of sliding mechanism with protrusion and two fastening elements adapted for sliding in the grooves

Det. 2 to FIG. 24 An example of sliding mechanism with protrusion is part of upper fastening element

FIG. 25 The block scheme of an basic accumulators charger example

FIG. 26 An all-purpose charger for four accumulators simultaneous charging

Det. 1 to FIG. 26 Flexible contacts on angle plate movable in groove

Det. 2 to FIG. 26 Fixation of sliding contacts with contact pad

Det. 3 to FIG. 26 Side view of contacts

Det. 4 to FIG. 26 Side view of another contact

Det. 5 to FIG. 26 Possibility of placement of charged accumulators on both sides of board

FIG. 27 A simplified version of all-purpose charger, where stops and contacts are fastened by soldering to a mounting board

FIG. 28 Casing for 4 spare basic accumulators

FIG. 29 Connection of mobile telephone to monitor of heart signals and other data about human body Det. 1 to FIG. 29 Communication of narrow cooperating units over the network of mobile operator

Det. 2 to FIG. 29 Adapted mobile telephone on bracelet on wrist

Det. 3 to FIG. 29 Simplified version of communication without doubling connection

Det. 4 to FIG. 29 Simply replaceable basic accumulator for adapted mobile telephone, placed on bracelet

FIG. 30 The examples of projection of data produced with monitor of heart signals on display

FIG. 31 Connection of glued electrodes to mobile telephone

FIG. 32 Connection of sensors to mobile telephone

FIG. 33 Construction solution of auxiliary devices

### BEST MODES FOR CARRYING OUT THE INVENTION

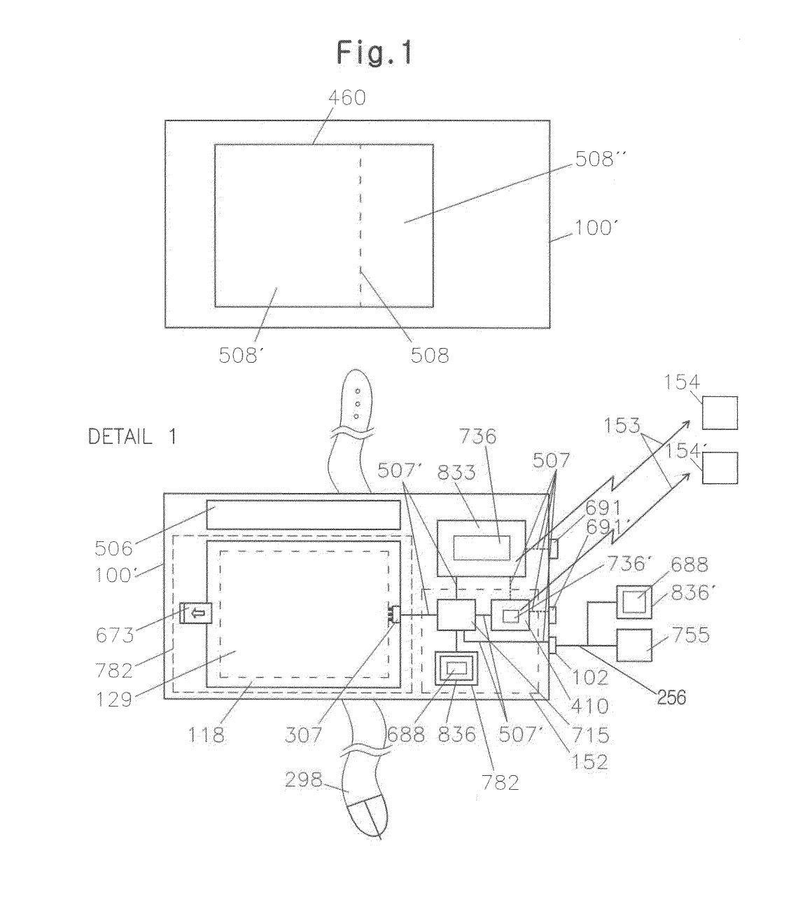

On FIG. 1 and its details is presented a mobile telephone 100′ adapted with auxiliary functions with a mechanism 782 for exchange basic accumulator 129 and block 152 of auxiliary nodules for realization of these functions, namely easy pulling out the basic accumulator without removing the back cover of the mobile telephone or auxiliary device preferably without interrupting operation and preferably on electronic unit 833 of mobile telephone independently of data processing and application in block 1 auxiliary independent 152 auxiliary modules, preferably results are imaged on display 506 auxiliary independent of display 406 of mobile phone and/or on a part split screen 508″ of module of units, and results from electronics 833 of mobile telephone on a part of split screen 508′ electronics of mobile telephone and/or alternatively is imaged successively, once from electronics 833 of mobile telephone and then from module 410 of auxiliary units from mobile telephone on the display 46 of mobile telephone. Interface 508 splits both parts to split screen.

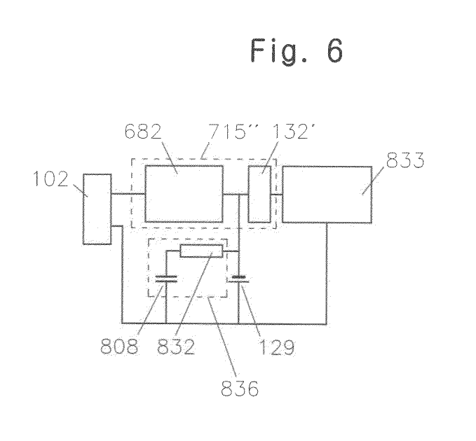

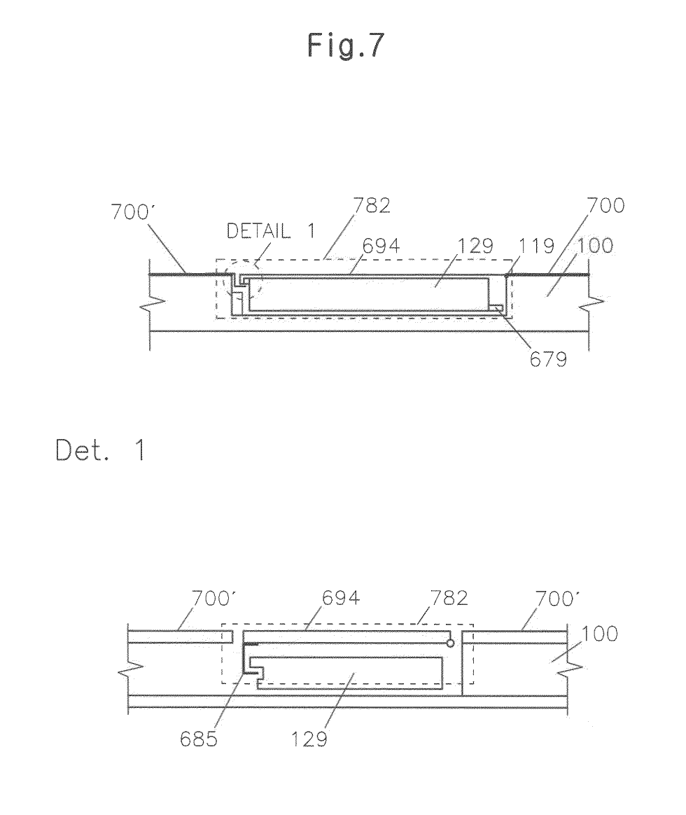

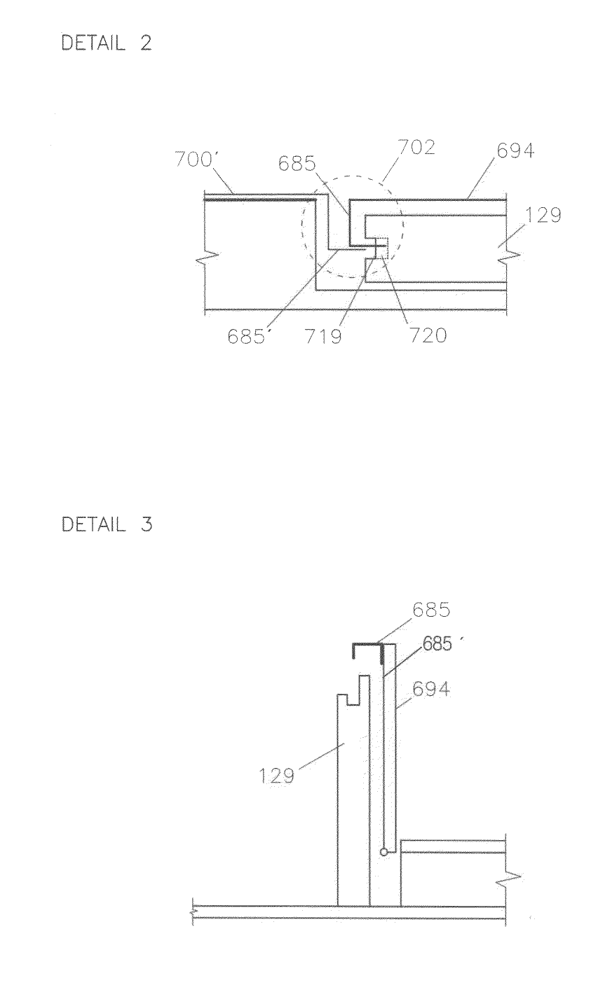

Detail 1 From parts which mobile telephone 100′ with auxiliary functions contains is presented electronics 833 of mobile telephone with control unit 736 with microprocessor and electronics of mobile telephone, mechanism 782″ for exchange of basic accumulator with swivel casing 118 stopper of door, stopper of door 673 and contacts 307 for connecting accumulator and block 152 of auxiliary modules including module 715 for supplying electronics of mobile telephone, power source 836 with bridging energy placed in mechanism 782 for exchange of auxiliary accumulator preferably comprising by bridging accumulator 688 and module 410 of auxiliary units of mobile telephone with second control unit 736′ with microprocessor. Interconnecting of modules and units is made by data connections 507 and supplying connection 507′. Alternatively is preferably fastened to the mobile phone 100′ a band 298 making a bracelet for fastening the mobile telephone to wrist. Bridging accumulator 688, which is preferably smaller in size comparing it with basic accumulator 129, because is ensuring the operation of mobile telephone 100′ only for short time during exchange of accumulator 129. Basic accumulator 129 preferably with higher power capacity and bigger in size than bridging accumulator 688, currently used for mobile telephones ensure operation of mobile phones 100′ and is preferably replaced by charged one during operation thanks to bridging energy source 836, which is supplying with power the electronics 833 of mobile telephone and the module 410 of auxiliary units through module 715 supplying electronics of mobile telephone during the accumulator exchange. For saving space for source 836 bridging energy made preferably by bridging accumulator 688 is for supplying of energy during exchange of basic accumulator 129 through tie connector 102 and cable 256 charging, connects charger 755 or charger 755′ modular or external source 836′ bridging energy, or casing 886 witch source of bridging energy replaces. There is preferably instead of internal source 836″ of bridging energy which is situated in mechanism 782′ for exchange of auxiliary accumulator used an external source 836′ of bridging energy connected through cable 256 and tie connector 102 as described in particular in FIG. 6. In this case bridging accumulator 688 falls off. Data connection of module 410 auxiliary units and electronics 833 with external devices 154, 154′ is preferably accomplished wirelessly by means of wireless connection 153 comprised preferably by Bluetooth, or through connector 961′ for data connecting of module 410 and through connector 691 for data connecting the electronics of mobile telephone. Independent data processing of block 152 of auxiliary modules on unit of electronics 833 of mobile telephone is carried out preferably by placing at least one microprocessor on independently working electronics 833 of mobile telephone to control unit 736 in module 410 of auxiliary units, which communicate with data connected wirelessly 153 or by connector 691′ for data connection independent on connector 691 for electronics 833 of mobile telephone working independently

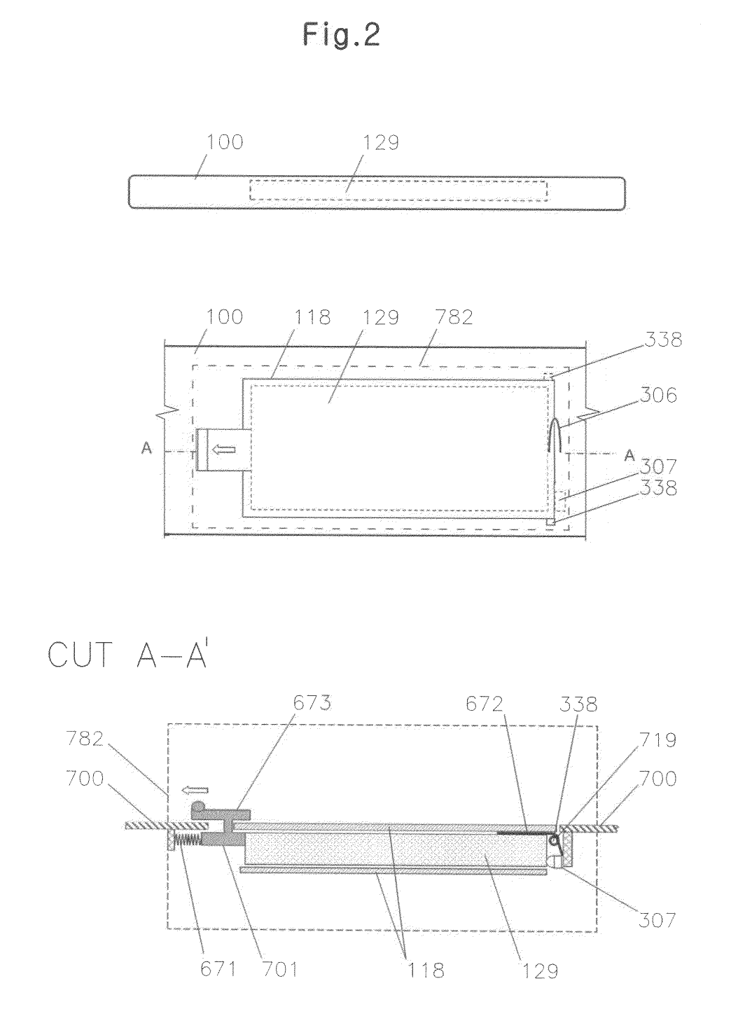

On FIG. 2 is presented in detail the mechanism 782 for exchange of basic accumulator where from cross section A-A and

Detail 1 is apparent how after shifting the lock of door in arrow direction the spring 672 swivel the released swivel casing 118 of mechanism 782 around the hinge 119 of swivel casing with hinge 338 of tipping case 118, for exchange of basic accumulator 129.

On the Detail 2 is imaged basic accumulator 129, where for its exchange preferably without necessity of removing the back cover, where for its exchange preferably without necessity of removing the back cover 700 of standard mobile telephone 100′ or auxiliary device or other part is placed in mechanism 782 for exchange of basic accumulator 129 preferably formed tipping casing 118 where the upper part creates as well door in side of cover 700 of mobile telephone. The exchange of basic accumulator 129 is carried out so, that the door 673 is unlocked by shifting the lock in arrow direction, opposite against the spring 67 which releases the tipping casing 118 of mechanism 782 for exchange of basic accumulator 129 which is shifted away from flexible contacts 30T, . . . for instance of mobile telephone 100, where the flexible contacts shift the accumulator forward and the second spring 672 slightly the swivel casing 118 on a pivot 338 thanks the second spring on cross-section A-A, and then the spring 306 ejects slightly the auxiliary accumulator from the swivel casing 118. After inserting a charged accumulator 129 the swivel casting 118 of mechanism 782 for accumulator 129 exchange is closed and the swivel and a shutter 673 locks the swivel casing, whereas the accumulator is shifted forward pushing by a spring 671 pushes the basic accumulator into contacts 307 for connecting the accumulator.

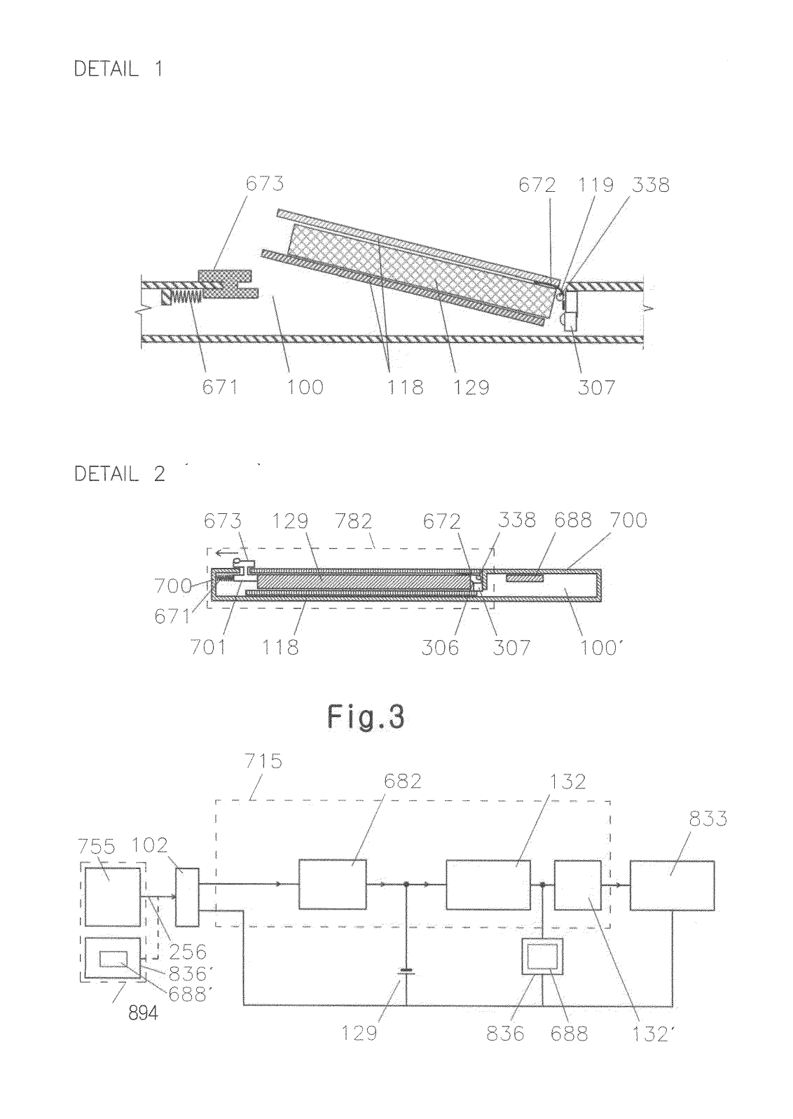

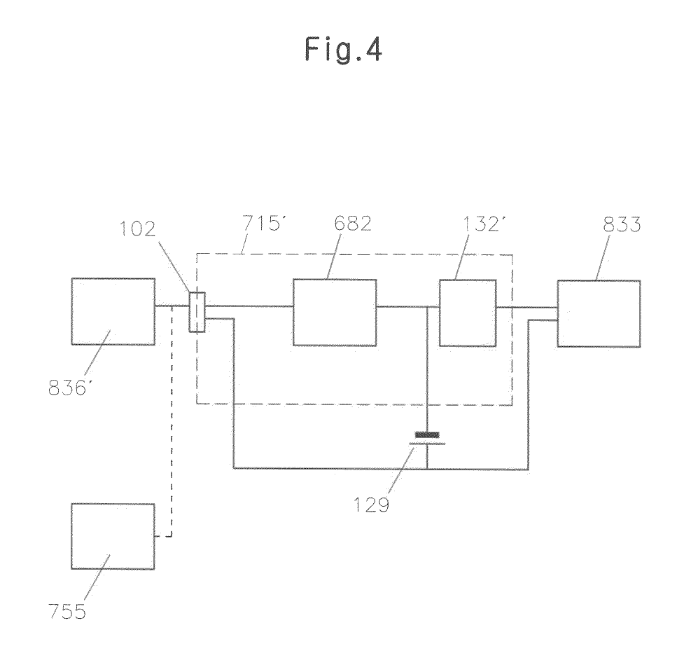

On FIG. 3 is an example of block diagram of module 715 supplying the electronics of mobile telephone 100′ represented on FIG. 2 and adapted for exchange of accumulator 129 during mobile telephone 100′ operation. Tie connector 102 for supplying is connected with suitable external charger 894 for instance a network charger 75, or USB port of PC with voltage 5V or external source 836′ of bridging energy. This voltage is lead to charging unit 682 of basic accumulator. This unit charges the basic accumulator 129, which can be instead of charging can be preferably exchanged by another charged basic accumulator 129. In this case using a network charger is not necessary. This voltage is also led through voltage converter 132′ of bridging accumulator for recharging of internal source 836 of bridging energy, which during the exchange of basic accumulator 129 takes over supplying electronics 833 of mobile telephone. In case when during the exchange of accumulator 129 is connected a charger 755 or external source 836′ of bridging energy, preferably the source of energy 836 is not used which saves the space in mobile telephone 100′ with auxiliary functions as presented on block scheme on FIG. 4.

FIG. 4 shows usage of external source 836′ of bridging energy instead of source 836 of internal bridging energy during the exchange of basic accumulator 129 for charged one. Its charge is processed by means of module 715′ for feeding the electronics of mobile telephone for external source, the voltage converter is not applied.

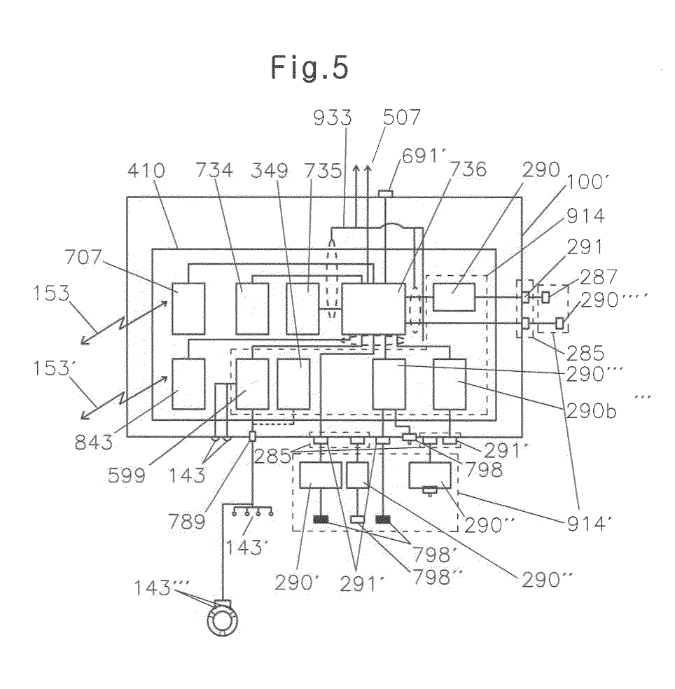

FIG. 5 presents module 410 of auxiliary units preferably formed by mobile telephone, which contains a unit of wireless communication 707 and/or Bluetooth and/or ANT and/or WiFi and/or a network of mobile operator with other suitable wireless media, further module of auxiliary units 410 containing watchdog 234, which produces warning sound in case of malfunction of mobile telephone 100′ unit of position detection 735, preferably accelerometer or gyroscope, control unit 736 with at least one microprocessor which is adapted for independent operation of microprocessor of mobile telephone 100′ and is adapted to independent and simultaneous processing not only applications processed in electronics 833 of mobile phone, but even other applications preferably health application, module 410 of auxiliary units contains receiver 843 for 5.5 kHz and further electronic units 844 adapted preferably for processing health applications. Unit ECG 599 processes heart signal from external electrodes 797′ placed preferably on a chest strap, or glued and connected by wires and connector 789 to ECG or from internal electrodes 143 fastened on surface of mobile telephone 100′. Alternatively can be connected by wireless connection 153 and unit of wireless communication 707 to external source of signal ECG, preferably to a monitor 345 of heart signals. ECG unit 599 preferably processes to a curve ECG, and/or curve of heart beat, and/or curve of arrhythmia or calculated degree of arrhythmia, variability and control unit 736 hands over for further processing and displaying. Internal unit of detectors 290 processes data and signals from probes 287 of health functions connected through additional connector 291. Probes 798′ are sounding health quantities, for instance alcohol and drugs test, blood saturation with oxygen, diabetes values, dilution of blood INR, breath frequency, blood pressure and other functions depending on connected probes in connectors 291′. External unit of detectors 290′ extends functions of internal unit 290 and is connected by means of connector 291. Wireless inductive connection 153′ preferably 5.5 kHz mediates connection of module 410′ of auxiliary units with for instance sport watch with pulse receiver preferably 5.5 kHz. Wire connection of auxiliary units 410 is realized through connector 691′ for data connection of mobile telephone independently of electronic 33 of mobile telephone as well as through wireless connection 153. Control unit 736 is preferably adapted for direct communication with module of internal monitoring units 914 and external monitoring units 914′ and in this case modules 410 and 410′ are realized without control unit 736. Connection of modules 914, 914′ is realized directly to control unit 236 of mobile telephone by means of connections of monitoring modules 933 as well as to data connection 507. Advantage of data processing in module of auxiliary units 410 is reliability, which is higher than data processing in electronics 833 of mobile telephone because there are processed also functions of mobile telephone and other applications and in case of need can be applied more microprocessors for further enhancement of reliability. Through connector interface 285, or electronically are connected external monitoring modules 914′ which preferably comprise probes 287 of health functions, unit 290″″ of testing external health functions, further unit 290′ for testing of alcohol and/or drugs with external probe 798′, unit 290″ and external unit 290′″ for alcohol or drugs testing. A further advantage is connection of electrodes 143′ external and electrodes 143″ placed on steering wheel 934 of car through connector 789 ECG which enables continuous monitoring the health condition of driver, preferably driver of public transportation.

FIG. 6 shows a block diagram 833 of electronics of mobile telephone 100′ adapted with a bridging accumulator 808, where voltage for charging the basic accumulator 129 is brought up from a tie connector 102 where feeding voltage is converted for charging of it in charging electronic 682 of basic accumulator in module 715″ feeding with a capacitor. Through limiting resistor 832 or electronics is simultaneously charged bridging capacitor 808. In case of basic accumulator 129 exchange the bridging voltage provides bridging accumulator 808 of sufficient high capacity in order to be ready to keep the voltage for mobile telephone electronic 831 during the time of basic accumulator exchange. Resistor 832 or electronics serves for reducing the current peak at connecting the fully charged basic accumulator 129 in case when bridging accumulator 688 is mainly discharged.

FIG. 7 and its details presents as an example completion of standard mobile telephone 100 with a mechanism 782 for quick basic accumulator 129 exchange without removing the original back cover of a mobile telephone by an adapted back cover 700′ of mobile telephone 100 or by auxiliary device 104 on which is this mechanism 782 for basic accumulator 129 mounted. The adapted back cover is preferably applied by exchange for original cover 700 for instance a mobile telephone where the original accumulator 129 removable by hand after folding up the small door 694 on a hinge 119 of swivel casing fastened to the cover 700′ of for easier removing as shows

Detail 1 which illustrates closed small door 694 of mechanism 782 for exchange basic accumulator 129 attached on cover 700′ standard mobile telephone 100.

Detail 2 illustrates opened small doors 694 where is apparent how the basic accumulator 129 is released by departs from spring 685.

Detail 3 shows the basic accumulator 129 at opening the small door 694 which is shifted by folded end of the spring 685 attached on small door 694, where when closed the spring 685 attached on small doors 694 preferably touches down on a spring 685′ mounted on side of the cover 700′ and creates contact of a switch 702. The basic accumulator 129 is connected for instance to s mobile telephone 100 (standard) by original flexible contacts. The basic accumulator 129, for instance for mobile telephones has mostly a recess 719 for removing it by fingernail. This recess 719 is mostly too shallow and preferably it can be enlarged.

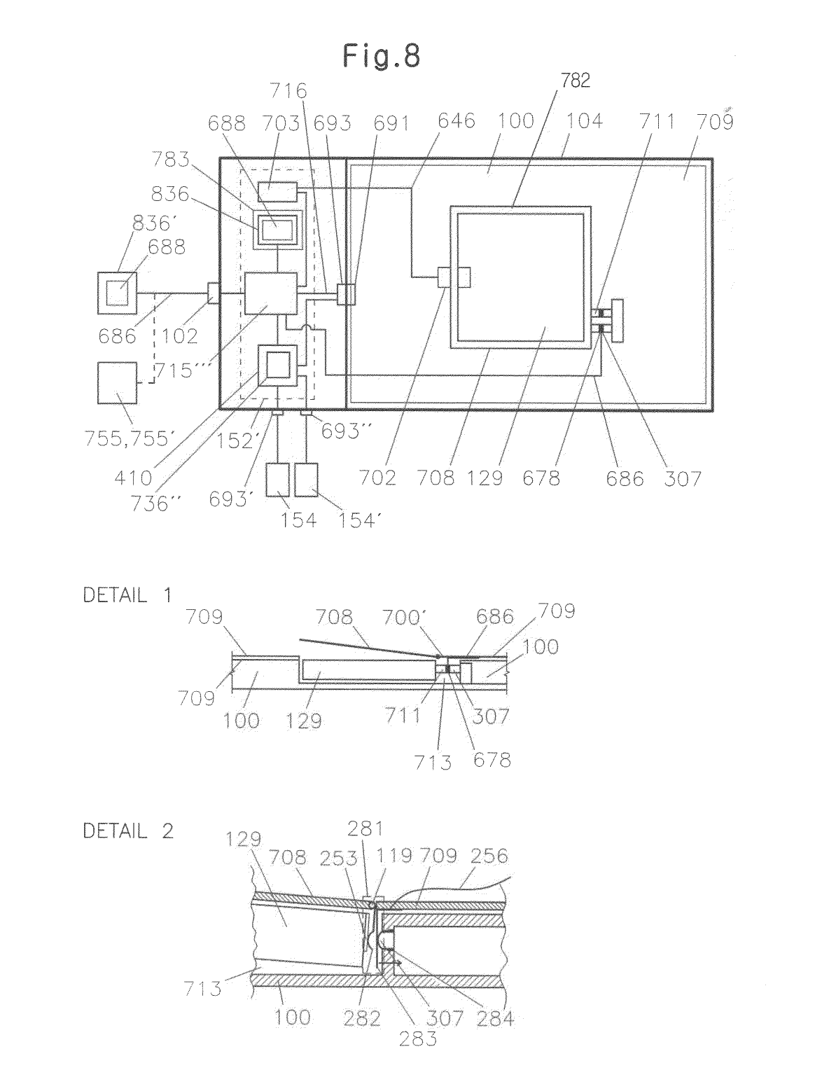

FIG. 8 presents a standard mobile telephone 100 with additional functions in auxiliary device 104 which is provided with mechanism 72 for easy exchange of basic accumulator 129 preferably formed by hinged door 708 and a block 152′ of auxiliary modules, for realization of auxiliary functions, namely easy removing the basic accumulator 129 without necessity of removing auxiliary device with advantage without interrupting the operation of mobile telephone and preferably on the unit of electronics 833 of the mobile telephone independent data processing and application in block 152′ of auxiliary device, which is realized similarly as described on FIG. 1. By means of second connector 693′ of auxiliary device is a module 4Q of auxiliary units connected with external device 154′ and through connector 693″ and the third connector with external device 154′ with a module 410 of auxiliary units is modified to mediate communication between external device 154′ and mobile telephone 100 which can substitute data communication of mobile telephone from connector 691 which is blocked when auxiliary device is applied. Auxiliary device 104 is adapted for easy exchange of basic accumulator 129 for charged one preferably without mobile telephone 100 interruption and without enlarging its thickness.

Auxiliary device 104 is coupled on mobile telephone 100 with advantage removable and contains the upper side 709 with hinged door 708 which preferably replaces original cover 700 of mobile telephone which elongate mobile telephone it or broaden it while the thickness is not changed or is thicker only for thickness of the side of auxiliary device 104 which contains the source of bridging energy 688 in this example presented, or accumulator or bridging capacitor 808 and module 715′″ supplying auxiliary device, which supplies from basic accumulator 129 through connector 691 mobile telephone, connector 693 of auxiliary device and connection 716 supplying the auxiliary device 104 and during the accumulator 129 exchange supplies a standard mobile telephone 100 from source 836 of bridging energy. Changing-over switching the module 715′″ of supplying the auxiliary device 104 for supplying mobile telephone 100 makes change-over switch 703. Mobile telephones which do not enable delivery of energy to auxiliary device 104 through connector 691 of mobile telephone and/or basic accumulator 129 exchange without operation also at charging through connector 691, the energy for supplying of auxiliary device is preferably taken from contact springs 678 and bridging cable 686 from basic accumulator 129 whose contacts 711 of basic accumulator sit on contact spring 678 which by its second side sits on contacts 307 of mobile telephone where bridging cable 686 is connected preferably to contacts 307 for example soldered. The supplying of mobile telephone 100 during the exchange of basic accumulator 129 is realized preferably through connectors 307 and bridging cable 686. Charging module 715′″ in auxiliary device is switched from charging from external source 836 of bridging energy to power supplying of standard mobile telephone 100 during the basic accumulator 129 exchange, preferably by a manual or electronic change-over switch 703, controlled preferably by switch 702 in time when the small door are open 708 during exchange of basic accumulator 129 with interconnected by cable 646. The change-over switch is alternatively controlled from standard mobile telephone 100 through connector 691 by data signals which is processed in module 410 of auxiliary units and controls change-over switch 703 in module 215″ of power supply. The supplying of mobile telephone 100 from auxiliary device 104 is realized alternatively with advantage through connection 716 and connectors 691 with advantage USB supplying and communicating at mobile telephones 100 which it enable. For saving space, necessary for external source 836′ of bridging energy charger 755 is advantageously for its substitution comes the bridging energy from external source 836′, bridging energy preferably made by basic accumulator 129 placed preferably in charger 755, connected for bridging exchange of basic accumulator 129 in mobile telephone 100 by external bridging cable 686. The source 836 of bridging energy is preferably made of bridging accumulator 688 and preferably placed in mechanics 783 for exchange of bridging accumulator 688 which is preferably applied for supplying auxiliary device 104 and mobile telephone 100 through connectors 693, 691 in time of exchange of basic accumulator 129. In case when mobile telephone 100 does not enable to utilize electric power through connector 691 of mobile telephone, is realized through contacts 307 for connecting with basic accumulator 129. Likewise is preferably alternatively substitution of source 836 of bridging energy illustrated on FIG. 1 where is alternatively substituted source 836 of bridging energy by external source 836′ of bridging energy. The auxiliary device 104 contains block 152′ of auxiliary modules of auxiliary device with module 410 of auxiliary units with control unit 736 with microprocessor of block auxiliary control.

Detail 1 presents the contact spring 678, put between contacts 711 of basic accumulator and springy contacts 307, for instance mobile telephone where the basic accumulator 129 pushes the contact spring 678 to springy contacts, for example mobile phones, for good contacts is the basic accumulator 129 placed in space 713 of basic accumulator,

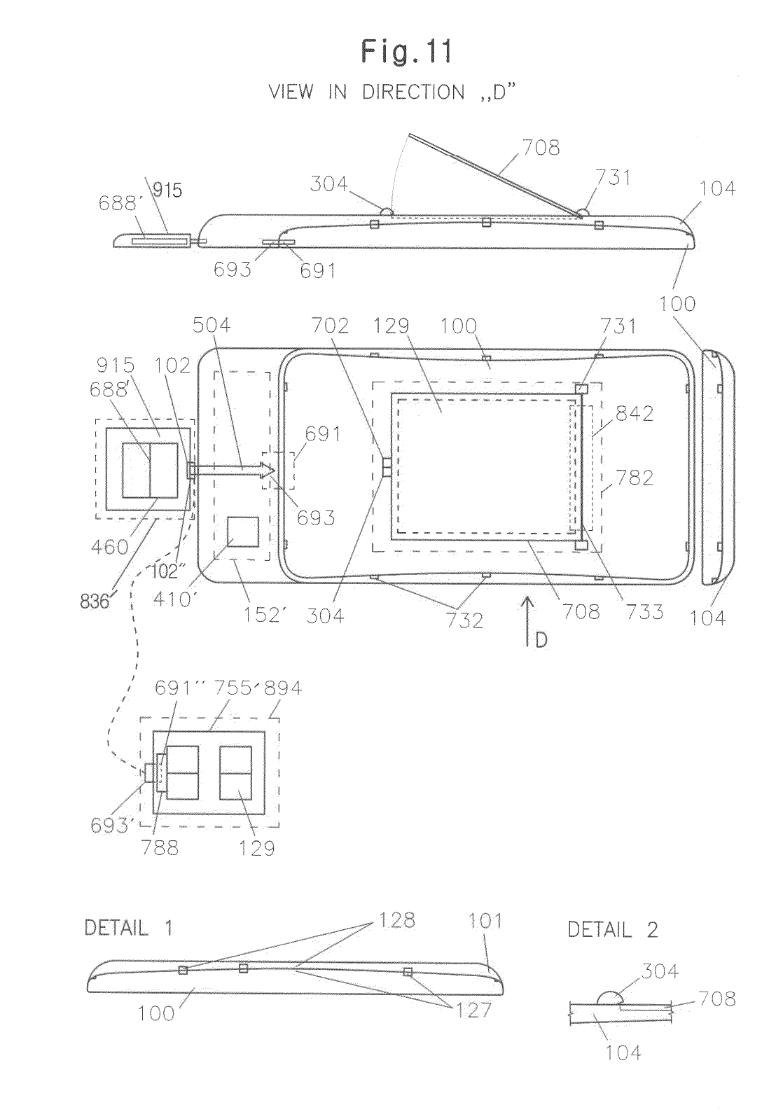

Detail 2 illustrates in detail the contact spring 678 with connected cable 256 divided preferably into two parts mutually connected and so springless part 283 which is firmly fixed on side 709 of upper auxiliary device, insomuch that putting it to mobile telephone 100 pushes in direction of arrow a springy contact 307, preferably telescopic, electronic device preferably made of mobile telephone so that it pushes it to level of side 284 of space in electronic device intended for the basic accumulator 129 where springy part 282 stands apart and is pushed by contacts 253 of basic accumulator 129, which is illustrated at inserting, so it comes up contact to it as well as to electronic device created preferably by mobile telephone 100. The springy part 282 with rigid part 283, create a double contact 281. The divided contact spring can be used on the same principle also at mechanic taking out the basic accumulator 129 with sliding door 738 presented on FIG. 11 or at basic accumulator 129, whose side or side of its casing make a side of mobile telephone an everywhere where is necessary to outlet contacts of auxiliary device or electronic device, which abut on basic accumulator 120.

Detail 3 illustrates module 715′″ of supplying in auxiliary device 104. During standard operation of mobile telephone is the bridging accumulator 688 kept in charged condition by charging from basic accumulator 129 of mobile telephone 100 where electric current comes through connectors 691 and 693 and through voltage converter 132 and through contacts of two pole change-over switch switched to position “A”. During exchange of basic accumulator 129 of mobile telephone 100 (FIG. 8). When the door 708 are open at exchange of accumulator which is below the door, a contact placed on the door is automatically disconnected and switches over the switch 703 from “A” to “B” and electronics 833 of mobile telephone is preferably supplied from bridging accumulator 688 through voltage converter 132′. Except automatic switching over the switch can be switched over manually by a command from the touch display of mobile telephone 100 where data is transferred through connectors 691 and 693 to module 410 of auxiliary units, which switches over the switch 703 by means of contact control. Except that the basic accumulator 129 as well as bridging accumulator can be charged by a charger or by notebook through tie connector 102 or other charging source. The module 715′″ charges the basic accumulator 129 through contacts 307. In order to save energy from the bridging source is during the exchange o accumulator 129 display 460 switched off as well as telephone application.

Detail 4 presents module 410′ of auxiliary units of auxiliary device, which is provided with the same units with functions as module 410 of auxiliary units of mobile telephone presented on FIG. 5. Connector 693 of module of auxiliary units of auxiliary device enables connection to mobile phone 100, second connector 603′ of module of auxiliary units ensuring connection of external devices and third connector 603″ of module of auxiliary units for connecting other external devices. The control unit 736 with microprocessor is provided at least one microprocessor and is adapted for data processing in application independently in control unit of mobile telephone 100. The control unit 736 is preferably adapted for direct communication with module 914 of internal monitoring units and with module 914′ external monitoring units and in his case module 410′ is preferably realized without control unit 736. Connection of modules 914, 914′ is realized directly to data connection 507 of mobile telephone 100 through connector 693 of module of auxiliary units on which relevant sensors are alternatively connected by connection 933 instead of connection 935 of control unit. Advantage of data processing in module 410 of auxiliary units is reliability which is higher than at data processing in electronics 833 of mobile telephone, because it is processing also functions of mobile phone and other applications, while module 410 of auxiliary units is processing only selected application and in case when needed can be filled with more microprocessors for further heighten reliability.

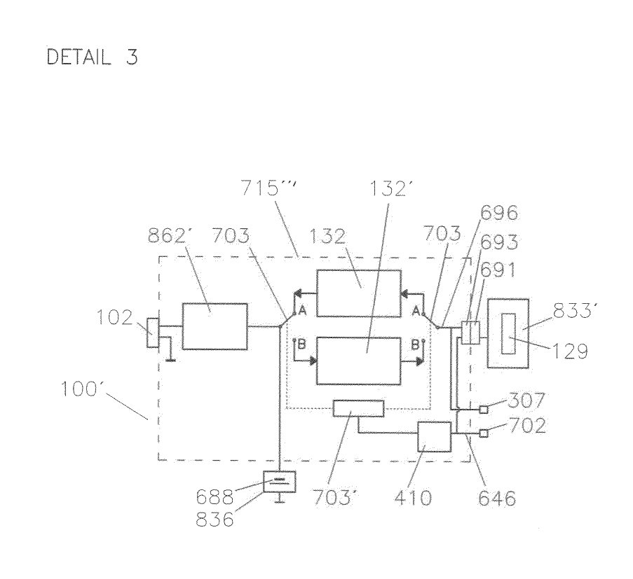

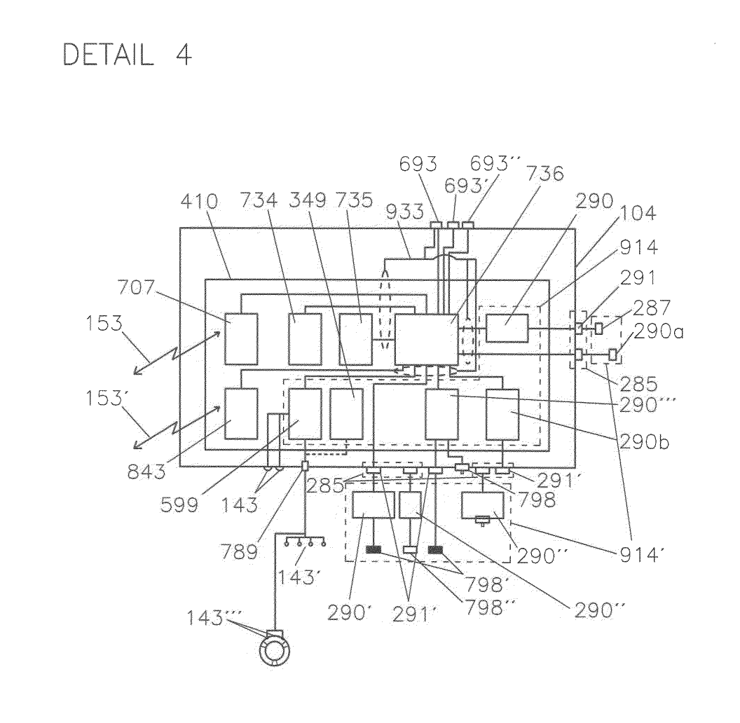

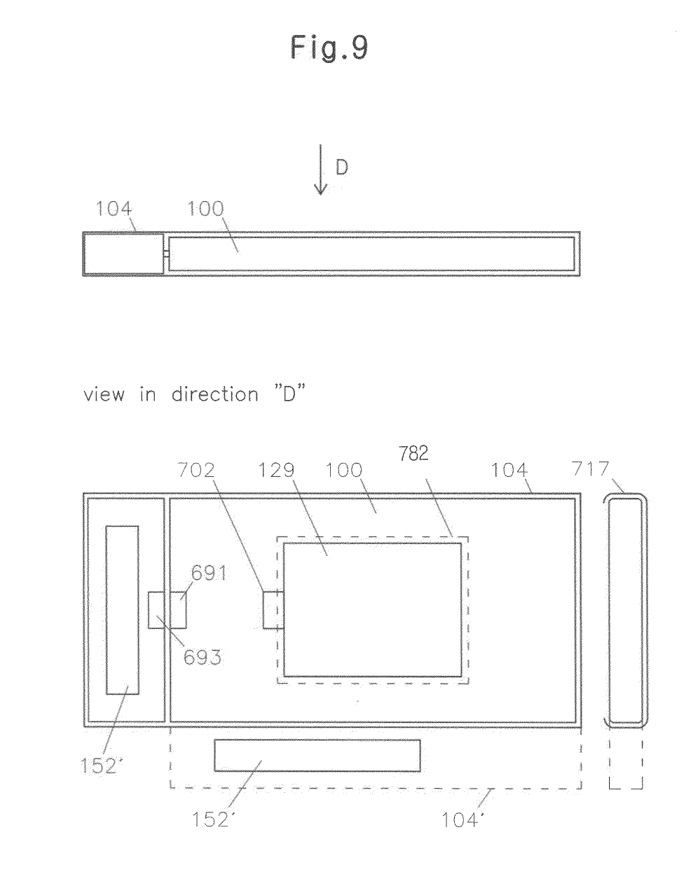

FIG. 9 introduces an example of fixing auxiliary device 104 with mechanism 782 for exchange of basic accumulator 129 fixed on mobile telephone 100 on formed side 717 of auxiliary device 104 with advantage to plastic material, which springs and can be at mobile telephone 100 clicked shut, there is also shown elongation of mobile telephone 100 by auxiliary device 104 where thickness of mobile telephone remains the same or is thicker only by the thickness of side of auxiliary device 104. The auxiliary device 104 contains a block 152 of auxiliary modules. The auxiliary device 104 is first inserted into connector 691 of mobile telephone 100 for charging and data transfer preferably USB, by connector 693 of auxiliary device and after inserting the auxiliary device 104 is clicked shut to mobile telephone 100. This FIG. 9 also shows an example of extension of mobile telephone 100 with auxiliary device 104′ instead to length to width, where the thickness where thickness of mobile telephone remains the same or is thicker only by the thickness of side of auxiliary device 104.

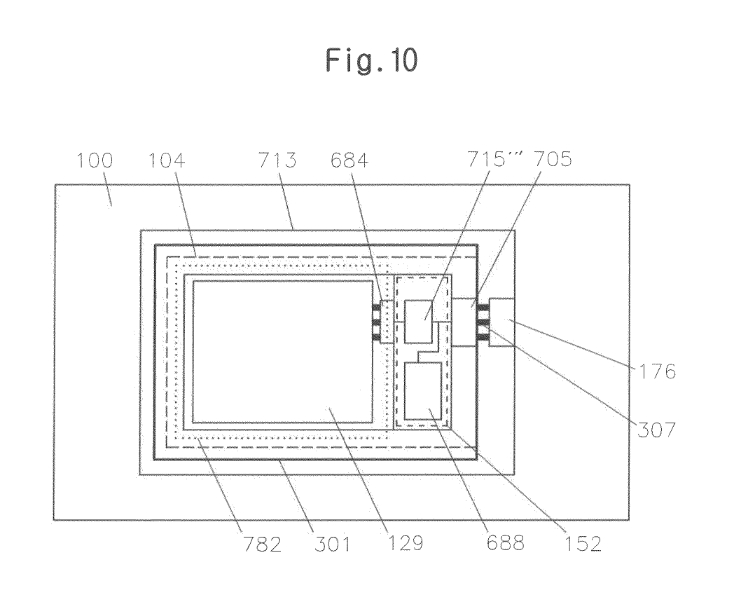

FIG. 10 presents an auxiliary device 104, consisting of casing 301 of auxiliary device 104 connector 705 of casing lumped down on contacts 176 for instance of mobile telephone 100 which are inserted into space of 713 of basic accumulator, illustrated on FIG. 8. There is placed minimized basic accumulator 129′ and through new contacts 684 and charging module 715′″ in auxiliary device is charging the bridging accumulator 688 and supplies mobile telephone 100 through connector 705 of casing with contacts and a connector 176 with telescopic contacts of mobile telephone 100 and basic accumulator 129 is placed in mechanism 782 for exchange of basic accumulator from witch is easy removable and exchange for charged one, where uninterrupted supplying ensures bridging accumulator 688.

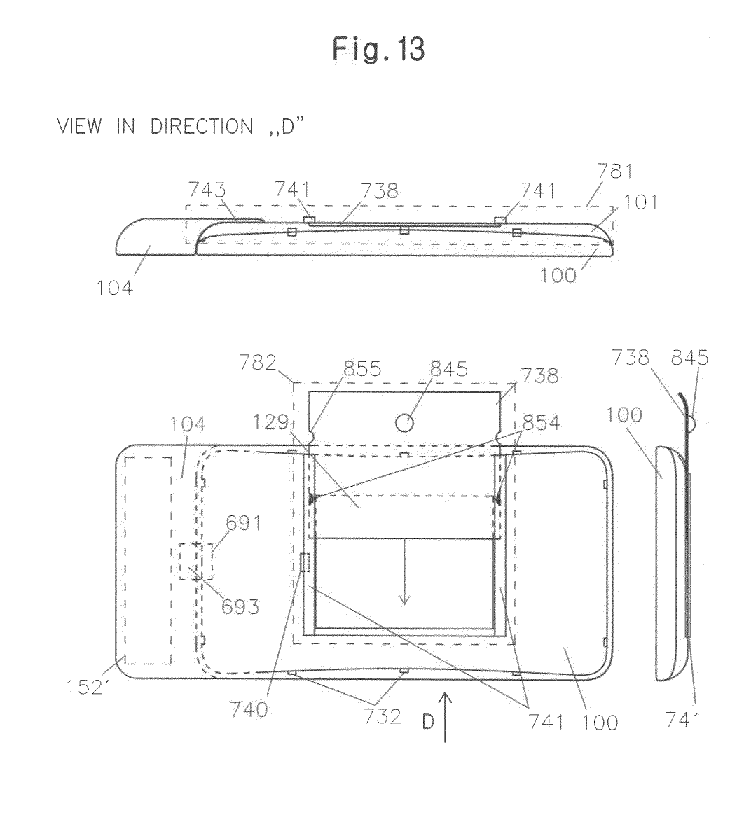

FIG. 11 illustrates auxiliary device 104 connected to mobile telephone 100 instead of original cover 101 of mobile telephone, electronic interconnection of mobile telephone 100 with auxiliary device 104 is realized with mutual connection of connector 691 of mobile telephone USB female with connector 693 male. Door 708 revolving on hinges 731 of doors are after closing ensured by a latch 304. Easy exchange of basic accumulator 129 ensures mechanism 782 for exchange of basic accumulator 129 where after pulling the latch 304 preferably controlling switch 702 is released opening the door 708 with axis 733 revolving in hinges 731 alternatively replaced with flexible plastic 842. Switch 702 controls switching over block 152′ of auxiliary modules for supplying mobile telephone in time when the basic accumulator 129 is replaced; alternatively can the hinged door 708 be replaced with sliding door 738 introduced on FIG. 13 External source 836′ of bridging energy is preferably created by bridging accumulator 866′ which is placed casing 915 of bridging accumulator and makes up a miniature unit provided with connector 102′ male, which is inserted to connector 102″ female of auxiliary device for external modules and is easy transferable and can be used for bridging exchange of accumulator 129 and/or supplying auxiliary device namely when mobile telephone 100 is not able to provide energy from connector 691 When it is used block 152 of auxiliary modules than is possible supply it from external source 836 of bridging energy, when is not used, the casing can be preferably inserted directly to connector 693 of mobile phone as shows the arrow 504, also than is preferably used mechanism 782 for exchange of basic accumulator 129, External source 836′″ of bridging energy with basic accumulator is made preferably by casing of basic accumulator or the energy for auxiliary device or mobile telephone preferably from a charger 755, 755′ preferably for more accumulators, where from at least one basic accumulator 129 is connected by a connecting cable 895 through connector 693′ or is formed preferably by a charger of basic accumulators, preferably multiple charger, where is made through a connecting cable 895 with connector 693′ in auxiliary device 104 or directly on mobile telephone 100 and the cable 895 sucks energy from voltage converter 825, which joins energy from more basic accumulators 129 this adjustment is preferably applicable for all types of mobile telephones namely on FIGS. 8, 9, 13, 14, 15, 16 and 16a.

On the Detail 1 is presented an original cover 101 with fixtures 128 snapped into fixtures 127 of mobile telephone 100 and so connect with a cover. The original cover is substituted by an auxiliary device 104 which is connected with mobile telephone 100 with a fixing mechanism 781 made preferably by snapping fixtures 732 of auxiliary device 104 which fit together with fixtures 127 of mobile telephone 100

Detail 2 illustrates a pawl 304 which when shifted in arrow direction releases door 708.

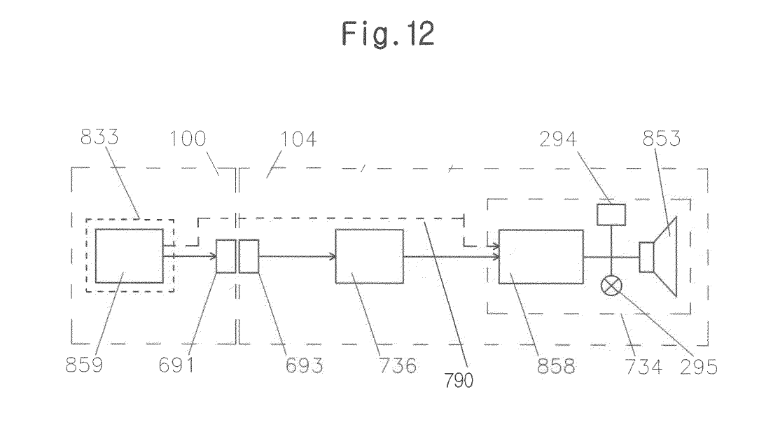

FIG. 12 presents a unit of detection activity watchdog 734 placed inn auxiliary unit 104, which activates acoustic signalization by an acoustic converter 853 in case when the mobile telephone 100 does not show proper function for some time. The mobile telephone 100 is programmed so that its microprocessor unit 859 amounts in defined time intervals some timely ambitious activity, for instance multiplying a few numbers, and in case when the result corresponds to number saved in memory, then sends through connector 691 and 693 a code corresponding to refresh to control unit 736 with microprocessor of auxiliary unit 104 which after processing resets a resettable timer 858 measuring time elapsed from the last reset. When reset didn't start earlier than preset time, the timer 858 activates the acoustic converter 853 preferably a loudspeaker, piezoelectric converter, and/or vibrator 294 or visual indication 295 preferably a LED. Watchdog 734 placed in mobile telephone 100′ receives signal refresh directly from the electronics 833 of mobile telephone through a connection 790 bridging and control unit 736 and connectors 691 of mobile telephone and 693 are not used.

FIG. 13 illustrates the auxiliary device 104 joined mechanically with an original cover 101 with fixing mechanism 781 made by overlapping 743 and in term of shape adapted to side of mobile telephone 100 which can be preferably joined with an original cover 101, which is adapted for manipulation with the basic accumulator 129, extended by mechanism 782 for exchange of basic accumulator 129 preferably made by cutting out or by pressing an opening in original cover 101. On edge of the opening are glued rails 741 on which is shifting a sliding door 738 with a thrusting swatch 845 making easy opening the door 738 which are after closing preferably locked by putting protrusions 854 into hollows 855 of door arresting, or by glued arresting pawl 740. Alternatively can be used tipping door 738 showed on FIG. 10.

Function of block of auxiliary modules 152′ for auxiliary device was already described in description of FIG. 10.

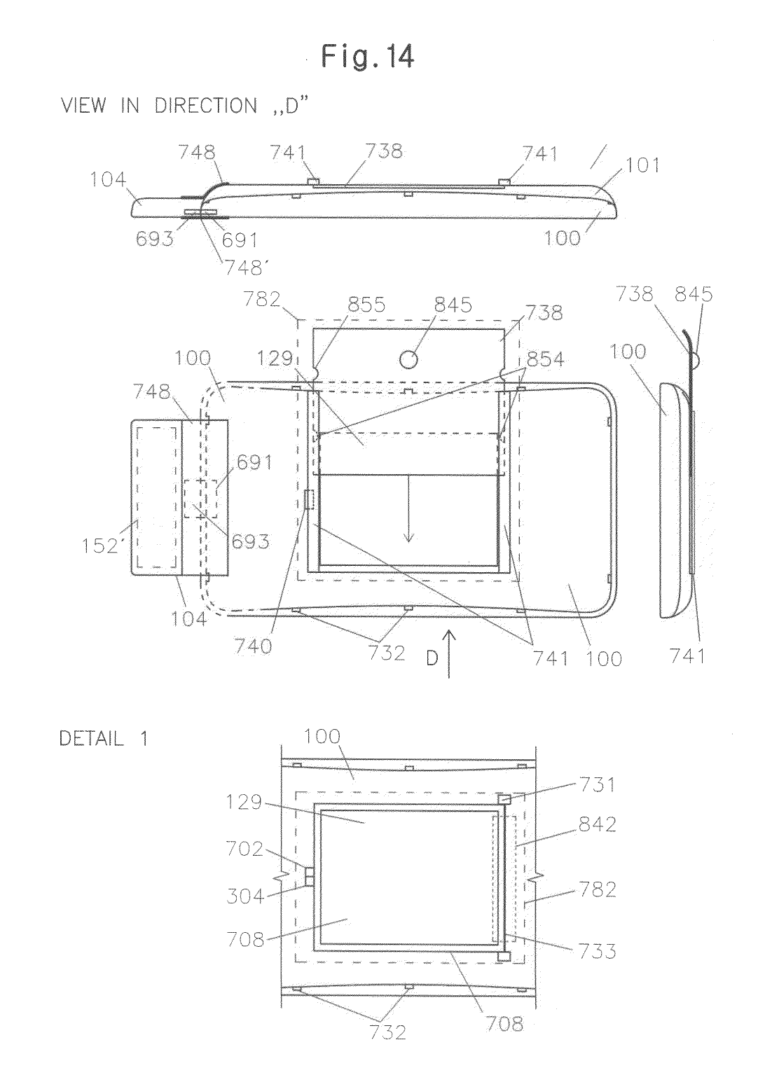

FIG. 14 presents a universal usable auxiliary device 104 the width of which preferably corresponds to the straight side of mobile telephone to which is attached. The auxiliary device 104 is fixed on a mobile telephone 100 by inserting it into connector 691 and if needed more fixing, it can be fixed mechanically with original cover 101 with fixing mechanism 781 made preferably with a flexible junction 748 glued to the cover 101 and preferably also with a second flexible junction 748′ glued to mobile telephone 100 which does not prevent removing the basic accumulator 129 by lifting of original cover 101. The original cover 101 is preferably adapted by attaching of mechanism 782 for exchanging the basic accumulator 129 made preferably by shifting door 738. The basic accumulator can be alternatively removed by lifting the cover 101. Block 152′ of auxiliary modules placed in auxiliary device 104 has functions mentioned in description of FIG. 10.

On the Detail 1 is presented alternative solution, where by means of door 708 where above cut of or impressed space is embedded accumulator. The door are preferably joined hinged door 731 external with a cover 101, preferably original and secured by a glued locking pawl 304.

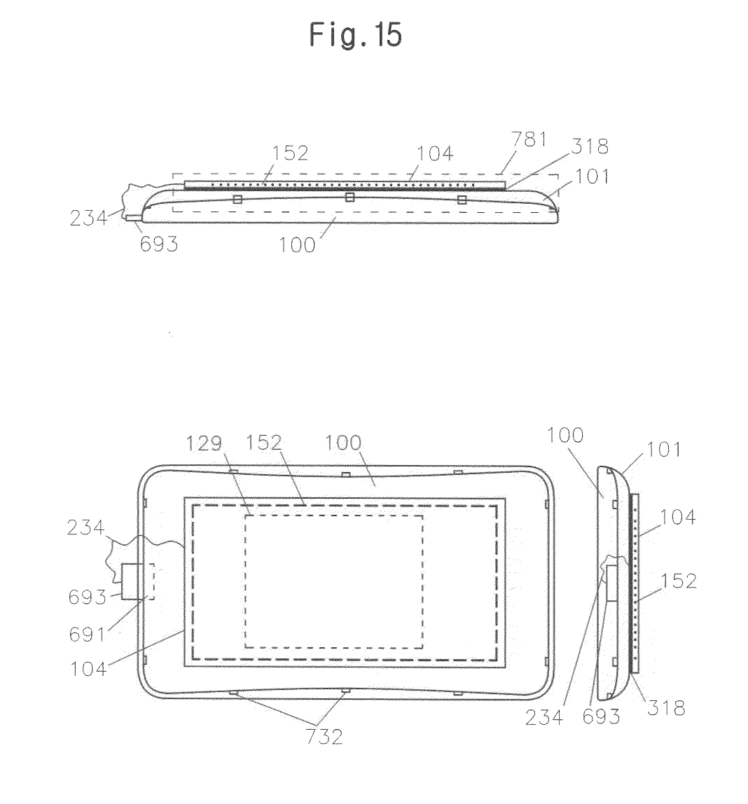

FIG. 15 illustrates all-purpose usable auxiliary device 104 which is mechanically connected with original not adapted cover 101 fixing mechanism 781 formed preferably by screws or connecting layer 318 preferably by glue, Velcro etc. An advantage is small thickness of auxiliary device 104 containing preferably block of auxiliary modules 152 with very low electric components and functions described on FIG. 10. Basic accumulator 129 is accessible in standard way, it is removing the cover 101. Connection of auxiliary device 104 with mobile telephone 100 is realized with a short cable 234 and connector 693.

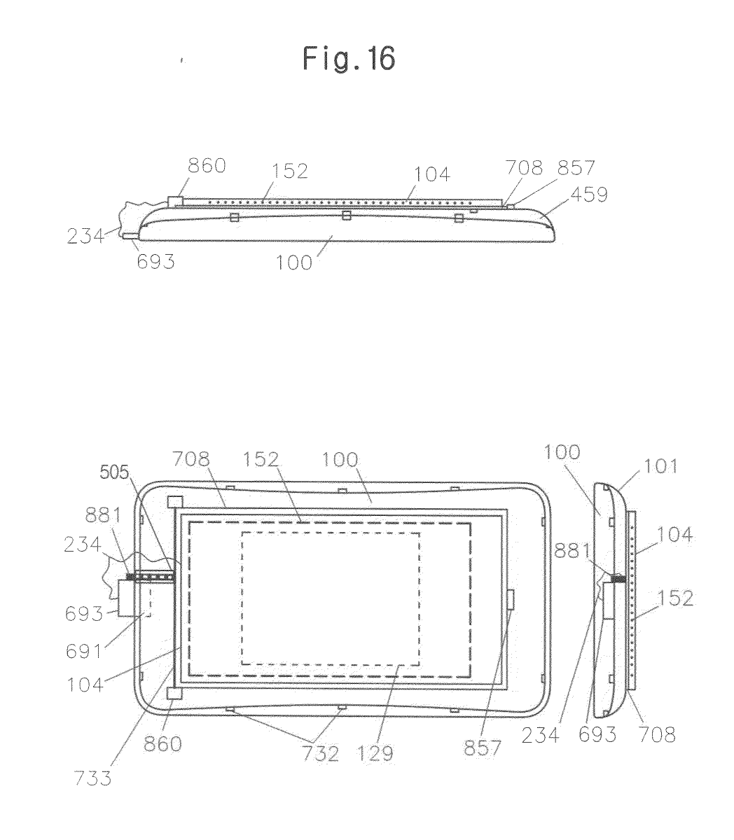

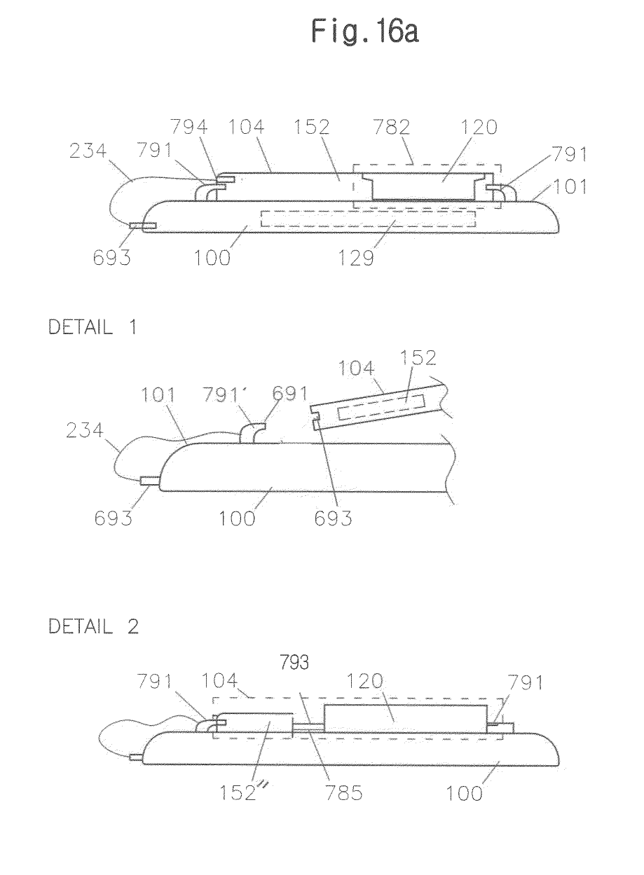

FIG. 16 presents usable auxiliary device 104 with block 152 of auxiliary modules which is easily lifting of with door 708 which is connected with is mechanically joined with fixing mechanism 781 made of hinges 860 and pawl 857. The door 708 are preferably a part of removable cover 101 of basic accumulator 129 and are by means of axis 733 and hinges 860 glued on cover 101 of basic accumulator alike so as the glued pawl 857 mechanically connected with the cover 101 as well as the stuck pawl 857 mechanically connected with cover 101. The connection with mobile telephone 100 is realized with cable 244 or alternatively with a flat cable 881 glued on mobile telephone 101, preferably covered with a flexible cover 505, which enables lifting doors 708 together with auxiliary device 104.

FIG. 16a illustrates further example of all-purpose usable auxiliary device 104 where the fixing mechanism 782 for exchange of basic accumulator of auxiliary device, formed of system allowing easy fixing or removing the auxiliary for instance clicking on, inserting direct, or swiveling, and securing by pawl or other suited manner. In mentioned example it is clicked on protrusions 791 on original cover 101 of mobile telephone, preferably glued and kept by protrusions 791 inserted into hollows 794 in auxiliary device 104. Auxiliary accumulator 120, in case when is applied preferably of bigger size and capacity then bridging accumulator 688 so as it can charge the basic accumulator 129 is exchangeable for charged one by means of mechanism 782 for exchange of basic accumulator and in this case the side 269 of accumulator forms side of auxiliary device 104. This easy removable auxiliary device 104 can be easily put on mobile telephone 100 only for recharging of basic accumulator 129, or if it used block 152 of auxiliary modules modified for clicking, so that when is not put on, the thickness of mobile phone 100 is not thicker. Connection of auxiliary device 104 with mobile telephone 100 is realized with a short cable 234 and connector 693.

On the Detail 1 is presented alternatively embodiment of adjusted protrusion 791′ with connector 691 male in which is preferably inserted the auxiliary device 104 with female connector 693 of auxiliary device and so is secured mechanically and connected with cable 234 which is preferably fixed to mobile telephone with gluing band, In this way is not necessary insert it in mobile telephone 100 at any putting of auxiliary device 104, in which the clicking auxiliary device is used only with block 152 of auxiliary modules, so the thickness of mobile telephone 100 is thicker only slightly. Preferably can be embedded also auxiliary accumulator 120. In this case the thickness of mobile telephone 100 is higher, but only for short time period during charging the basic accumulator 129, because with respect of easy removing of auxiliary accumulator 120 or auxiliary device 104 by clicking off the auxiliary accumulator 120 or auxiliary device 104 is connected in case of need.

Detail 2 illustrates embodiment of auxiliary device 1 with separately removable and clicking up mountable parts of block of auxiliary modules 152″ with auxiliary functions of mobile telephone and auxiliary accumulator 120 clicking to protrusions 791 with double protrusion in the middle 793 in which is also interconnection between auxiliary accumulator 120 and block 152″ of auxiliary module with interconnection 785 where can be clicked on auxiliary accumulator 120 only for charging basic accumulator 129 which increases the thickness of mobile telephone 100 for relatively short time of charging and auxiliary device 104 in place of block 152″ of auxiliary modules is very thin, so that increases the thickness of mobile phone very slightly and only when used.

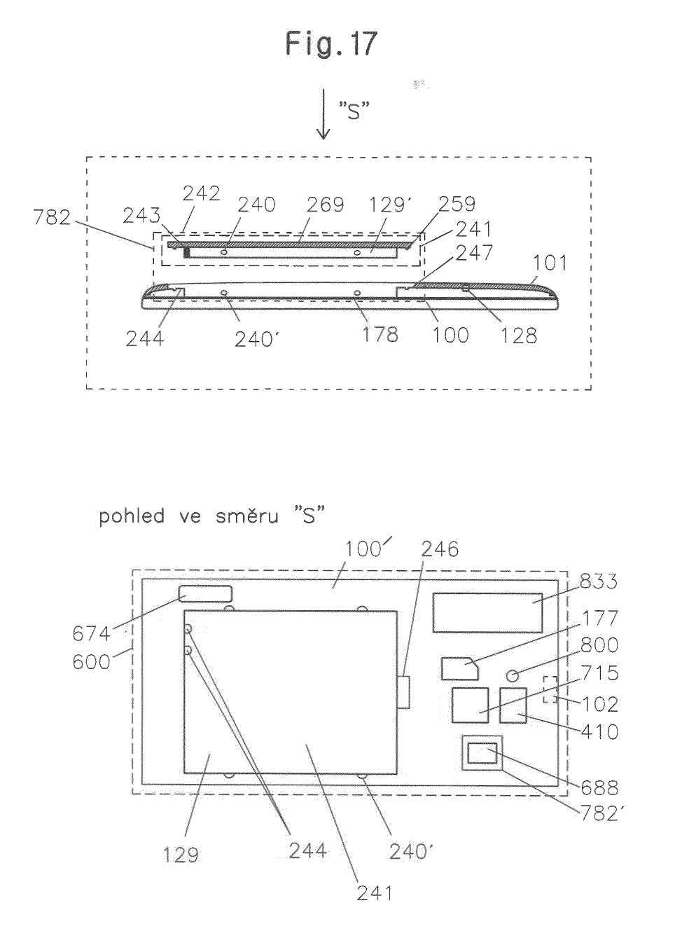

On FIG. 17 is another example of mechanism 782 for replacement of basic accumulator 129 formed of accumulator of mobile telephone whose part is source module 241, which is preferably formed of basic accumulator 129, whose side 269 is a part of the cover of adapted mobile telephone 100′ and enables quick manipulation with basic accumulator 129 during its exchange without removing the cover of mobile telephone 100′ with auxiliary functions with display 178 and tie connector 102 USB. Storing mechanism 603 is placed in adapted mobile telephone 100′ with additional functions. Mobile telephone 100′ with auxiliary functions. Mobile telephone 100′ with auxiliary functions is preferably provided withg electronics 833 of mobile telephone 100 with SIM card 177, grating for loudspeaker 674, lens of photo camera 800, module 410 of auxiliary units, module 715 of power supply, bridging accumulator 688 in storing mechanism 782′ for exchange of auxiliary accumulator which ensures operation of mobile telephone 100 during the accumulator 129 exchange Variety of embodiment of source module 241 are illustrated in particular on FIGS. 37 and 39. On FIG. 34 there is shown a removable power supply module 241 with supporting frame 242 with overlapping, which is described on FIG. 37. A notch 29 at source module 241 and incision for fingernail 246 on auxiliary device makes easy removing of source module 241 from auxiliary device which is fastened with fixtures 128. After inserting of source module 241 to mobile telephone 100 is the source module 241 fastened with arresting elements 240 of supporting frame 242 and arresting elements of electronic device, which can be preferably made as mechanic fixtures or magnets. Electronic connection of supporting frame 242 with electronics 833 of mobile telephone 100 and contacts 243 ensures flexible contacts 244 placed on mobile telephone 100 and contacts 243 of supporting frame. Block diagram of internal module 715 of supplying mobile telephone 100′ with auxiliary functions for replacement of basic accumulator 129 during operation, or alternatively recharging is illustrated on FIG. 3.

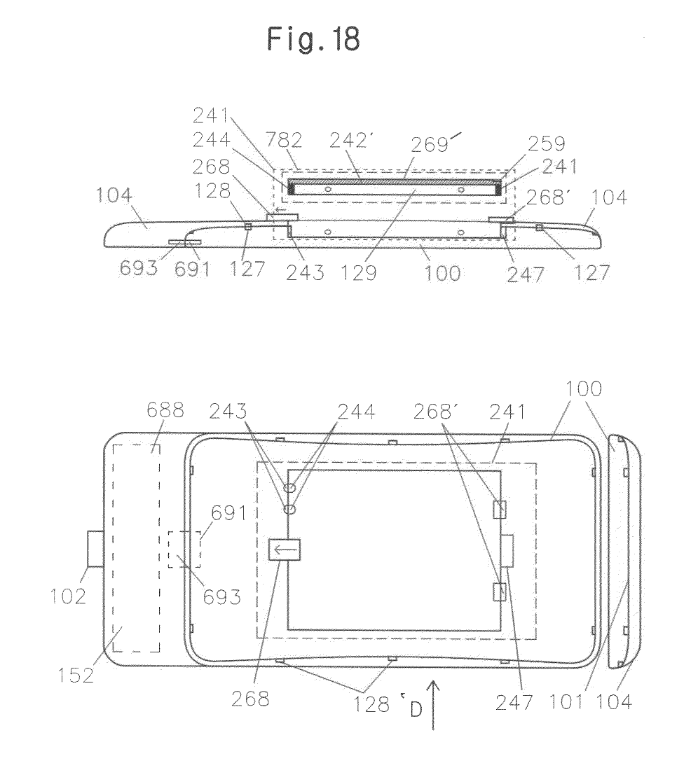

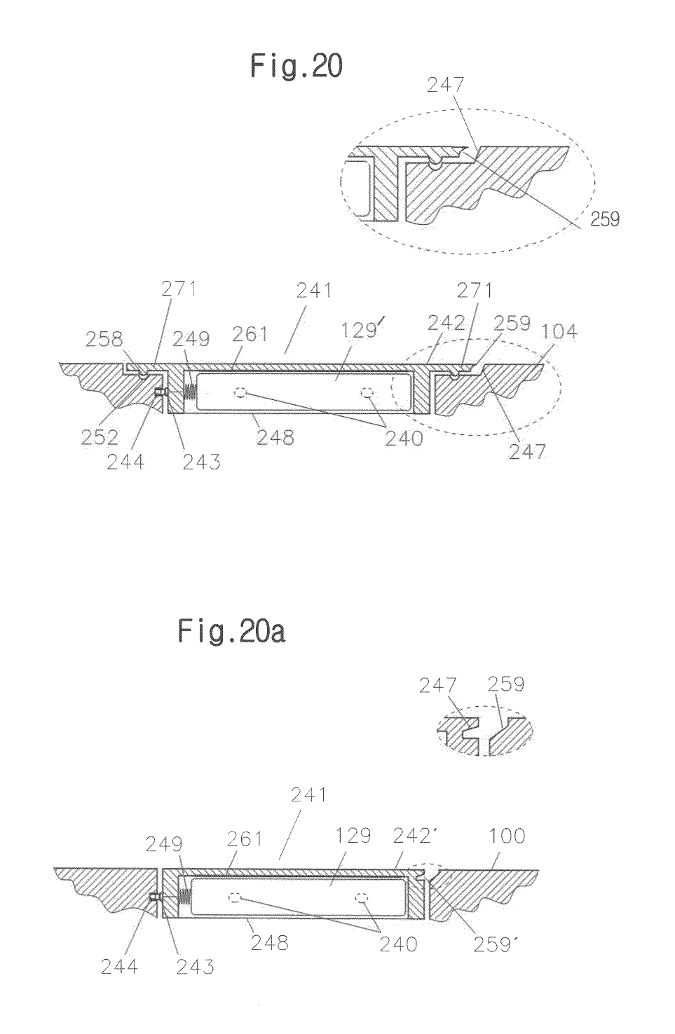

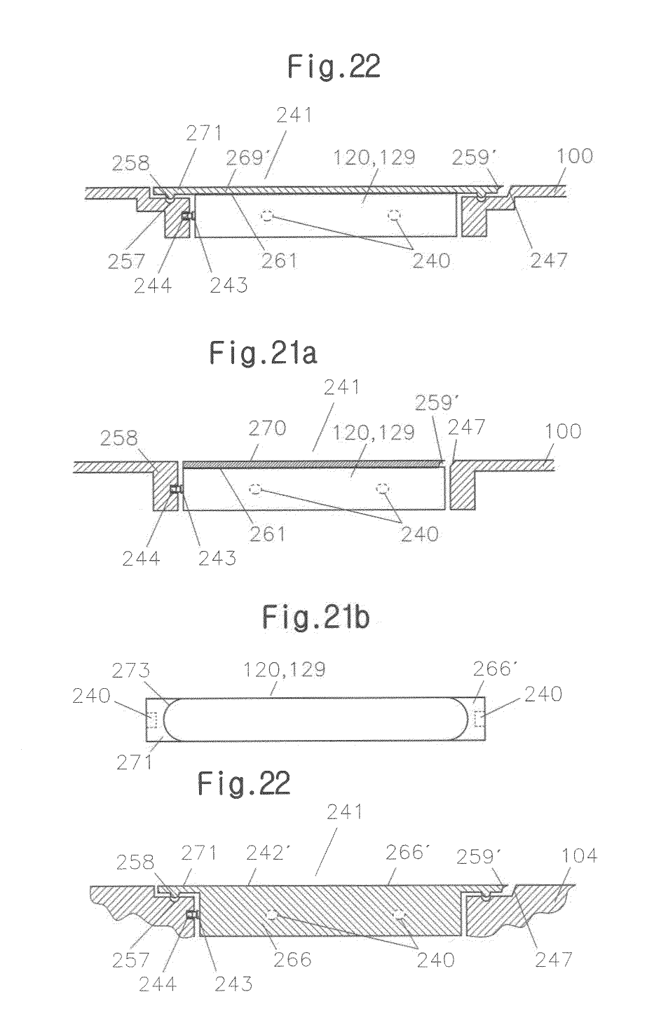

FIG. 18 shows mechanism 782 for replacement of basic accumulator 129 placed in mobile telephone 100 and auxiliary device 104 where basic accumulator 129 goes during replacement through auxiliary device 104 which extends functions of mobile telephone 100. Further there is illustrated removable power supply module 241 with side 269′ without overlapping which is on FIGS. 20a and 21a, and which is in auxiliary device 104 mechanically fixed, in this case with a rigid threshold 268′ and sliding threshold 268, which serves as a stop. In this case it can be used power supply module 241 without arresting elements. Notch 259 on doubled module 241 and notch for fingernail 247 on auxiliary device 104 as shown on FIG. 20 makes accumulator removing easier. Auxiliary device 104 is after removal of original cover of mobile telephone 100 connected with mobile telephone 100 with a fixing mechanism made preferably with fixtures 128 of auxiliary device 104 which are made so that fits into bulges 127 of mobile telephone 100 originally designed for fastening the cover of mobile telephone 100. In this illustration is the basic accumulator 129 formed by accumulator of mobile telephone 100 and auxiliary device preferably is contiguous to the surface of mobile telephone 100 along all its length and at inserting of source module 241 is passing through a hole made in thin cover 101 of auxiliary device 104, which lengthen the total length of mobile telephone 100 with auxiliary device 104 where the thickness remains nearly the same. Electronic connection of mobile telephone 100 with auxiliary device 104 is realized after mutual connection of connectors 691 of mobile telephone female with connector 693 USB male. Block 152 of auxiliary modules is the main part of auxiliary device 104. It contains preferably bridging accumulator 688, acoustic converter 853 preferably a loudspeaker or piezoelectric converter, also displayed on FIG. 12, module 715 supplying mobile telephone 100 and module 410 of auxiliary units. Supplying of block 152 auxiliary modules of auxiliary device 104 is preferably made from connectors 693 and 191 preferably USB, from mobile telephone 100 or alternatively from external source, when is connected preferably through tie connector 102. Electronic connection of source module 214 with mobile telephone 100 ensure contacts 243 of supporting frames and flexible contacts 244.

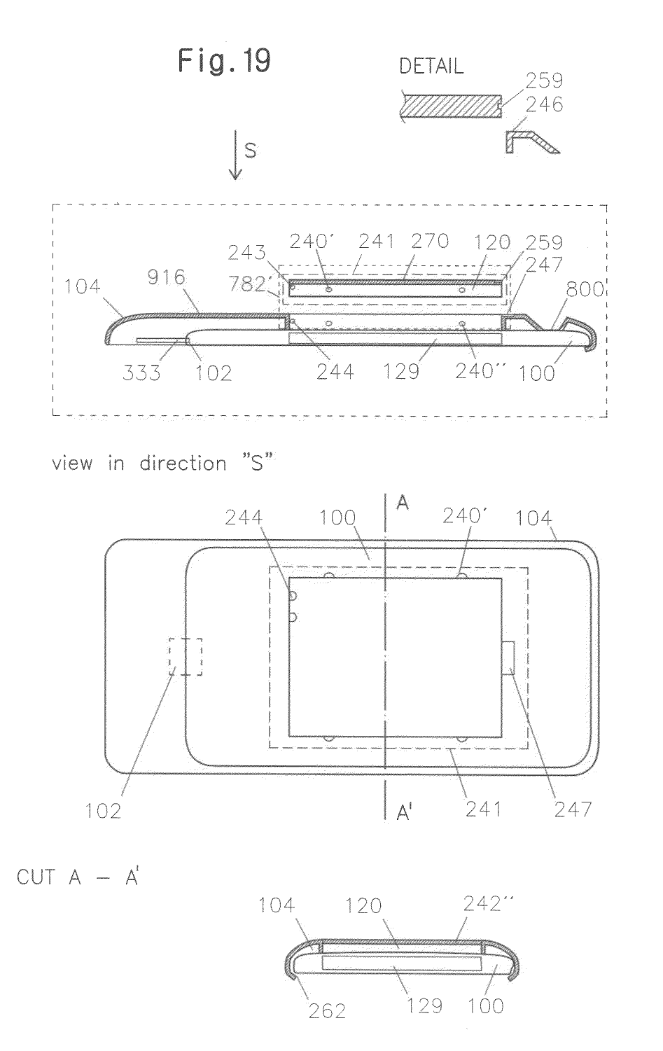

FIG. 19 represents location of mechanism 782′ for exchange of auxiliary accumulator and source module 241 which forms auxiliary accumulator 120 preferably standard to which is fastened side 270 preferably glued, which allows its smaller thickness because is strengthen with auxiliary accumulator 120 or is auxiliary accumulator with this side produced. Mechanism 782 for auxiliary accumulator exchange is placed in auxiliary device 104 which is connected with mobile telephone 100 with basic accumulator 129. Into its tie connector 102 preferably USB is inserted connector preferably USB of board 333 of auxiliary electronics. In this case is used space between surface of mobile telephone 100 and cover of auxiliary device 104 for inserting of source module 241 consisting of auxiliary accumulator 120 which is shown on FIG. 20. Incision 259 on source module 241 and incision for fingernail on auxiliary device 104 makes removing of source module 241 from auxiliary device easy. Arresting element is made of arresting protrusion 240″ for arresting of mobile telephone 100 and preferably strengthen mechanic connection of auxiliary device 104 and mobile telephone 100. Side 270 of auxiliary accumulator 120 preferably forms a part of side 270 of auxiliary device 104.

FIG. 20 presents source module 241 with supporting frame 242 with overlap 271 in which is basic accumulator 129 fixed preferably by gluing layer 261 to side of frame 242 which is with it reinforced and preferably is thinner in comparison with overlap 271 and preferably in comparison with commonly used door in cover 101 which is self-supporting, which allows lower the thickness of mobile telephone 100. Reduced basic accumulator 129′ is preferable in version without cover which lowers the mounting thickness of accumulator with contacts replaced with linking cable 249. Overlapping 271 of upper part of the frame 242 preferably completed with protrusions 258 put into recesses 252 made for this reason in side of auxiliary device 104 protect against dust penetration. Incision 259 on edge of supporting frame 242 with overlap and space for fingernail 247 on auxiliary device 104 make easy removing of frame 242 from auxiliary device 104. After inserting source module 241 into auxiliary device 104 or mobile telephone 100 the upper side of its supporting frame 242 fits with surface of mobile telephone 100 so that source module replaces its cover. The lower part of supporting frame can be preferably lapped with plastic foil 248. After inserting of source module 241 into electronic device, its supporting frame 242 with auxiliary accumulator 120 is fastened with arresting elements 240 of supporting frame and arresting elements 240 of electronic device as illustrated on FIG. 19. Electronic interconnection with auxiliary accumulator 120 with auxiliary device 104 ensure contacts 243 of supporting frame and flexible contacts 244, preferably telescopic, which are a part of auxiliary device 104.

FIG. 20a represents variation of an example of FIG. 20, using the supporting frame 242′ without overlapping, with incision 259′ to which the basic accumulator 129 is fastened with glue.

FIG. 21 shows a source module 241 with side 269′ of power supply module with overlapping to which the basic accumulator 129 is fastened also preferably with glue. After inserting it into mobile telephone 100 contacts of accumulator 243 are connected with flexible contacts 244, preferably telescopic, which form a part of mobile telephone 100 or auxiliary device 104. The arresting elements 240 are in this case fastened preferably by gluing to casing of basic accumulator 129 and/or auxiliary accumulator 120.

FIG. 21a presents a source module 241 with auxiliary accumulator 120 and/or preferably basic accumulator 129 to which is fastened side 270 of auxiliary accumulator preferably by gluing which enables smaller thickness because is reinforced with auxiliary accumulator 129 and/or basic accumulator 129 in comparison with currently used covering of auxiliary accumulator 120 and/or basic accumulator 129 with separate door, which enables reduce thickness of mobile telephone 100 or side 270 is made by side of auxiliary accumulator 120 and/or basic accumulator 129 which is rounded.

FIG. 21b illustrates mechanic connection of arresting elements 240 with auxiliary accumulator 120 and/or basic accumulator 129 using edge 273. Sides of edge 273 which adjoin to auxiliary accumulator 120 and/or to basic accumulator 129 which is preferably formed and so well connectable to auxiliary accumulator 120 and/or to basic accumulator 129 preferably by gluing.

FIG. 22 presents utilization of formed accumulator 266 in formed frame 266′ with overlaps 271 and arresting elements 240 which go down to recesses preferably on mobile telephone 100 see FIG. 18, or auxiliary device 104. Advantage of this solution is that side of formed frame 266′ of accumulator forms preferably side of mobile telephone 100 or auxiliary device 104 and so preferably door is not necessary and mobile telephone 100 can be thinner. Charger designed in that way can be used as multiple charger of flat accumulators, suitable for supplying mobile telephones 100 and at the same time can be portable storing space of accumulators and even more serves as external source of energy (power bank) for mobile telephone 100 and 100′ and as long-term or bridging. In function as external source the charger is able to transfer into mobile telephone 100, 100′ energy for mobile telephone 100 consumption as well as for charging of accumulator.

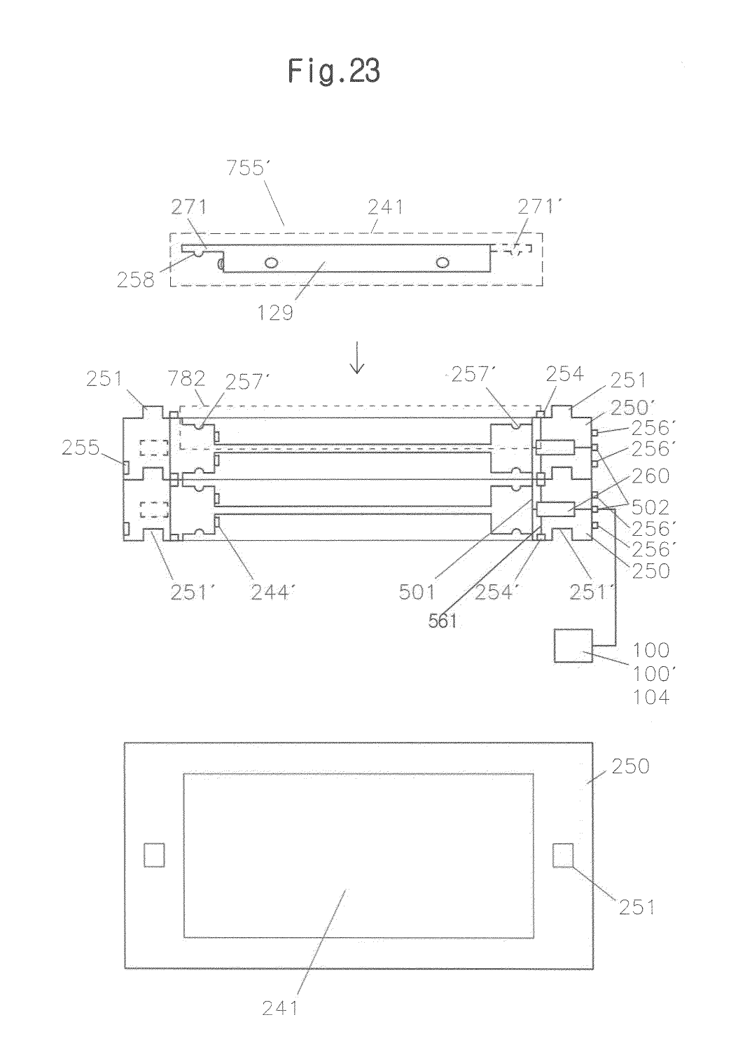

FIG. 23 presents a modular charger 755′ for charging source modules 241 with basic accumulators 129. Basis are modules 250 of charger, where into each module can be insert/remove two source modules 241 in the same way as at inserting/removing in mobile telephone 100, 100′ by means of mechanism 782 for replacing basic accumulator preferably with the same mechanism 782 for replacement of basic accumulator of mobile telephone 100, 100′. Electric connection ensure springy, preferably telescopic flexible contacts 244′ of module. Modules 250 can be clicked on themselves according the needs by means of shapes 251 and 251′ fitting each other,??????? Charging is realized by external source by means of connector 255 for connecting of external power supply. To side clicking of modules 250 serve samplings 256′ locking together and are mutually interconnected with contacts 254, 254′ and jumper 561 of charger module. The charging electronics 260 charger module ensures charging of source modules 241 and externally mobile telephone 100, 100′ through connector 502 of external supplying, when the modular charger 755′ compensates the source 836 of bridging energy by connecting cable 503 of external supplying, or putting into mobile telephone 100, 100′ directly into connector 502 preferably USB connector.

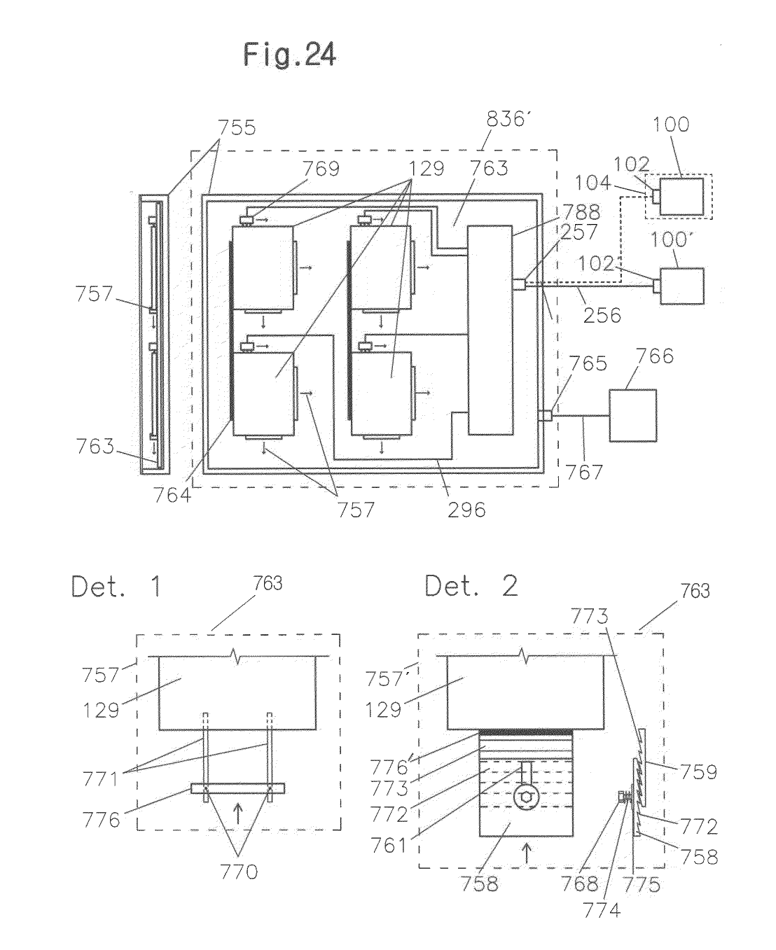

FIG. 24 illustrates un example of group charger 755 preferably for basic accumulators 129, where on their mounting board 763 are charged accumulators 129 fixed on side where are contacts with group of springy contacts 769 with a possibility of shifting all group for setting of mutual pitch on one side by a stopper 764 and on remaining two sides with shifting mechanisms 757. The energy for charging accumulators 762 inserted in this charger provides a network charger 766 through cable 767 of mains charger and connector 765 of the charger, which is connected with charging electronics 788 and which controls charging of basic accumulators 129. For using charger 755 as external source of 836′ bridging energy, the charging electronics 788 preferably gives energy from at least one inserted and at least partly charged accumulator, preferably cable 296 of all-purpose charger modified for charging mobile telephone 100, 100′ through cable 256 and connector 257 or 102 of alternatively auxiliary device 104. In this version is charger 755 preferably usable for function as external source 836′ of bridging energy instead of internal source 836 of bridging energy. It is advantage that for external source of bridging can be used basic spare accumulators 129 charged for basic accumulator replacement and extra source is not needed.

Detail 1 shows an example of sliding mechanism 757 whose notch 776 with two fixing elements 770 adapted for shifting in grooves 771 in mounting board 763. After pushing the notch 776 to side accumulator 129 is the position of notch 776 fixed by fastening elements 770, preferably by tighten screws and nuts.

Detail 2 presents another example of another sliding mechanism 757′ whose notch 776′ with fastening element composes a part of upper fixing element 758 movable with saw grooves 772 on bottom fixing element 759 with saw grooves 773, firmly connected with mounting board 763. The mutual movement of both fixing elements on sides with notches of saw shape enables leading element 768 with a spring 774 pushing through a washer 775 together both fixing elements and firmly joined with bottom fixing element 759. By shifting of upper fixing element 758 in direction of arrow in interval of groove length 761 in upper leading fixing element 758. On side of accumulator 129 is position of upper fixing element 758 and also the notch 776 fixed automatically.

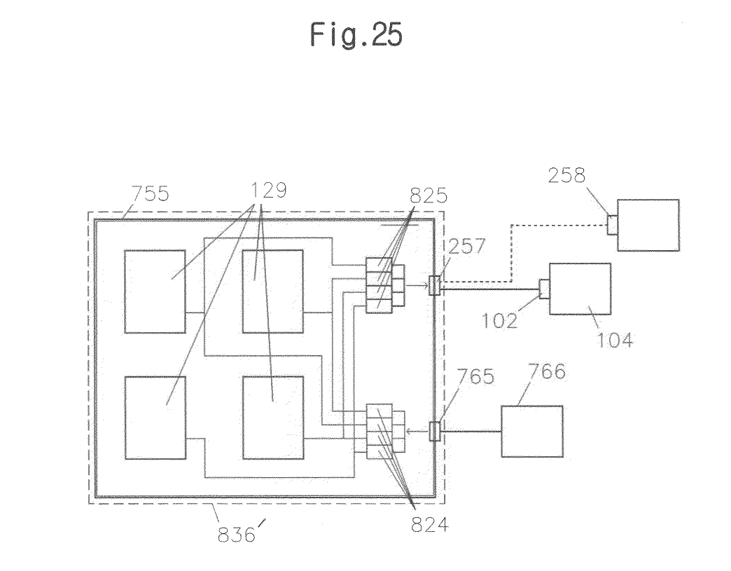

FIG. 25 illustrates an example of block scheme of charger 755 of basic accumulators 129. The charger is provided with four steps down voltage converters 824, which change the voltage from 5V to charging voltage 4.2V. The charger enables supply mobile telephone 100, 100′ and serves preferably as external source 836′ of bridging energy by means of step up voltage converters 825, which from accumulators located in group charger take necessary energy, supplied from external source during the basic accumulator 129 replacements. Preferably is adapted also for continuous charging of mobile telephone 100, 100′. In this case is the energy taken of all four basic accumulators 129. The charger 755 is preferably modified for pumping energy of any number of inserted accumulators.

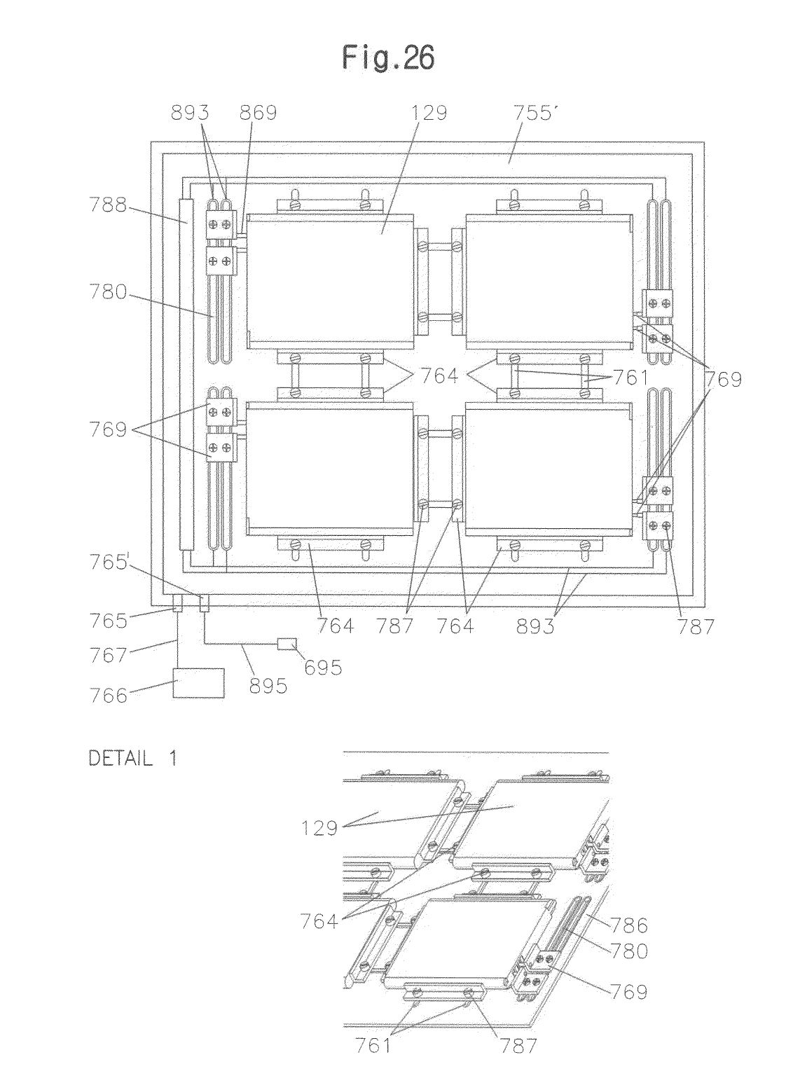

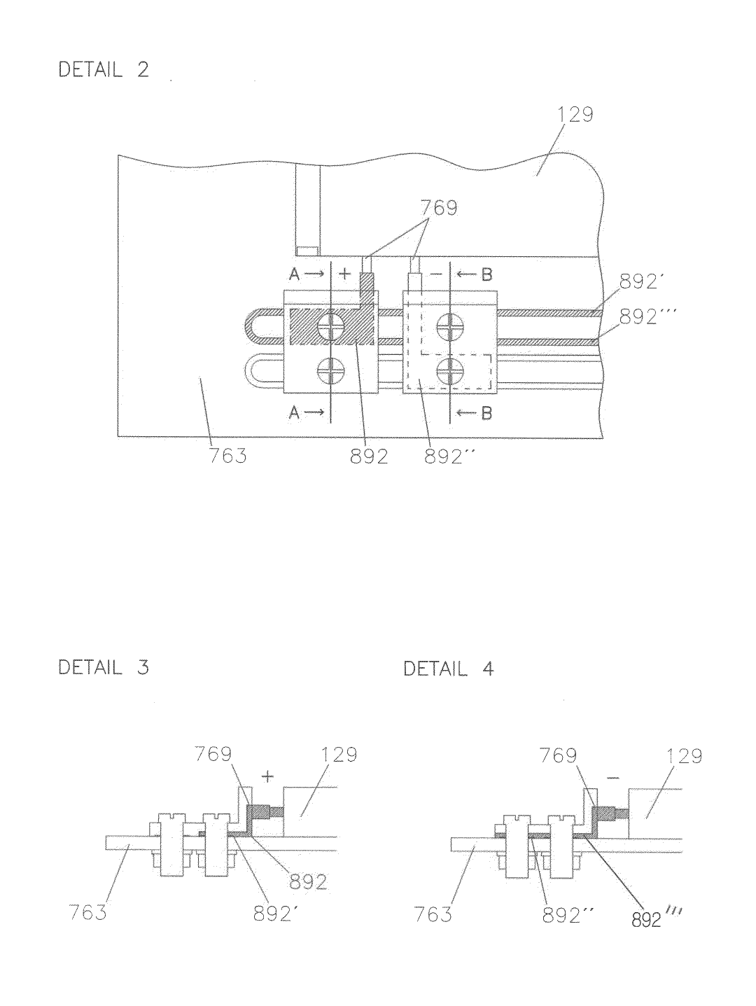

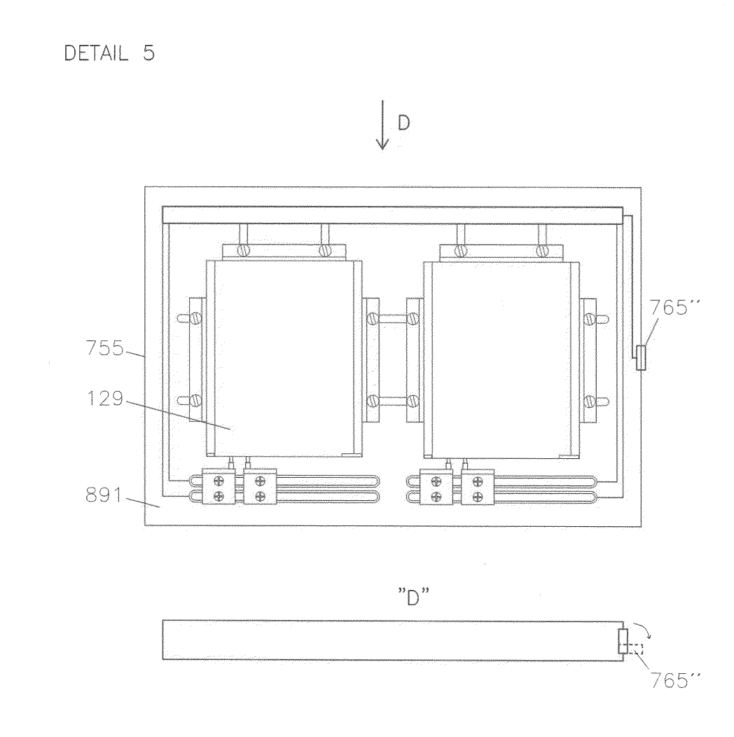

FIG. 26 presents an all-purpose charger 755 for simultaneous charging 4 accumulators. Inserted accumulator is first pushed with its contacts to flexible contacts 769 of the charger, whose proper position against contacts of accumulator must be properly set after releasing and after setting and tightening screws 787.

Similarly are moved and fastened stops 764 by releasing and than tightening of screws 2787. Contacts 769 are moved in grooves 780, stops in grooves 761. In charger 755, there is located charging electronics 788 connected through connector 765 of charger and cable 767 of mains charger to network charger 766. With contact areas 892 is interconnected by connections 893 and from here through contacts 769 to inserted accumulator 129. The charging electronics 788 is preferably adapted for supplying of mobile telephones 100, 101′ or auxiliary device 104 usable for bridging the time of replacement of basic accumulator 129 in mobile telephones 100, 101′ trough connector 765′ of charging electronics and through connecting cable 894 and connector 695 of cable of charging electronics. This modification is applicable for all types of described chargers.

Detail 1 presents springing contacts 769 sliding on groove 780 and sliding mechanism with fastening element formed by stop 764 which is movable in grove 761 and secured with screws 787 placed on three sides of basic accumulator 129, Contacts 769 are moved similarly at setting their proper position contrary to contacts of charging accumulator 129, whereas electric connection with contacts of charging electronics 788 ensures connecting surface of groves 786 in which slide flexible contacts 769

Detail 2 shoves sliding fastening of contacts 769 with contact pad 892 of contacts + conductively connected with a contact pad 892′ on mounting board 763 for contact +, preferably on printed circuit board and further second contact pad 892″ on − contacts and second contact pad 892′″ of board for contact −.

Detail 3 illustrates a side view to contact 769 +, where contact areas 892 bear on contact areas 892′

Detail 4 illustrates a side view to contact 769 −, where contact areas 892′″ bear on contact areas 892″″.

Detail 5 presents a possibility of locating of charged accumulators on both sides of board, preferably for four accumulators, which reduces the size of the charger 755, which is located in a box 891. On the picture is also presented a solution when for external charging or from spare bridging source is charger provided with hinged connector 765′, which is connected with a counterpart connector on mobile telephone 100 and 100′ and enables direct connecting or connecting by means of cable and supply it. In view “D” is connector 765″ in hinged position. This solution can be used for all chargers of this type 755.

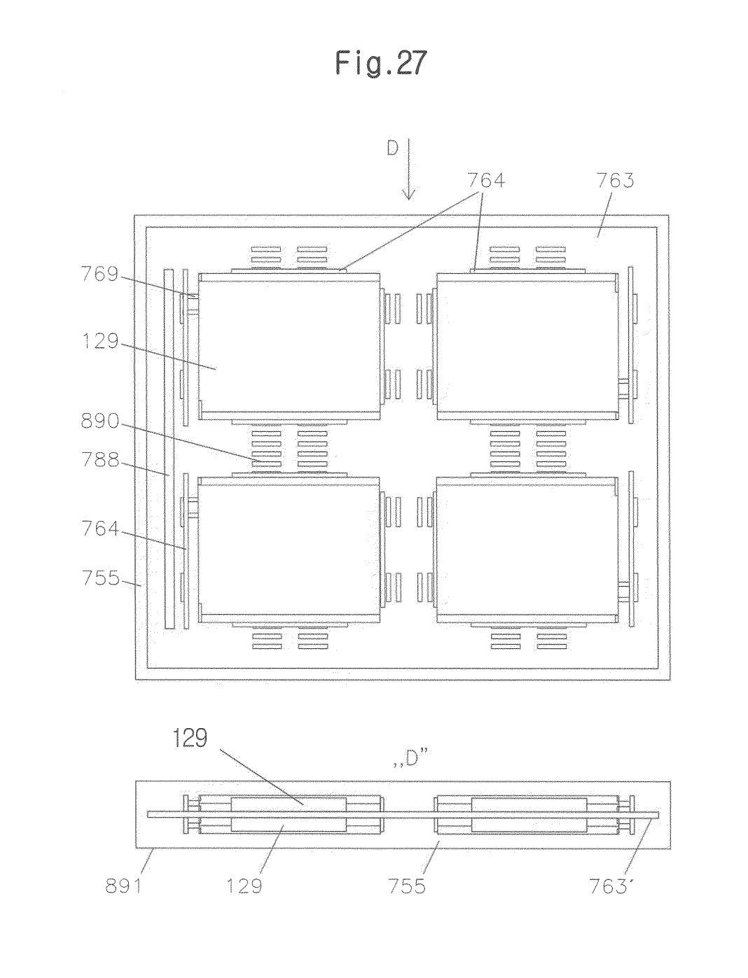

FIG. 27 shows a simplified version of all-purpose charger, where stops 764 and contacts 769 are fastened by soldering to a mounting board 763 on which are connections 890 for soldering of contacts 769 and stops 764 which enable their connecting to size of certain accumulator and their possibly relocating for another accumulator in case of changes.

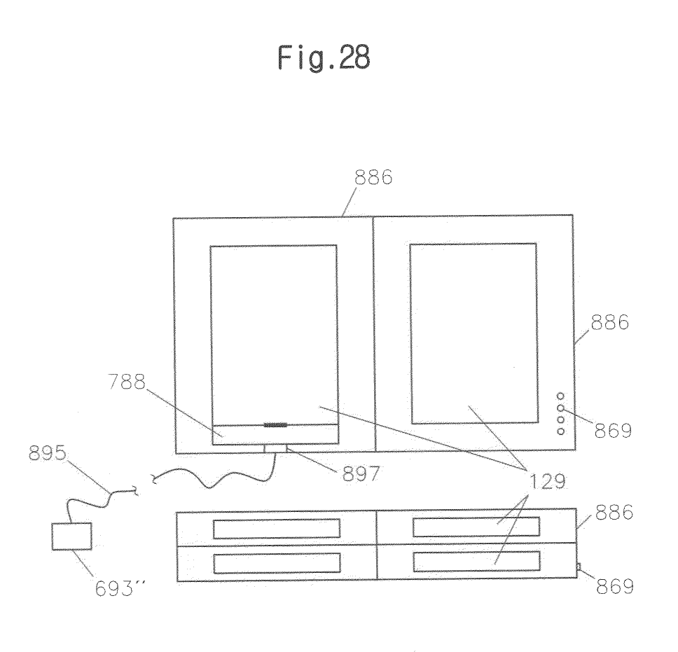

FIG. 28 illustrates casing 886 of basic accumulators preferably for 4 spare basic accumulators 129 where are at least at one position are distributed 897 contacts which bear on contacts of basic accumulator 129 from which take-off energy which is supplied trough cable 895 to tie connector 102 or 257, presented on FIGS. 1 and 6, which are placed on auxiliary device 104′ or mobile telephone 100, 100′ in which is processed with charging electronics. In casing is preferably placed charging electronics 788 connected between basic accumulator 129 and connecting cable 895 which suitably adjust voltage. In this case contacts 897 are placed so as they sit on basic accumulator 129 from where the energy is led through charging electronics 788 to cable 895. Energy is used preferably for bridging the time during replacement of basic accumulator 129 in mobile telephone 100, 101′ whereas is using preferably spare basic accumulators 129, carried in casing 886, so an extra source of bridging energy is not needed.

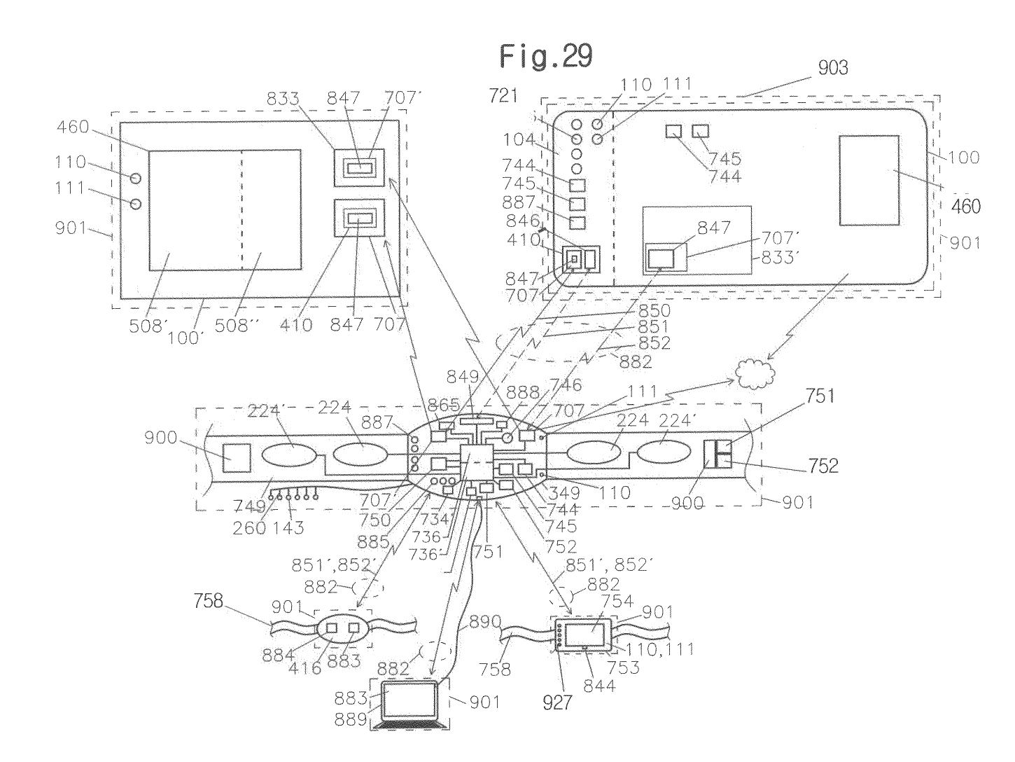

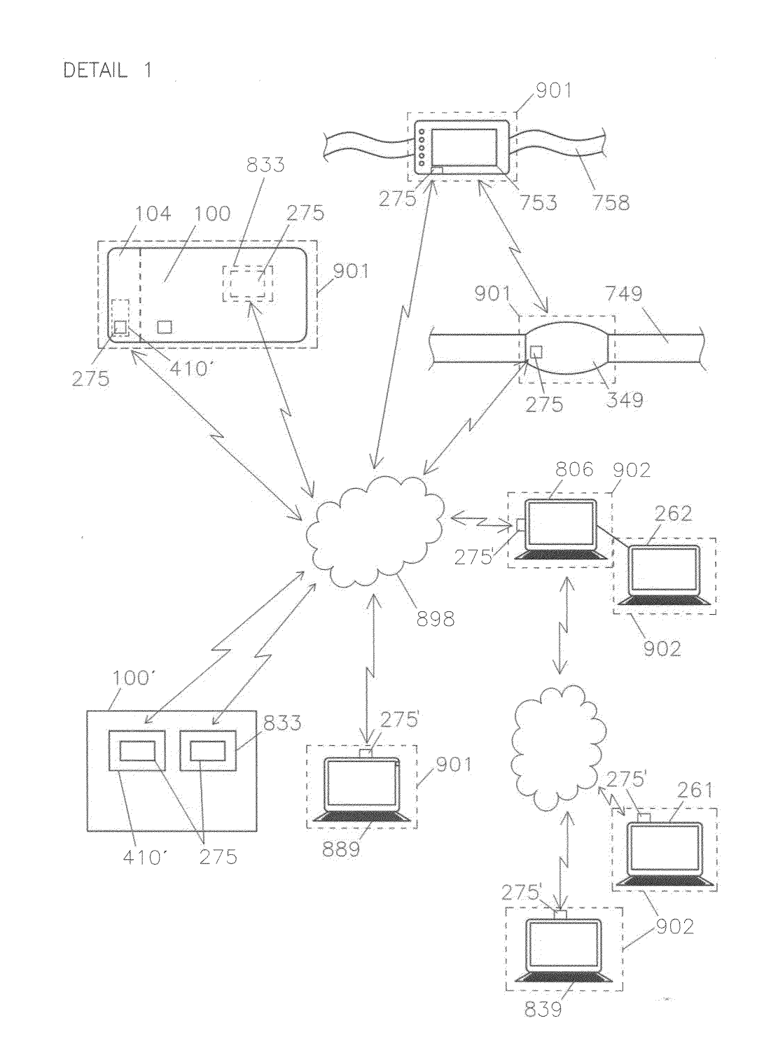

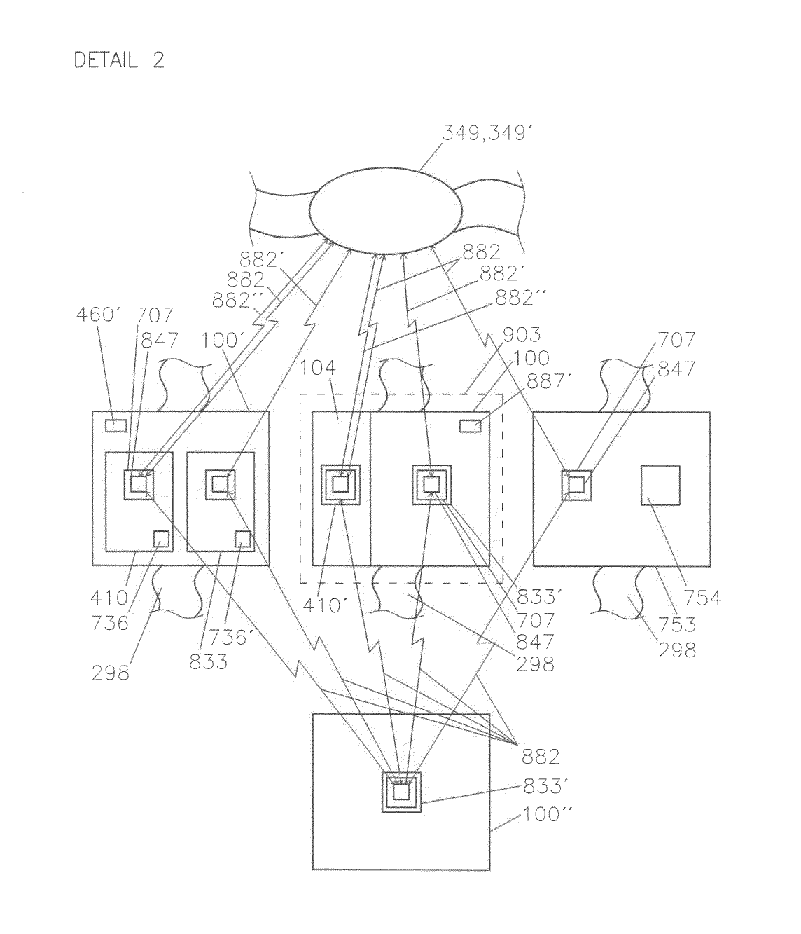

FIG. 29 presents communication between near co-operating units 901 by means of wireless connection 882 using preferably Bluetooth or ANT. Further there is illustrated connection of mobile telephone 100′ and/or auxiliary device 104 with mobile telephone 100 on monitor 349 of heart signals sensing and evaluating physiologic and bioelectric signals. These signals are converted to numeric values or curves of heart beats or arrhythmia or variability and/or curve ECG and/or further medical data on human body with pair of contact surfaces 224 and/or contact surfaces 224′ on chest strap 749 where is placed preferably and/or electrodes 143 glued and/or further according needs, adapted for continual sensing of bioelectric signals.

Monitor 349 of heart beat, between other, contains pushbutton 111 reset, pushbutton 110 panic, second unit 707′ of wireless communication monitoru srde\check{c}nich signál [symbol] , comparing unit 750 and communicates by means wireless link 851′ 5.5 kHz or wireless link 852′ 2.4 GHz for communication with watch 416 equipped with control unit 884 of watch, wrist 936. Monitor 349 cooperates with chest strap 749 and preferably contains unit 900 containing sensors of belt, which preferably contains among others sensor of breath 752 and sensor of body temperature.

Monitor 349 communicates preferably with mobile telephone by means of wireless connection 851 equipped with receiver 846 of impulses in band 5.5 kHz for reception of signals of heart beats. Detected physiologic and bioelectric signals from contact surfaces 224 are led to control unit 736 which evaluates these signals and in case of deviation from preset limits sends out a warning signal preferably through source of acoustic signal 745 or through some close cooperating unit 901. Alternatively physiological and bioelectric signals are sensed from both contact surfaces 224 and 224′ and are led preferably into two independent control units, it means into control unit 736 with microprocessor and second control unit 736′ with microprocessor, which ensures their independent processing and preferably continuous comparing of results. In case when results differ or exceed preset standards a warning signal is activated preferably by means of source of acoustic signal 745, preferably from loudspeaker, or piezo-converter or vibrator 744 or with wireless connection 882 through cooperating units formed preferably by mobile telephone 100′, auxiliary device 104 with mobile-telephone 100, control unit 753 and in case when the warning signal is not canceled in preset time interval by pushing pushbutton reset 111, then chest strap or selectable cooperating unit sends alarm to selectable remote unit made preferably by a server and/or suitable device at further participants preferably PC 889 or mobile telephone 100. Results from at least one control unit 736, 736′ are preferably transmitted by wireless connection 882 for graphic and numeric processing and displaying to close cooperating units 901 of mobile telephone 100 and/or to module 410′ auxiliary units in auxiliary device 104 connected with mobile telephone 100 and/or watch 416 and/or PC 889 and/or imaging and controlling unit 753 preferably on bracelet and/or others, whereas wireless connection 882 is formed preferably by Bluetooth or Bluetooth low energy, or by wireless connection 2.4 GHz or wireless connection 5.5 kHz, or ANT, or WiFi, whereas imaging on 883 on mentioned units preferably comprises value of arrhythmia and/or variability and/or pulse and/or further medical values with appropriate curves and numeric values, preferably ECG preferably in control units 736, 736′ analyzed and processed from heart signals and stated in properly units further processed for displaying.

Another alternative is results obtained in one control unit, for instance control unit 736 transfer through one communication channel, by means of wireless connection 882 to module 410 of auxiliary units, preferably into unit of wireless communication 707 preferably created by module 874 Bluetooth and results from second control unit 736′, for example transfer through second channel into mobile telephone 100 preferably into unit of wireless communication 707′ preferably formed by unit 874 Bluetooth and successively compare both results in module 410 of auxiliary units of auxiliary devices 104 and/or mobile telephone 100 and preferably displaying results independently, and in case of discrepancy initialize a warning signal. Alternatively are used signals of both channels in mentioned units independently without comparing as backup, if one of them failed or in simplified version is used only one channel and only this is processed and displayed. Alternatively is also preferably used only one pair of contact surfaces 224 led into both control units 736, 736′ so back-up starts only from them.

Preferably is monitor 349 together with mentioned contactable units, especially mobile telephone 100 an/or auxiliary device 104 adapted for full data back-up, processing and displaying of physiologic and bioelectric signals, preferably heart such as for instance curves and value of pulse, ECG, arrhythmia and other from first pair of contact pads 224 and second pair of contact pads of ECG electrodes 143 up to display with imagery of both channels independently and all system is doubled, whereas mobile telephone 100 with display 460 of mobile telephone is doubled with auxiliary device 104 with display 887 of auxiliary device or mobile telephone 100′ is doubled by module 410 of auxiliary units and electronics 833 of mobile telephone, working independently, or is doubled in module 410 with two or more independently working microprocessors or alternatively system is backed up partly, when is doubled only part of it, or is not backed up and monitor 349 is equipped with only one pair of contact surfaces 224 and one control unit 736. Control unit 753 preferably fastened on wrist 936 and contains pushbuttons 927, display 754 for processing and displaying data preferably with related curves including ECG and which besides processing and displaying is preferably dedicated for control of monitor 349 heart signals and creates with it separate unit, working without other units. The control unit 753 is preferably small and has only emergency function necessary for control of monitor 349 and simple imaging in comparison with mobile telephone 100′, which has more functions and bore detailed displaying.

When values of evaluated parameters exceed same of selected limits, a vibrator 744 and/or source of sound signal 745 is triggered by means of a loudspeaker or piezo-converter in monitor 349 of heart signals and/or according choice can be selected in some close cooperating units. In case when warning signal is not canceled by pushbutton 111 reset on monitor 349 or on other close cooperating units 901 within preset time interval, system sends alarm, which is automatically transferred to remote cooperating units 902, preferably to surveillance center 899 or other participants 839 with data or by telephone.

Preferably works also monitor 349 of heart signals separately without mobile telephone 100′ or auxiliary device 104 with mobile telephone 100 whereas is preferably controlled by pushbuttons 721, 722 and 723 and/or other and in its control unit are processed mentioned signals, which in case when values exceed preset limits, starts warning signal generated by source of sound signal 745, or 5 vibration by means of vibrator 744. If this warning is not canceled by pushing pushbutton reset 111 in preset time interval, monitor 349 sends alarm through mobile operator's network 898 to remote cooperating units 902 shown on detail 1. Warning signal is adjustable and preferably coded, which informs about type of alarm or why was alarm triggered. Adjustment of function of monitor 349 of heart signals is preferably made by control pushbuttons 885 on monitor 349 of heart signals, without necessity to connect other device or control unit 753 or for instance mobile telephone 100, 100′. In this case monitor 349 informs the user about values of measured quantity with acoustic signals by means of loudspeaker 674 or acoustic converter 843 as mentioned above. In case of connecting of auxiliary device 104 the control is carried out by control pushbuttons 721 of auxiliary device or by touch display 887 of auxiliary device, which preferably displays curves and quantities on display 887 preferably independently of displaying on mobile telephone 100 for parallel displaying on display 460 or back up. Monitor 349 of heart signals contains preferably display 865 of monitor of heart rate signals numeric or graphical for imaging of most important data, preferably arrhythmia, heart rate, ECG, variability and other data and preferably a touch display for control and displaying curves of heart pulses, arrhythmia, ECF and others. Monitor of heart signals contains preferably WATCHDOG 734 watching its proper activity and setting off alarm as described on FIG. 12, in case that control unit 736 and/or control unit 736′ fails and does not “refresh signal”. Monitor 349 of heart signals preferably watches over to proper operation of mobile telephone 100′ and/or auxiliary device 104 and/or mobile telephone 100′ and/or control unit 753 and/or sport watches 416 and further units herewith that mentioned units transmit on wireless connection 882 selectable code or the result of ordered task, preferably mathematic to the monitor 349 of heart signals. In case when code or result is correct, the control unit 736 and/or 736′ sends “refresh signal” to “watchdog” 734. When this signal does not come in adjusted time or is not correct, monitor 349 does not send the “refresh signal” and starts alarm initialized in watchdog 734 circuit. Alternatively the monitor 349 triggers alarm independently of watchdog 734 in case when does not receive proper code. Signal LEDs 931 or other type of acoustic vibrating type of alarm indicates the reason of alarm. Besides that they inform on the status of charging the accumulator, heart pulses and other information.

A memory removable card 888 stores data from monitor of heart signals can be downloaded to PC 889 or other suitable device, preferably by its relocation, or by means with wireless connection 882 or USB interconnection by means of connection 890. So is monitor 349 adapted for use as a “holter” with advantage of continuous monitoring as well as with advantage for live evaluation on displays 460, 887, 754 and further data of pulse and/or arrhythmia and/or variability and/or ECG. Preferably can be instead memory card 888 in monitor 349 used memory card 888′ in auxiliary device and/or mobile telephone 100 or 100′.

Monitor 349 is preferably placed on chest strap 749 or preferably on the wrist or on module 410 of mobile telephone 100′ or in module 410′ of auxiliary device 104 and electrodes 143 ECG preferably glued are connected with cables 267 to monitor 349 of heart signals in sufficient number, so as ECG would be optionally adaptable for 1 to 12 leads with possibility of back up. Connection to remote units, such as for instance to server 806, is realized preferably by means of mobile operators network 898. Surveillance centre 899 and participants 839 have access to server, Connection through mobile operator network has auxiliary device 104 and mobile telephone 100 independent of back-up.

Alternatively is instead of system 903 of mobile telephone 100 with auxiliary device 104 or simultaneously used a mobile telephone 100′, which has the same functions as system 903 and fully it replaces. Advantage of system 903 consist in possibility of removing auxiliary device and is applied in case of nee and only with such type of auxiliary device 104 where its functions fill momentarily need and in fittings preferably with optional sensors from the set of auxiliary device 104, so the mobile telephone 100 has extended functions only when needed, which means that mobile telephone is smaller and less expensive. Auxiliary device 104 contains module 401′, which is removable from mobile telephone 100, whilst in mobile telephone 100′ is a module 410 firmly build in. Electronics 833 of mobile telephone 100′ is comprised also in mobile telephone 100 as electronics 833′ of mobile telephone with the same functions, the auxiliary device 104 with mobile telephone 100 contain the unit of wireless communication 707, placed in module 410, 410′ preferably formed by unite 874 Bluetooth or ANT for communication of close cooperating units 901.

Detail 1 illustrates the communication through network of mobile operator 898 of close cooperating units, which is monitor 349, mobile telephone 100′, mobile telephone 100 with auxiliary device 104 and control unit 753, with remote cooperating units 902, preferably with the server 806 on which is saved information. Server is connected preferably with PC of operator 262, whereas information is accessible to remote cooperating units 902 and authorized participants 839, such as for instance to medical staff, relatives and to others and preferably to surveillance centre 899. This communication is enabled by communication unit 275 with parts for data and/or voice communication by means of mobile operator network

Detail 2 presents mobile telephone 100′, preferably on band 298 on wrist, smaller than mobile telephone 100′ without the band 291, communicating with monitor 349 or monitor 349′0 preferably simplified without backing-up. For backing-up the mobile telephone communicates with monitor 349 on two channels by means of communication wireless connection 882 to module 410 and spare wireless connection 882′ to electronic 833 of mobile telephone. Backed-up communication can be instead of communication with module 410 and electronics 833 of mobile telephone carried out only with module 410 where the second channel of doubling wireless connection 882″ is preferably processed by the second microprocessor in control unit 736 of module 410. Mobile telephone 100 on band 298, of smaller size processes data on control unit 736′ of module 410 separately from control unit 736 of mobile telephone and hence work reliably and preferably transfers processed data to standard mobile telephone 100″ of bigger size, which ensures displaying in detail on bigger display then mobile telephone 100′ on wrist 298. On mobile telephone 100′ is preferably instantaneous preview to smaller display and in mobile telephone 100 is preview in detail on bigger display which is not immediate in case, when the mobile telephone is in a pocket. Mobile telephone 100′ on a band 298 ensures reliability of data processing and immediate emergency view to smaller display 460 of smaller mobile telephone 100′ on band 298, imaging with details ensures the bigger mobile telephone 100″ for displaying of details. Mobile telephone 100′ works independently of mobile telephone for displaying in detail also when is not connected. In case of not backed up communication only on one channel of wireless connection 882 is alternatively instead of monitor 340 used monitor 349′ in economic version, which is not adapted for backing up and is smaller, simpler and with lower energy consumption.

Mobile telephone 100′ displays selectable data from mobile telephone 100″ for detailed displaying, for example data about incoming phone calls, SMS, which preferably takes. Similarly for described communication with mobile telephone 100″ for displaying in detail at monitor 349, 349″ is used system 903 with auxiliary device 104 and mobile telephone 100 or displaying and control unit 753. In case of using mobile telephone 100″ for displaying in detail, for economic and dimensional reasons telephone is not provided with parts for communication with mobile operator, is smaller and less expensive and for communication in network of mobile operators preferably used mobile telephone 100″.

Detail 3 shows a simplified version of detail 2, where connection between mobile telephone 100′ or system 903 is not backed-up and connection by means of wireless connection 882 is only module 410, 410′ which process data and send it to electronic 833, 833′ of mobile telephone, from where are sent to mobile telephone 100″ for detailed displaying, or connection is realized by means of wireless connection to control unit 753 and from it to mobile telephone, On detail 2 is described communication with mobile telephone 100′. Similarly runs communication with auxiliary device 104 with mobile telephone 100, which preferably replaces mobile telephone 100′.

On the Detail 4 is drawn the solution of easily replaceable basic accumulator 129 for mobile phone 100′, placed on wrist band 298, by means of mechanism 782 for replacement of basic accumulator which is equipped by door 694, which a is enabling, after turning off, slibasic accumulator 129 to the side and after the replacement to fix new accumulator by its closing and securing by valve 932 It is achieved by it that wrist band 298 on which is placed mobile phone 100′ is not preferably taken off hand for to make replacement of basic accumulator 129 and then the replacement is quick and comfortable.

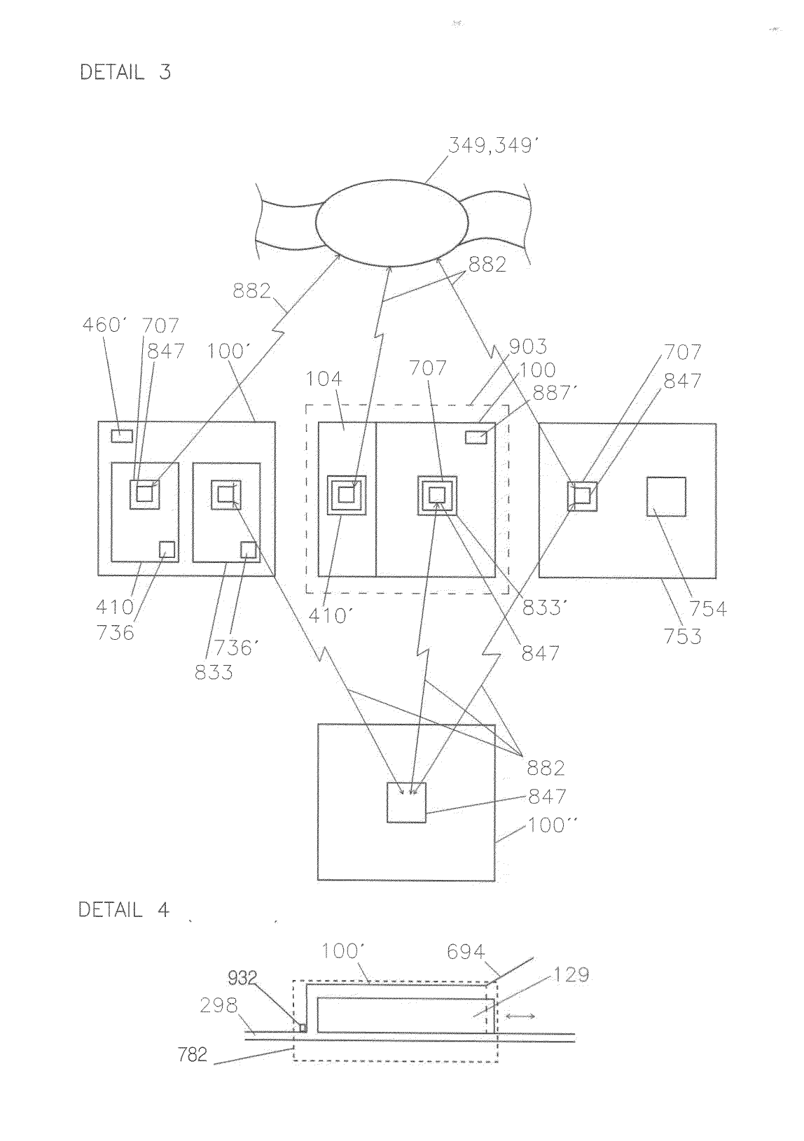

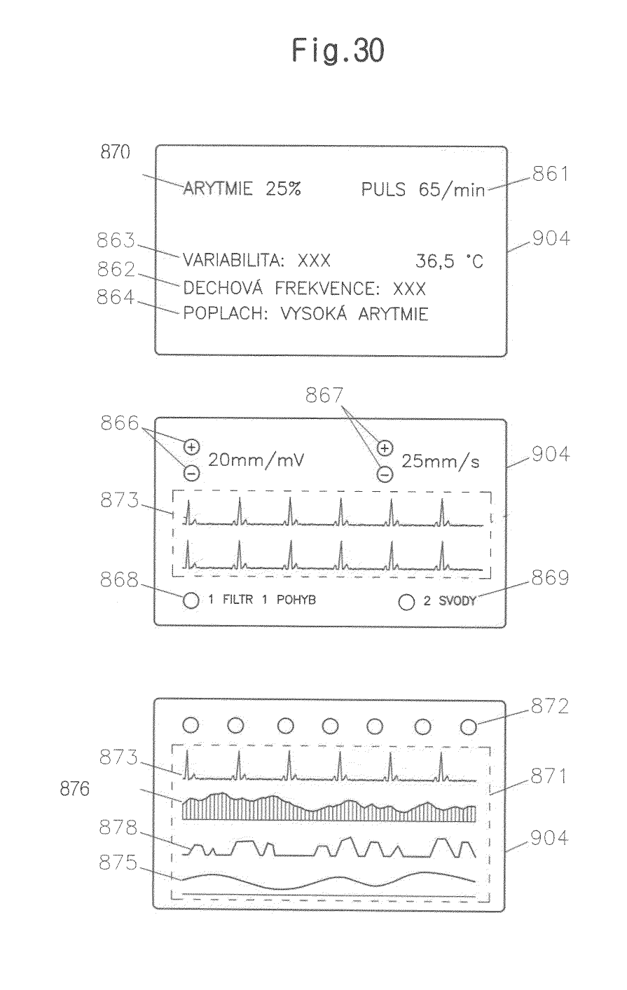

FIG. 30 is drawing the examples of projection of data produced with monitor 349 of heart signals on display 865 of monitor 349 of heart signals and/or on display of mobile phone 100′ and/or auxiliary device 104 with mobile phone and/or watch 416 and/or on control unit 753 and/or other units. Displaying part 904 preferably formed by some of displays 460, 178, 506, 754, 865, 887, in case of numeric projection preferably displays value 870 of arrhythmia, value 863 of variability, value 862 of breath, value 861 of pulsation and cause of alarm in case that alarm situation occurs. Displaying part 904 is preferably universal and displays course of curves, par example ECG curve 873 with touch handling, par example handling 866 of sensibility, handling 867 of shift speed of displayed curves, further handling 868 of movement filter preferably for calm, walking, running and handling 869 of multi lead projection adjustable preferably on display with imaging of curve 873 ECG which one is correcting for the instant results of setting be seen. It displays preferably curve 876 of heart rate, curve 878 of arrhythmia and curve 875 of variability whereas it is possible to follow change just when done and to set suitable value. These quantities and/or curves are preferably displayed individually or in groups, on one displaying unit 903. Value of arrhythmia is preferably expressed in % of irregular pulses of total number, during the optional time period or in degrees of arrhythmia preferably in values from 1 to 10 taken as 1/10 form above indicated % of irregular pulses or in another adequate scale preferably expressed orally as arrhythmia: none, low, middle, high, very high. The irregular pulses are to be preferably understood those ones which are not exceeding value 1, 15 of average pulsation measured of adjustable number of pulses, preferably 3 pulses for filtration of interference, to the detriment of exactness of projection.

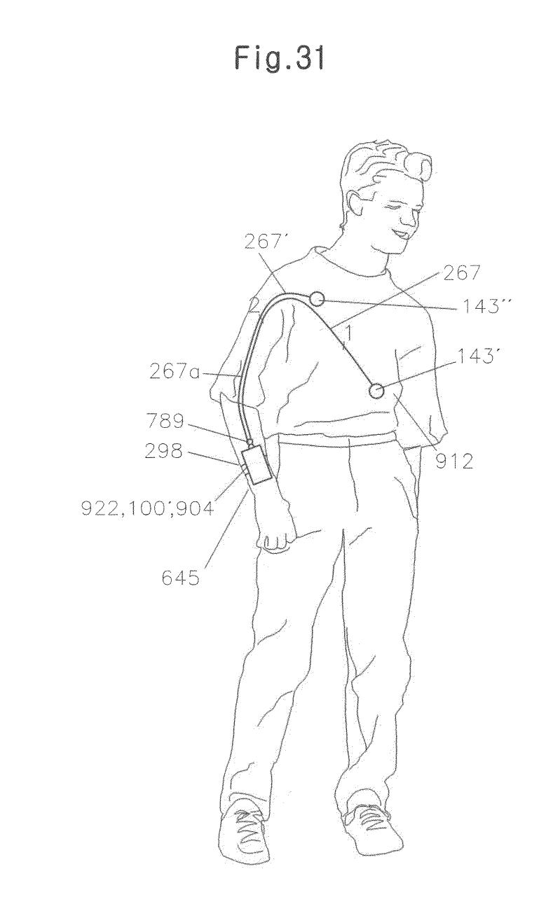

FIG. 31 is drawing the example of wire connection of electrodes 797′ external, preferably formed by electrodes 143′. 143″ glued, by cables 267 to nearby cooperating unit 901, to mobile phone 100′ or system 922 by means of connector 789 of ECG. One wire cable 267 led from glued electrodes 143′ is thin, preferably transparent or in body colour for not be discomfortable for monitored person and not attracting attention and is on arm added to one wire cable 267 from electrode 143″ thus from shoulder part is cable 267 a double wire and is led through sleeve under shirt 912 to connector 789 of ECG.

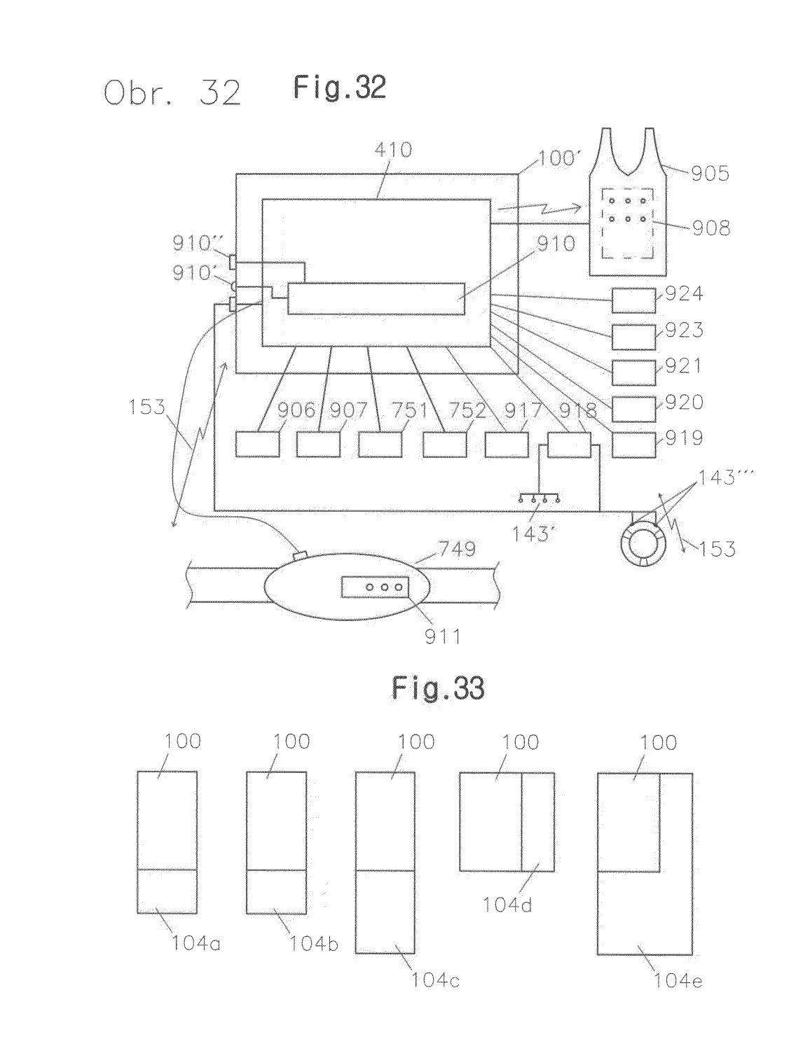

On FIG. 32 is drawn mobile phone 100′ with module 410 of auxiliary units or auxiliary device 104 with module 410′ which preferably contains module of internal sensors 910 equipped preferably by sensors of body temperature 751, pressure detector 917, detector of phases of sleep 921, light detector preferably of blood oxygenation 923 and detector of acoustic signals 924. To module 410 is connected set of external sensors preferably completing internal sensors, which are preferably detector of level of alcohol 906, detector of presence of addictive drugs 907, sensor of body temperature 751, breath sensor 752 pressure detector 917, ECG detector 918, EEG detector 919, EMG detector (electromyograph) 920, detector of phases of sleep 921, light detector 923 with preference of blood oxygenation and sensing of pulsation, detector of acoustic signals 924 preferably completing or replacing module of internal sensors 910 which is connected to sensors 910′ placed on mobile phone 100′ or outside it as sensors 910″. Preferably sensors 908 are placed on T-shirt 905 for sensing of signals and valued from selected parts on upper parts of body of monitored person whereas are connected by wire or wireless to module 410, 410′ and completing or replacing sensors in set of internal or external sensors and/or they are placed on multifunctional chest strap 749 connected by wire or wireless. Preferably are sensors and/or external electrodes 143″ on steering wheel placed on control device of transport or other mean with human service, preferably on wheel of car and signals from which are transmitted to mobile phone by wire or wireless by connection 153. Preferably are sensed in such a way also the ECG signals transmitted further to detector ECG 918.

On FIG. 33 is drawn auxiliary device 104, which is connected to mobile phone preferably that time when is required increase of auxiliary functions. Auxiliary devices 104 are equipped by various functions in various quantities for individual purposes while user is choosing deployment of them accordingly number and kind of functions required. Auxiliary device 104a with equipment 1 is identical in the dimensions as auxiliary device 104b with equipment 2 but it enables different functions of auxiliary device 104b with equipment 3 of bigger dimensions, it enables more functions of auxiliary device 104c with equipment 4 it enables same auxiliary functions as equipment 1 or 2 but mechanical adjustment is different due to the fact that mobile phone 100 is enlarged up to the width of auxiliary device 104d. Equipment 5, the most dimensional one, is enlarging mobile phone 100 both up to width and to length and enables more functions, adequately to dimensions.

### INDUSTRIAL APPLICABILITY

Invention is of use especially for mobile devices where longterm uninterrupted activity without charging of accumulator is required. It is especially about collection and processing of important data, par example medicinal ones.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. Mobile phone
characterized in that
mobile phone (100′) with auxiliary functions is provided by mechanism (782) for replacement of accumulators and block (152) of auxiliary modules for realization of auxiliary functions in mobile phone (100′) and is for
easy replacement of basic accumulator (129) without removal of cover (700) of mobile phone (100′) of another element or device provided by mechanism (782) for replacement of accumulator, does not increase thickness of mobile phone (100′) with auxiliary functions in comparison with standard mobile phone (100)
and/or
mobile phone (100′) with auxiliary functions for replacement of basic accumulator (129) without interruption of operation is provided by bridging source (836) of energy for supply of block (833) of electronics of mobile phone (100′) with auxiliary functions and/or module of auxiliary units (410) minimum for the time of replacement of basic accumulator (129)
and/or
mobile phone (100′) with auxiliary functions is adjusted for independent processing of data of electronics of mobile phone (100′) with auxiliary functions per module of auxiliary units (410), which is provided, and this module of auxiliary units (410) which is adjusted to data receiving from further external devices (154) additional electronics, comprise minimum one control unit (736) with microprocessor operating with block (833) mutually independently on each other or the data are receiving from external device (154) in electronic (833) of mobile phone directly.

17. Mobile phone
characterized in that
mobile phone (100), with auxiliary functions in auxiliary device (104) is this one provided by mechanism (782) for easy replacement of accumulators and block (152) of auxiliary modules for realization of auxiliary functions whereas auxiliary device (104) is able to be fixed by means of fixation mechanism (781) without increase of thickness of standard mobile phone (100) and is for easy replacement of basic accumulator (129) provided by mechanism (782) for replacement of accumulator, in original accumulator shaft of standard mobile phone (100), without removal of auxiliary device (104), or removal of its cover or another element of auxiliary device (104) or cover of mobile phone (100) whereas is not increased thickness of mobile phone (100)
and/or
auxiliary device (104) is adapted for such replacement of basic accumulator (129) without interruption of operation by means of source (836) of bridging energy for supply of standard mobile phone (100) and auxiliary device (104) minimum for time of replacement of basic accumulator (129)
and/or
auxiliary device (104) is adapted for independent processing of data on block (833) of electronics of standard mobile phone (100) in such a way that it is provided by block (410) of auxiliary electronics of auxiliary device (104) operating with block (833) of electronics of mobile phone mutually independently on each other
when
standard mobile phone (100) is, by connection with auxiliary device (104) increased only in length or width, or if auxiliary device (104) is placed directly in store space (713) of original accumulator, mobile phone (100) is not increased at all, as outside dimensions is concern.

18. Charger
characterized in that
it is provided by charging electronics (788) connectable to source (766) of charger which is provided by
module (824) of charging of basic accumulators (129) and
module (825) of charging of mobile phone (100) or mobile phone (100′) with auxiliary functions or auxiliary device (104) or their supply by bridging energy within replacement of basic accumulator (129) from minimum one optional accumulator (129) or from their remaining gathered energy from all accumulators (129) in charger (755)
whereas
in execution of mounting boards (763, 763′)
is charger (755) adapted for any dimensional execution of flat basic accumulators (129) for mobile phones and placement and fixation of minimum one of accumulators (129) in drive of charger and fixation on one basic supporting board (763) at least, namely inclusive charging electronics (788) when such sets on supporting board (763) are able to be assembled in layers and fitted from one side or from both sides on reversible supporting board (763′),
or they are
in modular execution
flat basic accumulators (129) in mobile phones or for them adapted source modules (241) able to be stored in at least one module (250) of charger, for them adapted dimensionally and in shape, where are accumulators (129) fitted at least from one side and such sets of modules (250) of charger are able to be assembled then moreover in one on one layers or to the sides, to optional groups.

19. Mobile phone of any claim of claims 16, 17
wherein
module (410) of auxiliary electronics of mobile phone (100′) with auxiliary functions of module (410′) of auxiliary device (104) to mobile phone (100) adapted for detection of physiologic and bioelectric signals of monitored object corresponding with minimum one of health function of monitored person as it is ECG, EEG, EMG, ABPM, sleep activity, breath activity, resistance of skin, alcohol test, drug test, body temperature, detection of breathing, oxygen blood saturation, pulse frequency, pulsation,
is provided by module (914) of internal monitoring units formed at least by one of ECG units, unit of detector (288), especially of health functions, unit of alcohol detector (289) and/or drugs, unit of further functions with respective electrodes and probes
and/or
is provided with module (914′) of external monitoring units formed at least by one of ECG units (599), unit of detector (288′), especially of health, unit of alcohol detector (289′) and/or drugs, unit (290′) of further functions with respective electrodes and probes, when module (914) is connected through interface (285)
and when
outputs of module (914) of monitoring units, internal and or module (914′) of monitoring units, external, are connected to control unit (736) with microprocessor of module (410, 410′) of auxiliary electronics,
whereas
output of control unit (736) with microprocessor contained on module (410) of mobile phone with auxiliary function (100′) is connected with block (833) of electronics of mobile phone or contained in module (410′) of auxiliary device (104) of mobile phone (100) is connected through connector (691′) with mobile phone (100).

20. Mobile phone of any claim of claims 16, 17
wherein
in cover (700) forming back side of mobile phone (100), or in covering formed side (717) of auxiliary device (104) replaceably for cover (700) there is made, above of space of basic accumulator (129), mechanism (782) for replacement of accumulator composing of small doors (708) which are, together with drive of hinge of small door, part of cover (700) of mobile phone (100) or covering formed side (700) of auxiliary device (104), whereas small door overcovering the store space is in its construction adapted as door able to be secured by snap or valve (676) which is swiveling on hinges (119) or bendable reduction, or extensible, or removable and snapped in bulges or removable at all (247), formed as cut-out of cover (700) or covering formed side (717) of auxiliary device (104) namely glued outside on basic accumulator (129).

21. Mobile phone according to claims 16, 17,
characterized in that
module of auxiliary units (410) is adjustable in corpus of mobile phone (100′) directly, or in space of mechanisms (603, 782) for accumulator change, or is independently connected per covering formed side (717) of auxiliary device (104) to corpus of standard mobile device (100).

22. Mobile phone according to claims 16, 17
characterised in that,
replaceably adapted cover (700) of mobile phone (100) or covering formed side (717) of auxiliary device (104) to corpus of standard mobile phone (100) are provided by extensible small door (694) for easy replacement of basic accumulator (129) with advantage of provided hinge and stopper of door (673) created mechanisms (782) for accumulator (685, 685′) change while these pressure springs in door (685,685′), easily removable of the accumulator (129, 129′) from accumulator storage are modified in the hinge of extensible door (694) opposite to the locking cap (673).

23. Mobile phone of any claim of claims 17, 20
wherein
in auxiliary device (104) of mobile phone (100), provided by electronics (833) of mobile phone with microprocessor unit (859) of mobile phone with bridging accumulator (688) and charging/supplying electronics (682) is charging/supplying electronics (682) connected by cable (686) with contact springs (678) of fit of contacts (711) of basic accumulator (129) or charging/supplying electronics (682) is connected with charging connector (691, 693) of mobile phone (100) whereas charging/supplying electronics (682) is able to be connected with mobile phone by manual or electronic switch (703) handled by switch (702) of door of cover of basic accumulator (129) and charging/supplying electronics (682) is connected with block (410) of auxiliary electronics of auxiliary device (104) whereas in this auxiliary device (104) are adapted connectors for connection of external modules of bridging energy (836′, 836″) of mobile phone.

24. Mobile phone of any claim of claims 16, 17, 18
wherein
mobile phone (100), provided with electronics (833) of mobile phone with microprocessor unit (859) of mobile phone is connected by means of connectors USB (691, 693) with auxiliary device (104) when connector USB (693) of auxiliary device (104) is in this auxiliary device connected through control unit (736) with microprocessor with code checking for connection of timer (858) reset by “refresh” signal and generator of alarm when timer (858) is connected with vibrator (294), acoustic changer (853) and light signalization (295) and together form watchdog (734),
whereas supplying connector (102) USB of mobile phone is able to be connected through block of supplying electronics (715) of mobile phone to the block of electronics of mobile phone (833) and to bridging source (836), the second poles of them are connected with connector (102) USB as well, when between block of supplying electronics (715) and these second poles is connected basic accumulator (129) and connector (102) USB is adapted for connection of charger (755).

25. Mobile phone of claim 17
wherein
to auxiliary device (104) of mobile phone (100), by means of connector USB (691, 693), block (894) of charging electronics is able to be connected externally and electronics (333) of mobile phone (100) in current cover provided by basic accumulator (129) is connected to mobile phone (100) by means of connector (102) and on mobile phone (100) is fastened, by overhangs for arresting, side (258) of auxiliary device with built in auxiliary device (104), when in the side (258) of auxiliary device there is above shaft for placing of basic accumulator (129) the adjusted space for placing of source block (241) of auxiliary accumulator (129′) and/or
auxiliary device (104) to mobile phone (100) together with block (152) of electronics adjusted in shape of small board or very flat rectangular block, is able to be mechanically attached/fixed to the outside flat side of original cover (101) of mobile phone (100) by affixing layer (318) formed preferably of elastic gel, electric interconnection of mobile phone (100) with block (152) of electronics and auxiliary device (104) is made by short cable link (234) with USB connector (691, 693) when basic accumulator (129) is placed in original space of corpus of mobile phone (100) under original cover or is
auxiliary device (104) to mobile phone (100), together with block (152) of electronics, adjusted into the form of small board or very flat rectangular block, covering door (708) in cover (101) is able to be mechanically attached/fixed to the flat outside of original cover (101) of mobile phone (100) by glued hinge (860), glued from outside to the flat outside of original cover (101) of mobile phone (100) and secured also by glued latch (857), glued also from outside to the flat outside of original cover (101) of mobile (100) when electric interconnection of mobile phone (100) with block (152) of electronics and auxiliary device (104) is formed by short cable connection (234) with USB connector (691, 693) when basic accumulator (129) is placed in original space of corpus of mobile (100) under door (708) replaceable by uncovering of block (152) of electronics by glued hinge (860) whereas cable (234) is in part between connector USB (693) and axis (733) of glued hinge (860) as cable which is to be glued to cover (101).

26. Mobile phone of any claim of claims 16, 17
wherein
in cover (700) of mobile phone (100′) with auxiliary functions or in covering formed side (717) of auxiliary device (104) of mobile phone (100) is made store mechanism (782) for placement of source block (241) which is provided by door (694) or only door (694) is adapted for insertion of basic accumulator (129) into original shaft of mobile phone when such door is formed as surface of material of identical or lower thickness as this one of cover (700) or covering formed side (717) and surfaces identical with space of accumulator (129) or with surface larger for covering antidust overhangs with protrusions (258) and notches (259) for fingernail whereas source block (241) is formed as accumulator casing in shape of collar with contacts (307), dimensionally fitting into space of placement of original basic accumulator (129) and this source block (241) is provided by arresting elements (240) and casing contacts (243) and source block (241) created in such a way, is able to be put individually into store space of original accumulator (129) of mobile phone,
whereas source block (241) with basic accumullator (129′) with outside interconnection and execution of upper side without overhang or in execution with overhang, is to be created as one compact operation unit or optionally with removable accumulator as one compact operation unit as well.

27. Charger of claim 18
wherein
charging electronics (788) of control of charge, able to be fastened on mounting board (763) is through connector (765) by cable (767) optionally able to be connected with source (766) of supply of charger or PC, or by another device as source of supply energy or is, through second connector (257) as source of charging energy of charging electronics (788) able to be connected with mobile phone through connector (258) and cable (256) and/or with auxiliary device (104) by means of the same cable and connector (102) whereas this connection can be used both for charging of basic accumulator (129) and as external source (836′) of bridging energy,
whereas between charged basic accumulators (129) and income/outcome connectors (257, 765) are in block of charging electronics (788) of control of charging connected module (824) of charging of basic accumulators (129) and module (825) of charging of mobile phone and/or auxiliary device of voltage correction for external source (836′) of bridging energy or charger (755) is adapted for permanent supply of mobile phone or auxiliary device (104) or for time of replacement of basic accumulator (129) and/or
at least from one module (250) of charger of source modules (241) is to be assembled module charger of charging source modules (241) of specific shape placeable in mechanism (782) for replacement of accumulator of mobile phone (100′) or auxiliary device (104) when each of composed modules (250) of charger is provided by formed protrusion of lock of connection (251) of modules of chargers and its opposite formed bulge of lock of connection (251′) of modules of chargers, connectors of interconnection (254, 254′) of modules of chargers, electronics (260) of module of charger, flexible contacts (244, 244′) of connection of source block (241) and connector (255) for connection of external source,
whereas module (250) of charger has opening, adapted in form, for insertion of source module (241) into this opening, shaped accordingly and each module (250) of charger is provided by arresting elements corresponding with arresting protrusions (240) of source module (241).

28. Charger of claim 18
wherein
at least one module (250) of charger or at least one mounting board (763, 763′) fitted by reserve basic accumulators (129) is optionally able to be placed in casing (866) which is provided by linking segments of connection to mobile phone (100) or mobile phone (100′) with auxiliary functions or auxiliary device (104) for charging their basic accumulators (129) or their supply of bridging energy within exchange of basic accumulator (129) or from their remaining joined energy of all reserve accumulators (129) in casing (866) and/or
flat accumulators (762) are in positions limitable on mounting board (762), fastened by firmly put pressure (764), shiftable mechanism (757) and springly contacts (769), whereas shiftable mechanism (757) and springly contacts (769) are solved by means of in grooves (769) optionally fixable notches (756) with fastening elements (770) for shift in grooves or shiftable mechanism (757′) can be solved by means of notch (776) and fixation elements (758, 759) with settable shift by means of saw-toothed grooves (772, 773) and screw (768).

29. Charger according to claim 18,
characterized in that
for connecting the charger (755) to a mobile phone (100,100′) is equipped with the tipping connector (765″) realized for connection of charger (755) with network charger (766) or with the cable (767) for charging.

30. Mobile phone
characterized in that
along with other nearby cooperating units (901) is wirelessly connected to the hearth signal monitor (349) for transmission, detection and display physiological and bioelectrical signals of tracked object corresponding to at least one medical function of the monitored person such as ECG, EEG, EMG, ABPM, sleep activity, breathing activity, the resistance of the skin, alcohol test, a drug test, body temperature, detection of breathing, blood oxygen saturation, pulse rate, pulse on mobile phone
and/or transmission to remote cooperating unit (902) for live viewing or monitoring memory card (888) and/or the monitor preferably simplified (349) is connected wirelessly via the mobile telephone network (898) of the mobile operator the server (806) and the remote cooperating transfer unit or backup and removable memory card (888) is designed for backup or to be used as holter, ie. data transfer by moving the card or remote transmission,
wherein the heat signal monitor (349) is adjusted for non-backed or redundant transmission through duplication of elements, namely the contact surface (224,224) and/or control unit with microprocessor (736,736′)
and the heart signal monitor (349) is adjustable to work independently without additional units, which is controllable by pressing disposed thereon, a display (865) to facilitate the management and display or can be controlled from a control unit (753) with a display (754) control unit (753).

31. The mobile phone according to claim 30,
characterized that,
this mobile phone (100′) and/or nearby cooperating unit (901) are connected with the c (349) for backing up two different channels with the electrodes (224, 224′, 143) and data from the two channels are compared for a match in the comparing unit (750), in case of disagreement, the warning signal is running that, if is not reset, changes to the alarm.

32. Mobile phone according to claim 30,
characterized that,
in cooperating heart signal monitor (349), there are evaluated sensed data from the body of the monitored person and in case of exceeding set limits to the heat signal monitor (349), gives an audible and/or vibration and/or visual warning signal when it is reset, is sent to the cooperative or nearby cooperating units (901, 902).

33. Mobile phone according to claim 30,
characterized in that,
cooperating with the heart signal monitor (349) cardiac signal is connectable to the adhesive lower ECG electrodes (143′, 142″) and positionable on the wrist in nearby cooperating units (901) or separately.

34. Mobile phone according to claim 16, 17,
characterized in that,
module contains module of auxiliary units (410) that contains or is connected optionally at least one of the units or detectors and the detector of the alcohol (906), detector of addictive substances (907), a detector of temperature (751), detector a breath (752), detector a pressure (917), detector ECG (918), detector EEG (919), a detector EMG (920), a detector sleep phase (921), detector phase of the light (923), acoustic detector (924) and these units and detectors are adaptable for sensing physiological biometric values and from the body of the monitored person or the vehicle driver from the multifunction strip (740) via a wire connection (153) and/or from the lower ECG electrodes (143′) and/or external lower ECG electrodes (143′″) at the wheel connected by wire or a wireless connected (153) and/or the additional module of auxiliary units (410) are adjusted to read signals from the body of the monitored person comprising a control sensor (908) and the electrodes placed on the hook (905).

35. Mobile phone according to claim 17,
characterized in that,
additional devices (104a, 104b, 104c, 104d, 104e) adjusted for different functions realized with various amounts and types of units, they are the same or different sizes, enlarged in length and/or width, and are selectively connectable to the mobile phone (100) depending of desired functions.
